(19) United States
(12) Patent Application Publication
(10) Pub. No.: US 2024/0275572 A1
(43) Pub. Date: Aug. 15, 2024

(54) TECHNIQUES FOR SINGLE TRANSMISSION OCCASIONS ACROSS DIFFERENT SYMBOLS

(71) Applicant: QUALCOMM Incorporated, San Diego, CA (US)

(72) Inventors: Qian Zhang, Basking Ridge, NJ (US); Yan Zhou, San Diego, CA (US); Muhammad Sayed Khairy Abdelghaffar, San Jose, CA (US)

(21) Appl. No.: 18/168,813

(22) Filed: Feb. 14, 2023

(51) Int. Cl. H04L 5/16; H04L 5/00; H04W 72/1273

(52) U.S. Cl. CPC H04L 5/16; H04L 5/0083; H04W 72/1273

(57) ABSTRACT

Methods, systems, and devices for method for wireless communication are described. A user equipment (UE) may receive an indication that an occasion of a set of one or more occasions for a message occurs over a set of symbols. In some examples, the set of symbols may include a set of full-duplex symbols and a set of non-full-duplex symbols. The UE may then communicate the message via the occasion in accordance with a set of rules and based on the occasion being across at least one full-duplex symbol of the set of full-duplex symbols and at least one non-full-duplex symbol of the set of non-full-duplex symbols.

### TECHNICAL FIELD

The following relates to method for wireless communication, including techniques for single transmission occasions across different symbols.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for single transmission occasions across different symbols. For example, the described techniques provide for a user equipment (UE) and a network entity operating in accordance with a set of rules. In particular, the UE and the network entity may manage uplink transmissions and downlink receptions over subband full-duplex symbols and non-subband full-duplex symbols in accordance with the set of rules. In some examples, the UE may receive an indication that an occasion of a set of one or more occasions for a message occurs over a set of full-duplex symbols and a set of non-full-duplex symbols. In some examples, the occasion may be across at least one full-duplex symbol of the set of full-duplex symbols and at least one non-full-duplex symbol of the set of non-full-duplex symbols. In such cases, the UE may communicate the message via the occasion in accordance with the set of rules.

A method for wireless communication at a user equipment (UE) is described. The method may include receiving an indication that an occasion of a set of one or more occasions for a message occurs over a set of multiple symbols, where the set of multiple symbols includes a set of full-duplex symbols and a set of non-full-duplex symbols and communicating the message via the occasion in accordance with a set of rules and based on the occasion being across at least one full-duplex symbol of the set of full-duplex symbols and at least one non-full-duplex symbol of the set of non-full-duplex symbols.

An apparatus for wireless communication at a UE is described. The apparatus may include a processor, memory coupled with the processor, and instructions stored in the memory. The instructions may be executable by the processor (e.g., directly, indirectly, after pre-processing, without pre-processing) to cause the apparatus to receive an indication that an occasion of a set of one or more occasions for a message occurs over a set of multiple symbols, where the set of multiple symbols includes a set of full-duplex symbols and a set of non-full-duplex symbols and communicate the message via the occasion in accordance with a set of rules and based on the occasion being across at least one full-duplex symbol of the set of full-duplex symbols and at least one non-full-duplex symbol of the set of non-full-duplex symbols.

Another apparatus for wireless communication at a UE is described. The apparatus may include means for receiving an indication that an occasion of a set of one or more occasions for a message occurs over a set of multiple symbols, where the set of multiple symbols includes a set of full-duplex symbols and a set of non-full-duplex symbols and means for communicating the message via the occasion in accordance with a set of rules and based on the occasion being across at least one full-duplex symbol of the set of full-duplex symbols and at least one non-full-duplex symbol of the set of non-full-duplex symbols.

A non-transitory computer-readable medium storing code for wireless communication at a UE is described. The code may include instructions executable by a processor to receive an indication that an occasion of a set of one or more occasions for a message occurs over a set of multiple symbols, where the set of multiple symbols includes a set of full-duplex symbols and a set of non-full-duplex symbols and communicate the message via the occasion in accordance with a set of rules and based on the occasion being across at least one full-duplex symbol of the set of full-duplex symbols and at least one non-full-duplex symbol of the set of non-full-duplex symbols.

In some examples of the method, apparatuses, and non-transitory computer-readable medium described herein, the set of rules indicate that communication of the message via the occasion may be allowed based on the message being a first type of message and the occasion including a multi-symbol resource having a transmission direction that conflicts with at least one subband of the at least one full-duplex symbol of the set of full-duplex symbols.

In some examples of the method, apparatuses, and non-transitory computer-readable medium described herein, the first type of message includes a physical uplink shared channel, or a physical downlink shared channel, or one or more reference signals.

Some examples of the method, apparatuses, and non-transitory computer-readable medium described herein may further include operations, features, means, or instructions for dropping the message in accordance with the set of rules and based on the occasion including a multi-symbol resource having a transmission direction that conflicts with at least one subband of the at least one full-duplex symbol of the set of full-duplex symbols.

Some examples of the method, apparatuses, and non-transitory computer-readable medium described herein may further include operations, features, means, or instructions for performing rate matching around one or more resource blocks of the message in accordance with the set of rules, where the rate matching may be performed based on the occasion including the one or more resource blocks having a transmission direction that conflicts with at least one subband, or at least one guard band, or both, of the at least one full-duplex symbol of the set of full-duplex symbols, or at least one resource block of the set of non-full-duplex symbols.

Some examples of the method, apparatuses, and non-transitory computer-readable medium described herein may further include operations, features, means, or instructions for receiving, from a network entity, an indication to perform uplink cancellation for one or more resource blocks, or one or more symbols, or both, of the message in accordance with the set of rules, where the uplink cancellation may be performed based on the occasion including the one or more resource blocks having a transmission direction that conflicts with at least one subband, or at least one guard band, or both, of the at least one full-duplex symbol of the set of full-duplex symbols or at least one resource block of the set of non-full-duplex symbols.

Some examples of the method, apparatuses, and non-transitory computer-readable medium described herein may further include operations, features, means, or instructions for receiving a control message indicating a set of multiple frequency domain resource allocations, or a set of multiple time domain resource allocations, or both, for one or more resource blocks of one or more occasions of the message, identifying one or more respective occasions of the message associated with a first frequency domain resource allocation of the set of multiple frequency domain resource allocations, or a first time domain resource allocation of the set of multiple time domain resource allocations, or both, for the set of full-duplex symbols, based on the set of rules and the set of full-duplex symbols, where communicating the message may be based on the frequency domain resource allocation, or the time domain resource allocation, or both, and identifying one or more respective occasions of the message associated with a second frequency domain resource allocation of the plurality of frequency domain resource allocations, or a second time domain resource allocation of the plurality of time domain resource allocations, or both, for the set of non-full-duplex symbols, based at least in part on the set of rules and the set of non-full-duplex symbols, wherein communicating the message is based at least in part on the second frequency domain resource allocation, or the second time domain resource allocation, or both.

Some examples of the method, apparatuses, and non-transitory computer-readable medium described herein may further include operations, features, means, or instructions for performing rate matching around one or more resource blocks of the message in accordance with the set of rules, where the rate matching may be performed based on the occasion including the one or more resource blocks having a transmission direction that conflicts with at least one subband of the at least one full-duplex symbol of the set of full-duplex symbols, and where the one or more resource blocks correspond to the at least one subband or at least one guard band of the at least one full-duplex symbol and at least one subband of the at least one non-full-duplex symbol of the set of non-full-duplex symbols.

Some examples of the method, apparatuses, and non-transitory computer-readable medium described herein may further include operations, features, means, or instructions for receiving a control message indicating that the UE update at least one subband of the at least one full-duplex symbol in accordance with the set of rules, where the at least one full-duplex symbol of the set of full-duplex symbols corresponds to a downlink symbol or a flexible symbol and determining that the message corresponds to a downlink transmission and the occasion includes a multi-symbol resource having a transmission direction that conflicts with at least one subband of the at least one full-duplex symbol of the set of full-duplex symbols, where communicating the message includes receiving the downlink transmission via the occasion based on the control message.

Some examples of the method, apparatuses, and non-transitory computer-readable medium described herein may further include operations, features, means, or instructions for receiving a control message indicating that the UE update at least one subband of the at least one full-duplex symbol in accordance with the set of rules, where the at least one full-duplex symbol of the set of full-duplex symbols corresponds to a flexible symbol and determining that the message corresponds to an uplink transmission and the occasion includes a multi-symbol resource having a transmission direction that conflicts with at least one subband of the at least one full-duplex symbol of the set of full-duplex symbols, where communicating the message includes transmitting the uplink transmission via the occasion based on the control message.

Some examples of the method, apparatuses, and non-transitory computer-readable medium described herein may further include operations, features, means, or instructions for determining that the message corresponds to a downlink transmission and the occasion includes a multi-symbol resource having a transmission direction that corresponds to a transmission direction of a first subband of the at least one full-duplex symbol, where the message may be non-overlapping with one or more other subbands of the at least one full-duplex symbol, and where communicating the message includes receiving the downlink transmission via the first subband.

Some examples of the method, apparatuses, and non-transitory computer-readable medium described herein may further include operations, features, means, or instructions for determining that the message corresponds to an uplink transmission and the occasion includes a multi-symbol resource having a transmission direction that corresponds to a transmission direction of a first subband of the at least one full-duplex symbol, where the message may be non-overlapping with one or more other subbands of the at least one full-duplex symbol, and where communicating the message includes transmitting the uplink transmission via the first subband.

In some examples of the method, apparatuses, and non-transitory computer-readable medium described herein, a second occasion of the set of one or more occasions may be across the at least one non-full-duplex symbol of the set of non-full-duplex symbols and a gap period that may be between the set of non-full-duplex symbols and the set of full-duplex symbols and the method, apparatuses, and non-transitory computer-readable medium may include further operations, features, means, or instructions for dropping a second message of the second occasion in accordance with the set of rules.

In some examples of the method, apparatuses, and non-transitory computer-readable medium described herein, a second occasion of the set of one or more occasions may be across the at least one non-full-duplex symbol of the set of non-full-duplex symbols and a gap period that may be between the set of non-full-duplex symbols and the set of full-duplex symbols and the method, apparatuses, and non-transitory computer-readable medium may include further operations, features, means, or instructions for performing rate matching around one or more resource blocks of a second message included in the second occasion in accordance with the set of rules, where the one or more resource blocks overlap with the gap period and receiving the second message via the second occasion based on performing the rate matching around the one or more resource blocks.

In some examples of the method, apparatuses, and non-transitory computer-readable medium described herein, the occasion may be across the set of non-full-duplex symbols and the method, apparatuses, and non-transitory computer-readable medium may include further operations, features, means, or instructions for dropping the message in accordance with the set of rules and based on the occasion including a multi-symbol resource having a transmission direction that conflicts with at least one subband, or at least one guard band, or both, of the at least one full-duplex symbol of the set of full-duplex symbols or at least one or more resource blocks of the set of non-full-duplex symbols.

In some examples of the method, apparatuses, and non-transitory computer-readable medium described herein, the occasion may be across the set of non-full-duplex symbols and the method, apparatuses, and non-transitory computer-readable medium may include further operations, features, means, or instructions for performing rate matching around one or more resource blocks of the message in accordance with the set of rules, where the rate matching may be performed based on the occasion including the one or more resource blocks having a transmission direction that conflicts with at least one subband, or at least one guard band, or both, of the at least one full-duplex symbol of the set of full-duplex symbols or at least one or more resource blocks of the set of non-full-duplex symbols, and where the one or more resource blocks overlap with the gap period and the at least one full-duplex symbol or the at least one or more resource blocks of the set of non-full-duplex symbols.

In some examples of the method, apparatuses, and non-transitory computer-readable medium described herein, the occasion may be across the set of non-full-duplex symbols and the method, apparatuses, and non-transitory computer-readable medium may include further operations, features, means, or instructions for performing rate matching around one or more resource blocks of the message in accordance with the set of rules, where the rate matching may be performed based on the occasion including the one or more resource blocks having a transmission direction that conflicts with at least one subband, or at least one guard band, or both, of the at least one full-duplex symbol of the set of full-duplex symbols or at least one or more resource blocks of the set of non-full-duplex symbols, and where the one or more resource blocks overlap with the gap period, each subband of the at least one subband, and at least one subband of the at least one non-full-duplex symbol of the set of non-full-duplex symbols corresponding to the at least one subband of the at least one full-duplex symbol.

Some examples of the method, apparatuses, and non-transitory computer-readable medium described herein may further include operations, features, means, or instructions for bundling, in accordance with the set of rules, one or more demodulation reference signal symbols included in the occasion prior to the gap period that may be between the set of non-full-duplex symbols and the set of full-duplex symbols and bundling, in accordance with the set of rules, one or more demodulation reference signal symbols included in the occasion after the gap period that may be between the set of non-full-duplex symbols and the set of full-duplex symbols.

In some examples of the method, apparatuses, and non-transitory computer-readable medium described herein, the occasion may be across the set of non-full-duplex symbols and the method, apparatuses, and non-transitory computer-readable medium may include further operations, features, means, or instructions for dropping one or more resource blocks of the message in accordance with the set of rules and based on the one or more resource blocks having a transmission direction that conflicts with at least one subband, or at least one guard band, or both, of the at least one full-duplex symbol of the set of full-duplex symbols or at least one or more resource blocks of the set of non-full-duplex symbols, and where the one or more resource blocks overlap with the gap period, each subband of the at least one subband, and at least one subband of the at least one non-full-duplex symbol of the set of non-full-duplex symbols corresponding to the at least one subband of the at least one full-duplex symbol.

Some examples of the method, apparatuses, and non-transitory computer-readable medium described herein may further include operations, features, means, or instructions for performing rate matching around the one or more resource blocks of the message in accordance with the set of rules, where the rate matching may be performed based on one or more demodulation reference signal symbols being included in the occasion prior to the gap period that may be between the set of non-full-duplex symbols and the set of full-duplex symbols.

In some examples of the method, apparatuses, and non-transitory computer-readable medium described herein, the occasion may be across the set of non-full-duplex symbols and the method, apparatuses, and non-transitory computer-readable medium may include further operations, features, means, or instructions for performing rate matching around one or more resource blocks of the message in accordance with the set of rules and based on the occasion including the one or more resource blocks having a transmission direction that conflicts with at least one subband, or at least one guard band, or both, of the at least one full-duplex symbol of the set of full-duplex symbols or at least one or more resource blocks of the set of non-full-duplex symbols, where the one or more resource blocks overlap with the gap period and each subband of the at least one subband, and where the rate matching may be performed based on one or more demodulation reference signal symbols being included in the occasion prior to and after the gap period that may be between the set of non-full-duplex symbols and the set of full-duplex symbols.

In some examples of the method, apparatuses, and non-transitory computer-readable medium described herein, the one or more resource blocks further overlap with a remaining portion of the message after the occasion prior to the gap period and the rate matching may be performed based on the one or more demodulation reference signal symbols being included in the occasion prior to the gap period that may be between the set of non-full-duplex symbols and the set of full-duplex symbols.

In some examples of the method, apparatuses, and non-transitory computer-readable medium described herein, the occasion may be across the set of non-full-duplex symbols and the method, apparatuses, and non-transitory computer-readable medium may include further operations, features, means, or instructions for dropping one or more resource blocks of the message in accordance with the set of rules and based on the occasion including the one or more resource blocks having a transmission direction that may be same as at least one subband, or at least one guard band, or both, of the at least one full-duplex symbol of the set of full-duplex symbols or at least one or more resource blocks of the set of non-full-duplex symbols, where the message may be non-overlapping with one or more other subbands of the at least one full-duplex symbol.

In some examples of the method, apparatuses, and non-transitory computer-readable medium described herein, the occasion may be across the set of non-full-duplex symbols and the method, apparatuses, and non-transitory computer-readable medium may include further operations, features, means, or instructions for performing rate matching around one or more resource blocks of the message in accordance with the set of rules and based on the occasion including the one or more resource blocks having a transmission direction that may be same as at least one subband, or at least one guard band, or both, of the at least one full-duplex symbol of the set of full-duplex symbols or at least one or more resource blocks of the set of non-full-duplex symbols, where the message may be non-overlapping with one or more other subbands of the at least one full-duplex symbol, and where the rate matching may be performed based on one or more demodulation reference signal symbols being included in the occasion prior to the gap period that may be between the set of non-full-duplex symbols and the set of full-duplex symbols.

In some examples of the method, apparatuses, and non-transitory computer-readable medium described herein, the occasion may be across the set of non-full-duplex symbols and the method, apparatuses, and non-transitory computer-readable medium may include further operations, features, means, or instructions for performing rate matching around one or more resource blocks of the message in accordance with the set of rules and based on the occasion including the one or more resource blocks having a transmission direction that may be same as at least one subband, or at least one guard band, or both, of the at least one full-duplex symbol of the set of full-duplex symbols or at least one or more resource blocks of the set of non-full-duplex symbols, where the message may be non-overlapping with one or more other subbands of the at least one full-duplex symbol, and where the one or more resource blocks overlap with the gap period.

Some examples of the method, apparatuses, and non-transitory computer-readable medium described herein may further include operations, features, means, or instructions for bundling, in accordance with the set of rules, one or more demodulation reference signal symbols included in the occasion prior to the gap period that may be between the set of non-full-duplex symbols and the set of full-duplex symbols and bundling, in accordance with the set of rules, one or more demodulation reference signal symbols included in the occasion after the gap period that may be between the set of non-full-duplex symbols and the set of full-duplex symbols.

In some examples of the method, apparatuses, and non-transitory computer-readable medium described herein, the occasion may be across the set of non-full-duplex symbols and the method, apparatuses, and non-transitory computer-readable medium may include further operations, features, means, or instructions for performing rate matching around one or more resource blocks of the message in accordance with the set of rules and based on the occasion including the one or more resource blocks having a transmission direction that may be configured same as at least one subband, or at least one guard band, or both, of the at least one full-duplex symbol of the set of full-duplex symbols or at least one or more resource blocks of the set of non-full-duplex symbols, where the message may be non-overlapping with one or more other subbands of the at least one full-duplex symbol, and where the one or more resource blocks overlap with the gap period and each subband of the at least one subband.

Some examples of the method, apparatuses, and non-transitory computer-readable medium described herein may further include operations, features, means, or instructions for receiving, from a network entity, a control signal indicating the set of rules, where communicating the message may be based on receiving the control signal.

In some examples of the method, apparatuses, and non-transitory computer-readable medium described herein, the message includes a physical downlink control channel without repetition, a physical uplink control channel without repetition, a physical uplink shared channel without repetition, physical downlink shared channel without repetition, a physical downlink control channel with repetition, a physical uplink control channel with repetition, a physical uplink shared channel with repetition, physical downlink shared channel with repetition, a sounding reference signal, a channel state information reference signal, a transport block over multiple slots with repetition, a transport block over multiple slots without repetition, multiple physical uplink shared channel scheduled by a single downlink control information, multiple physical downlink shared channel scheduled by a single downlink control information, or a combination thereof.

In some examples of the method, apparatuses, and non-transitory computer-readable medium described herein, the set of full-duplex symbols and the set of non-full-duplex symbols may be included in same slot or in different slots.

In some examples of the method, apparatuses, and non-transitory computer-readable medium described herein, the set of full-duplex symbols and the set of non-full-duplex symbols included in different slots include physical uplink shared channel repetition type B or supports transport block processing over multiple slots or both.

A method for wireless communication at a network entity is described. The method may include transmitting, to a UE, an indication that an occasion of a set of one or more occasions for a message occurs over a set of multiple symbols, where the set of multiple symbols includes a set of full-duplex symbols and a set of non-full-duplex symbols and communicating the message via the occasion in accordance with a set of rules and based on the occasion being across at least one full-duplex symbol of the set of full-duplex symbols and at least one non-full-duplex symbol of the set of non-full-duplex symbols.

An apparatus for wireless communication at a network entity is described. The apparatus may include a processor, memory coupled with the processor, and instructions stored in the memory. The instructions may be executable by the processor (e.g., directly, indirectly, after pre-processing, without pre-processing) to cause the apparatus to transmit, to a UE, an indication that an occasion of a set of one or more occasions for a message occurs over a set of multiple symbols, where the set of multiple symbols includes a set of full-duplex symbols and a set of non-full-duplex symbols and communicate the message via the occasion in accordance with a set of rules and based on the occasion being across at least one full-duplex symbol of the set of full-duplex symbols and at least one non-full-duplex symbol of the set of non-full-duplex symbols.

Another apparatus for wireless communication at a network entity is described. The apparatus may include means for transmitting, to a UE, an indication that an occasion of a set of one or more occasions for a message occurs over a set of multiple symbols, where the set of multiple symbols includes a set of full-duplex symbols and a set of non-full-duplex symbols and means for communicating the message via the occasion in accordance with a set of rules and based on the occasion being across at least one full-duplex symbol of the set of full-duplex symbols and at least one non-full-duplex symbol of the set of non-full-duplex symbols.

A non-transitory computer-readable medium storing code for wireless communication at a network entity is described. The code may include instructions executable by a processor to transmit, to a UE, an indication that an occasion of a set of one or more occasions for a message occurs over a set of multiple symbols, where the set of multiple symbols includes a set of full-duplex symbols and a set of non-full-duplex symbols and communicate the message via the occasion in accordance with a set of rules and based on the occasion being across at least one full-duplex symbol of the set of full-duplex symbols and at least one non-full-duplex symbol of the set of non-full-duplex symbols.

In some examples of the method, apparatuses, and non-transitory computer-readable medium described herein, the set of rules indicate that communication of the message via the occasion may be allowed based on the message being a first type of message and the occasion including a multi-symbol resource having a transmission direction that conflicts with at least one subband of the at least one full-duplex symbol of the set of full-duplex symbols.

In some examples of the method, apparatuses, and non-transitory computer-readable medium described herein, the first type of message includes a physical uplink shared channel, or a physical downlink shared channel, or one or more reference signals.

Some examples of the method, apparatuses, and non-transitory computer-readable medium described herein may further include operations, features, means, or instructions for dropping the message in accordance with the set of rules and based on the occasion including a multi-symbol resource having a transmission direction that conflicts with at least one subband of the at least one full-duplex symbol of the set of full-duplex symbols.

Some examples of the method, apparatuses, and non-transitory computer-readable medium described herein may further include operations, features, means, or instructions for performing uplink cancellation for one or more resource blocks, or one or more symbols, or both, of the message in accordance with the set of rules, where the uplink cancellation may be performed based on the occasion including the one or more resource blocks having a transmission direction that conflicts with at least one subband, or at least one guard band, or both, of the at least one full-duplex symbol of the set of full-duplex symbols or at least one resource block of the set of non-full-duplex symbols.

Some examples of the method, apparatuses, and non-transitory computer-readable medium described herein may further include operations, features, means, or instructions for transmitting, to the UE, an indication to perform the uplink cancellation for the one or more resource blocks of the message in accordance with the set of rules.

Some examples of the method, apparatuses, and non-transitory computer-readable medium described herein may further include operations, features, means, or instructions for transmitting a control message indicating a set of multiple frequency domain resource allocations, or a set of multiple time domain resource allocations, or both, for one or more resource blocks of the message.

Some examples of the method, apparatuses, and non-transitory computer-readable medium described herein may further include operations, features, means, or instructions for performing uplink cancellation for one or more resource blocks, or one or more symbols, or both, of the message in accordance with the set of rules, where the uplink cancellation may be performed based on the occasion including the one or more resource blocks having a transmission direction that conflicts with at least one subband of the at least one full-duplex symbol of the set of full-duplex symbols, and where the one or more resource blocks correspond to the at least one subband, or at least one guard band, or both, of the at least one full-duplex symbol and at least one subband of the at least one non-full-duplex symbol of the set of non-full-duplex symbols.

Some examples of the method, apparatuses, and non-transitory computer-readable medium described herein may further include operations, features, means, or instructions for transmitting a control message indicating that the UE update at least one subband of the at least one full-duplex symbol in accordance with the set of rules, where the at least one full-duplex symbol of the set of full-duplex symbols corresponds to a downlink symbol or a flexible symbol and determining that the message corresponds to a downlink transmission and the occasion includes a multi-symbol resource having a transmission direction that conflicts with at least one subband of the at least one full-duplex symbol of the set of full-duplex symbols, where communicating the message includes transmitting the downlink transmission via the occasion based on the control message.

Some examples of the method, apparatuses, and non-transitory computer-readable medium described herein may further include operations, features, means, or instructions for transmitting a control message indicating that the UE update at least one subband of the at least one full-duplex symbol in accordance with the set of rules, where the at least one full-duplex symbol of the set of full-duplex symbols corresponds to a flexible symbol and determining that the message corresponds to an uplink transmission and the occasion includes a multi-symbol resource having a transmission direction that conflicts with at least one subband of the at least one full-duplex symbol of the set of full-duplex symbols, where communicating the message includes receiving the uplink transmission via the occasion based on the control message.

Some examples of the method, apparatuses, and non-transitory computer-readable medium described herein may further include operations, features, means, or instructions for determining that the message corresponds to a downlink transmission and the occasion includes a multi-symbol resource having a transmission direction that corresponds to a transmission direction of a first subband of the at least one full-duplex symbol, where the message may be non-overlapping with one or more other subbands of the at least one full-duplex symbol, and where communicating the message includes transmitting the downlink transmission via the first subband.

Some examples of the method, apparatuses, and non-transitory computer-readable medium described herein may further include operations, features, means, or instructions for determining that the message corresponds to an uplink transmission and the occasion includes a multi-symbol resource having a transmission direction that corresponds to a transmission direction of a first subband of the at least one full-duplex symbol, where the message may be non-overlapping with one or more other subbands of the at least one full-duplex symbol, and where communicating the message includes receiving the uplink transmission via the first subband.

In some examples of the method, apparatuses, and non-transitory computer-readable medium described herein, a second occasion of the set of one or more occasions may be across the at least one non-full-duplex symbol of the set of non-full-duplex symbols and a gap period that may be between the set of non-full-duplex symbols and the set of full-duplex symbols and the method, apparatuses, and non-transitory computer-readable medium may include further operations, features, means, or instructions for dropping a second message of the second occasion in accordance with the set of rules.

In some examples of the method, apparatuses, and non-transitory computer-readable medium described herein, a second occasion of the set of one or more occasions may be across the at least one non-full-duplex symbol of the set of non-full-duplex symbols and a gap period that may be between the set of non-full-duplex symbols and the set of full-duplex symbols and the method, apparatuses, and non-transitory computer-readable medium may include further operations, features, means, or instructions for performing uplink cancellation for one or more resource blocks, or one or more symbols, or both, of a second message included in the second occasion in accordance with the set of rules, where the one or more resource blocks overlap with the gap period and receiving the second message via the second occasion based on performing the uplink cancellation for the one or more resource blocks, or the one or more symbols, or both.

In some examples of the method, apparatuses, and non-transitory computer-readable medium described herein, the occasion may be across the set of non-full-duplex symbols and the method, apparatuses, and non-transitory computer-readable medium may include further operations, features, means, or instructions for dropping the message in accordance with the set of rules and based on the occasion including a multi-symbol resource having a transmission direction that conflicts with at least one subband, or at least one guard band, or both, of the at least one full-duplex symbol of the set of full-duplex symbols or at least one or more resource blocks of the set of non-full-duplex symbols or at least one or more resource blocks of the set of non-full-duplex symbols.

In some examples of the method, apparatuses, and non-transitory computer-readable medium described herein, the occasion may be across the set of non-full-duplex symbols and the method, apparatuses, and non-transitory computer-readable medium may include further operations, features, means, or instructions for performing uplink cancellation for one or more resource blocks, or one or more symbols, or both, of the message in accordance with the set of rules, where the uplink cancellation may be performed based on the occasion including the one or more resource blocks having a transmission direction that conflicts with at least one subband, or at least one guard band, or both, of the at least one full-duplex symbol of the set of full-duplex symbols or at least one or more resource blocks of the set of non-full-duplex symbols, and where the one or more resource blocks overlap with the gap period and the at least one full-duplex symbol or at least one or more resource blocks of the set of non-full-duplex symbols.

In some examples of the method, apparatuses, and non-transitory computer-readable medium described herein, the occasion may be across the set of non-full-duplex symbols and the method, apparatuses, and non-transitory computer-readable medium may include further operations, features, means, or instructions for performing uplink cancellation for one or more resource blocks, or one or more symbols, or both, of the message in accordance with the set of rules, where the uplink cancellation may be performed based on the occasion including the one or more resource blocks having a transmission direction that conflicts with at least one subband, or at least one guard band, or both, of the at least one full-duplex symbol of the set of full-duplex symbols or at least one or more resource blocks of the set of non-full-duplex symbols, and where the one or more resource blocks overlap with the gap period, each subband of the at least one subband, and at least one subband of the at least one non-full-duplex symbol of the set of non-full-duplex symbols corresponding to the at least one subband of the at least one full-duplex symbol.

Some examples of the method, apparatuses, and non-transitory computer-readable medium described herein may further include operations, features, means, or instructions for bundling, in accordance with the set of rules, one or more demodulation reference signal symbols included in the occasion prior to the gap period that may be between the set of non-full-duplex symbols and the set of full-duplex symbols and bundling, in accordance with the set of rules, one or more demodulation reference signal symbols included in the occasion after the gap period that may be between the set of non-full-duplex symbols and the set of full-duplex symbols.

In some examples of the method, apparatuses, and non-transitory computer-readable medium described herein, the occasion may be across the set of non-full-duplex symbols and the method, apparatuses, and non-transitory computer-readable medium may include further operations, features, means, or instructions for dropping one or more resource blocks of the message in accordance with the set of rules and based on the occasion including the one or more resource blocks having a transmission direction that conflicts with at least one subband, or at least one guard band, or both, of the at least one full-duplex symbol of the set of full-duplex symbols or at least one or more resource blocks of the set of non-full-duplex symbols, and where the one or more resource blocks overlap with the gap period, each subband of the at least one subband, and at least one subband of the at least one non-full-duplex symbol of the set of non-full-duplex symbols corresponding to the at least one subband of the at least one full-duplex symbol.

Some examples of the method, apparatuses, and non-transitory computer-readable medium described herein may further include operations, features, means, or instructions for performing uplink cancellation for the one or more resource blocks, or one or more symbols, or both, of the message in accordance with the set of rules, where the uplink cancellation may be performed based on one or more demodulation reference signal symbols being included in the occasion prior to the gap period that may be between the set of non-full-duplex symbols and the set of full-duplex symbols.

In some examples of the method, apparatuses, and non-transitory computer-readable medium described herein, the occasion may be across the set of non-full-duplex symbols and the method, apparatuses, and non-transitory computer-readable medium may include further operations, features, means, or instructions for performing uplink cancellation for one or more resource blocks, or one or more symbols, or both, of the message in accordance with the set of rules and based on the occasion including the one or more resource blocks having a transmission direction that conflicts with at least one subband, or at least one guard band, or both, of the at least one full-duplex symbol of the set of full-duplex symbols or at least one or more resource blocks of the set of non-full-duplex symbols, where the one or more resource blocks overlap with the gap period and each subband of the at least one subband, and where the uplink cancellation may be performed based on one or more demodulation reference signal symbols being included in the occasion prior to and after the gap period that may be between the set of non-full-duplex symbols and the set of full-duplex symbols.

In some examples of the method, apparatuses, and non-transitory computer-readable medium described herein, the one or more resource blocks further overlap with a remaining portion of the message after the occasion prior to the gap period and the uplink cancellation may be performed based on one or more demodulation reference signal symbols being included in the occasion prior to the gap period that may be between the set of non-full-duplex symbols and the set of full-duplex symbols.

In some examples of the method, apparatuses, and non-transitory computer-readable medium described herein, the occasion may be across the set of non-full-duplex symbols and the method, apparatuses, and non-transitory computer-readable medium may include further operations, features, means, or instructions for dropping one or more resource blocks of the message in accordance with the set of rules and based on the occasion including the one or more resource blocks having a transmission direction that may be configured same as at least one subband, or at least one guard band, or both, of the at least one full-duplex symbol of the set of full-duplex symbols or at least one or more resource blocks of the set of non-full-duplex symbols, where the message may be non-overlapping with one or more other subbands of the at least one full-duplex symbol.

In some examples of the method, apparatuses, and non-transitory computer-readable medium described herein, the occasion may be across the set of non-full-duplex symbols and the method, apparatuses, and non-transitory computer-readable medium may include further operations, features, means, or instructions for performing uplink cancellation for one or more resource blocks, or one or more symbols, or both, of the message in accordance with the set of rules and based on the occasion including the one or more resource blocks having a transmission direction that may be configured same as at least one subband, or at least one guard band, or both, of the at least one full-duplex symbol of the set of full-duplex symbols or at least one or more resource blocks of the set of non-full-duplex symbols, where the message may be non-overlapping with one or more other subbands of the at least one full-duplex symbol, and where the uplink cancellation may be performed based on one or more demodulation reference signal symbols being included in the occasion prior to the gap period that may be between the set of non-full-duplex symbols and the set of full-duplex symbols.

In some examples of the method, apparatuses, and non-transitory computer-readable medium described herein, the occasion may be across the set of non-full-duplex symbols and the method, apparatuses, and non-transitory computer-readable medium may include further operations, features, means, or instructions for performing uplink cancellation for one or more resource blocks, or one or more symbols, or both, of the message in accordance with the set of rules and based on the occasion including the one or more resource blocks having a transmission direction that may be same as at least one subband of the at least one full-duplex symbol of the set of full-duplex symbols, where the message may be non-overlapping with one or more other subbands of the at least one full-duplex symbol, and where the one or more resource blocks overlap with the gap period.

Some examples of the method, apparatuses, and non-transitory computer-readable medium described herein may further include operations, features, means, or instructions for bundling, in accordance with the set of rules, one or more demodulation reference signal symbols included in the occasion prior to the gap period that may be between the set of non-full-duplex symbols and the set of full-duplex symbols and bundling, in accordance with the set of rules, one or more demodulation reference signal symbols included in the occasion after the gap period that may be between the set of non-full-duplex symbols and the set of full-duplex symbols.

In some examples of the method, apparatuses, and non-transitory computer-readable medium described herein, the occasion may be across the set of non-full-duplex symbols and the method, apparatuses, and non-transitory computer-readable medium may include further operations, features, means, or instructions for performing uplink cancellation for one or more resource blocks, or one or more symbols, or both, of the message in accordance with the set of rules and based on the occasion including the one or more resource blocks having a transmission direction that may be same as at least one subband, or at least one guard band, or both, of the at least one full-duplex symbol of the set of full-duplex symbols or at least one or more resource blocks of the set of non-full-duplex symbols, where the message may be non-overlapping with one or more other subbands of the at least one full-duplex symbol, and where the one or more resource blocks overlap with the gap period and each subband of the at least one subband.

Some examples of the method, apparatuses, and non-transitory computer-readable medium described herein may further include operations, features, means, or instructions for transmitting, to the UE, a control signal indicating the set of rules, where communicating the message may be based on receiving the control signal.

In some examples of the method, apparatuses, and non-transitory computer-readable medium described herein, the message includes at least one of a physical downlink control channel without repetition, a physical uplink control channel without repetition, a physical uplink shared channel without repetition, physical downlink shared channel without repetition, a physical downlink control channel with repetition, a physical uplink control channel with repetition, a physical uplink shared channel with repetition, physical downlink shared channel with repetition, a sounding reference signal, a channel state information reference signal, a transport block over multiple slots with repetition, a transport block over multiple slots without repetition, multiple physical uplink shared channel scheduled by a single downlink control information, multiple physical downlink shared channel scheduled by a single downlink control information, or a combination thereof.

In some examples of the method, apparatuses, and non-transitory computer-readable medium described herein, the set of full-duplex symbols and the set of non-full-duplex symbols may be included in same slot or in different slots.

In some examples of the method, apparatuses, and non-transitory computer-readable medium described herein, the set of full-duplex symbols and the set of non-full-duplex symbols included in different slots include physical uplink shared channel repetition type B or supports transport block processing over multiple slots or both.

### BRIEF DESCRIPTION OF THE DRAWINGS

FIG. 1 illustrates an example of a wireless communications system that supports techniques for single transmission occasions across different symbols in accordance with one or more aspects of the present disclosure.

FIG. 2 illustrates an example of a wireless communications system that supports techniques for single transmission occasions across different symbols in accordance with one or more aspects of the present disclosure.

FIG. 3 illustrates an example of a slot structure that supports techniques for single transmission occasions across different symbols in accordance with one or more aspects of the present disclosure.

FIG. 4 illustrates an example of a slot structure that supports techniques for single transmission occasions across different symbols in accordance with one or more aspects of the present disclosure.

FIG. 5 illustrates an example of a slot structure that supports techniques for single transmission occasions across different symbols in accordance with one or more aspects of the present disclosure.

FIG. 6 illustrates an example of a slot structure that supports techniques for single transmission occasions across different symbols in accordance with one or more aspects of the present disclosure.

FIG. 7 illustrates an example of a slot structure that supports techniques for single transmission occasions across different symbols in accordance with one or more aspects of the present disclosure.

FIG. 8 illustrates an example of a slot structure that supports techniques for single transmission occasions across different symbols in accordance with one or more aspects of the present disclosure.

FIG. 9 illustrates an example of a slot structure that supports techniques for single transmission occasions across different symbols in accordance with one or more aspects of the present disclosure.

FIG. 10 illustrates an example of a slot structure that supports techniques for single transmission occasions across different symbols in accordance with one or more aspects of the present disclosure.

FIG. 11 illustrates an example of a slot structure that supports techniques for single transmission occasions across different symbols in accordance with one or more aspects of the present disclosure.

FIG. 12 illustrates an example of a slot structure that supports techniques for single transmission occasions across different symbols in accordance with one or more aspects of the present disclosure.

FIG. 13 illustrates an example of a slot structure that supports techniques for single transmission occasions across different symbols in accordance with one or more aspects of the present disclosure.

FIG. 14 illustrates an example of a slot structure that supports techniques for single transmission occasions across different symbols in accordance with one or more aspects of the present disclosure.

FIG. 15 illustrates an example of a slot structure that supports techniques for single transmission occasions across different symbols in accordance with one or more aspects of the present disclosure.

FIGS. 16 and 17 illustrate block diagrams of devices that support techniques for single transmission occasions across different symbols in accordance with one or more aspects of the present disclosure.

FIG. 18 illustrates a block diagram of a communications manager that supports techniques for single transmission occasions across different symbols in accordance with one or more aspects of the present disclosure.

FIG. 19 illustrates a diagram of a system including a device that supports techniques for single transmission occasions across different symbols in accordance with one or more aspects of the present disclosure.

FIGS. 20 and 21 illustrate block diagrams of devices that support techniques for single transmission occasions across different symbols in accordance with one or more aspects of the present disclosure.

FIG. 22 illustrates a block diagram of a communications manager that supports techniques for single transmission occasions across different symbols in accordance with one or more aspects of the present disclosure.

FIG. 23 illustrates a diagram of a system including a device that supports techniques for single transmission occasions across different symbols in accordance with one or more aspects of the present disclosure.

FIGS. 24 through 27 illustrate flowcharts showing methods that support techniques for single transmission occasions across different symbols in accordance with one or more aspects of the present disclosure.

### DETAILED DESCRIPTION

In some systems, one or more wireless communication devices may support full-duplex or flexible time-division duplexing communications, according to which such devices may simultaneously transmit and receive or may switch between uplink and downlink communication across various time intervals, respectively. In some deployments, a full-duplex or dynamic time-division duplexing capable device may support a sub-band configuration according to which the device may transmit via a first set of one or more sub-bands and receive via a second set of one or more sub-bands, where the first and second sets of sub-bands may overlap or may be non-overlapping in the frequency domain. A time interval supporting multiple sub-bands and full-duplex configuration may be referred to as a subband full-duplex time interval and a time interval supporting multiple sub-bands and non-full-duplex configuration may be referred to as a non-subband full-duplex time interval. Techniques for uplink transmissions and downlink receptions across subband full-duplex symbols and non-subband full-duplex symbols may be enhanced.

One or more aspects of the present disclosure provide for multiple aspects for uplink transmissions and downlink receptions across subband full-duplex symbols and non-subband full-duplex symbols. The aspects depict a set of rules for managing uplink transmissions and downlink receptions at a user equipment (UE) over subband full-duplex symbols and non-subband full-duplex symbols. In particular, the present disclosure provides techniques for communicating over a single occasion (e.g., uplink occasion or downlink occasion) that spans across full duplex symbols (e.g., subband full-duplex symbols) and non-full-duplex symbols (e.g., non-subband full-duplex symbols). The UE may communicate in accordance with a set of rules to handle an occasion overlapping subband full-duplex symbols and non-subband full-duplex symbols. In one case, when a single occasion is scheduled to be across both types of symbols, such an occasion may not be allowed and the UE may not expect such an occasion to occur. In another example, the UE may either drop the occasion or drop a portion of the occasion (that overlaps with a sub-band having a different transmission direction). Additionally, or alternatively, the UE may rate match around the conflicting resource blocks. In another case, when a single occasion is scheduled to be across both types of symbols and across a gap period between the two types of symbols, the UE may either drop the occasion or drop a portion of the occasion. The UE may also rate match around the conflicting resource blocks included in the gap period as well as in the subbands of the subband full-duplex symbol. In some examples, the UE may only rate match around the conflicting resource blocks included in the gap period.

Aspects of the disclosure are initially described in the context of wireless communications systems. Aspects of the disclosure are further illustrated by slot structures. Aspects of the disclosure are further illustrated by and described with reference to apparatus diagrams, system diagrams, and flowcharts that relate to techniques for single transmission occasions across different symbols.

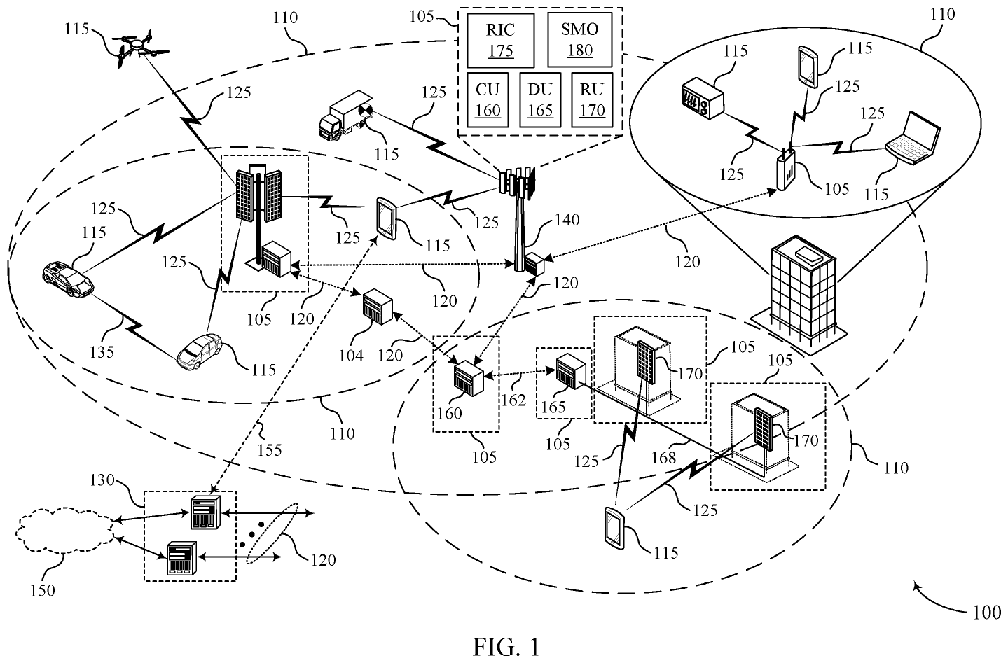

FIG. 1 illustrates an example of a wireless communications system 100 that supports techniques for single transmission occasions across different symbols in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160.

Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for single transmission occasions across different symbols as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may be a device such as a cellular phone, a smart phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may also refer to a wireless local loop (WLL) station, an Internet of Things (IoT) device, an Internet of Everything (IoE) device, or an MTC device, or the like, which may be implemented in various articles such as appliances, drones, robots, vehicles, meters, or the like.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, a UE 115 may receive an indication that an occasion of a set of one or more occasions for a message occurs over a set of symbols. In some examples, the set of symbols may include a set of full-duplex symbols and a set of non-full-duplex symbols. The UE 115 may then communicate the message via the occasion in accordance with a set of rules and based on the occasion being across at least one full-duplex symbol of the set of full-duplex symbols and at least one non-full-duplex symbol of the set of non-full-duplex symbols.

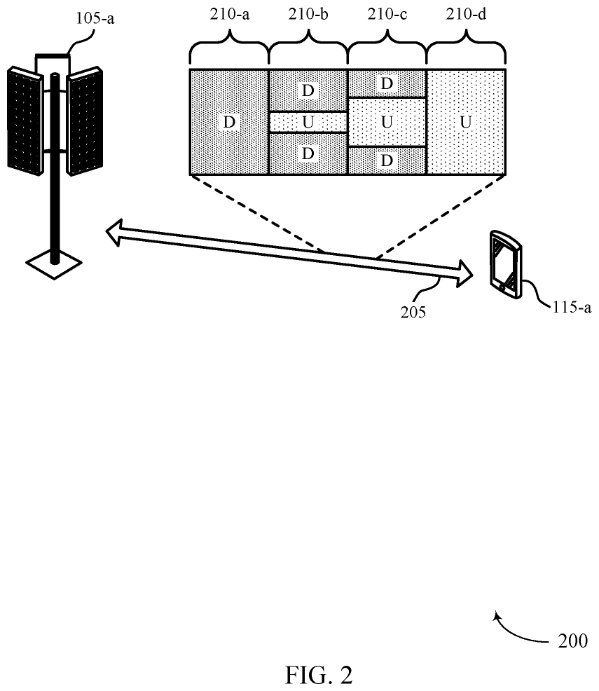

FIG. 2 illustrates an example of a wireless communications system 200 that supports techniques for single transmission occasions across different symbols in accordance with one or more aspects of the present disclosure. In some examples, the wireless communications system 200 may implement aspects of wireless communications system 100. For instance, the wireless communications system 200 may include a network entity 105-a and a UE 115-a, which may be examples of corresponding devices described herein. The network entity 105-a and the UE 115-a may communicate via a communication link 205.

The network entity 105-a and the UE 115-a may each be configured to communicate according to a full duplex communication configuration (e.g., supportive of both downlink communications and uplink communications simultaneously), such as inband full-duplex, subband full-duplex, or the like, among other examples. For example, the communication link 205 may be used for downlink communications, uplink communications, or both. As illustrated, the network entity 105-a and the UE 115-a may communicate transmissions via slots 210, where each slot 210 may be structured to support communications in one or more directions.

The slots 210 may be examples of subband full-duplex slots structured according to a subband full-duplex slot format or non-subband full-duplex, where one or more portions of a slot are allocated for uplink transmissions and one or more other portions of the slot are allocated for downlink transmissions. The slot format may be defined as a ‘D+U’ slot, which may be a slot in which a frequency band (or frequency subband) is used for both uplink and downlink transmissions. The downlink and uplink transmissions may occur in overlapping bands or adjacent bands (e.g., subband full-duplex). In some examples, downlink and uplink bands in a ‘D+U’ slot may be separated by a frequency guard band, which may reduce interference between the bands. In a given ‘D+U’ slot, a full duplex UE 115 can transmit in an uplink band and/or receive in a downlink band in a same slot. For example, slot 210-a may include only downlink symbols, while slots 210-b and 210-c include uplink and downlink symbols, and slot 210-d may include only uplink symbols. Further, slots 210-b and 210-c may each include two downlink subbands and one uplink subband, though the downlink subbands within slot 210-b may each be wider than the downlink subbands in slot 210-c. Thus, the slots 210-a and 210-d may be considered non-subband full-duplex the slots 210-b and 210-c may be considered subband full-duplex slots.

The wireless communications system 200 may support duplex enhancement at the network entity side and half duplex operation at the UE side. In case of in-band full-duplex operation, the UE 115-a and the network entity 105-a may transmit and receive on the same time and frequency resource. The downlink and uplink may share the same in-band full-duplex time and frequency resource (full or partial overlap). In case of subband full-duplex operation, the UE 115-a and the network entity 105-a may transmit and receive at the same time but on the different frequency resources. The downlink resource may be separated from the uplink resource in frequency domain. In subband full-duplex, an increase in uplink duty cycle may lead to: latency reduction, (e.g., it may be possible to transmit uplink signal in downlink only slots or receive downlink signal in uplink only slots), which can enable latency savings. The increase in uplink duty cycle may also provide uplink coverage improvement. The wireless communications system 200 may enhance system capacity or resource utilization or spectrum efficiency. Additionally, or alternatively, the wireless communications system 200 may enable flexible and dynamic uplink or downlink resource adaption according to uplink or downlink traffic in a robust manner.

According to one or more aspects depicted herein, the wireless communications system 200 may support transmission and reception of a scheduled or configured physical downlink control channel without repetition, a scheduled or configured physical uplink control channel without repetition, a scheduled or configured physical uplink shared channel without repetition, a scheduled or configured physical downlink shared channel without repetition, a scheduled or configured physical downlink control channel with repetition, a scheduled or configured physical uplink control channel with repetition, a scheduled or configured physical uplink shared channel with repetition, a scheduled or configured physical downlink shared channel with repetition, a scheduled or configured sounding reference signal, a scheduled or configured channel state information reference signal, a scheduled or configured transport block over multiple slots with repetition, a scheduled or configured transport block over multiple slots without repetition, multiple physical uplink shared channel scheduled by a single downlink control information, multiple physical downlink shared channel scheduled by a single downlink control information, or a combination thereof. Techniques depicted herein support resource allocation in frequency domain including frequency hopping, resource allocation in time domain, power domain, and spatial domain.

In some examples, the UE 115-a may receive an indication that an occasion of a set of one or more occasions for a message occurs over a set of symbols, where the set of symbols includes a set of full-duplex symbols and a set of non-full-duplex symbols. The UE 115-a may communicate the message via the occasion in accordance with a set of rules and based on the occasion being across at least one full-duplex symbol of the set of full-duplex symbols and at least one non-full-duplex symbol of the set of non-full-duplex symbols. In some examples, the set of full-duplex symbols and the set of non-full-duplex symbols may be included in same slot or in different slots. Additionally, or alternatively, the set of full-duplex symbols and the set of non-full-duplex symbols may be included in different slots may include physical uplink shared channel repetition type B or supports transport block processing over multiple slots or both.

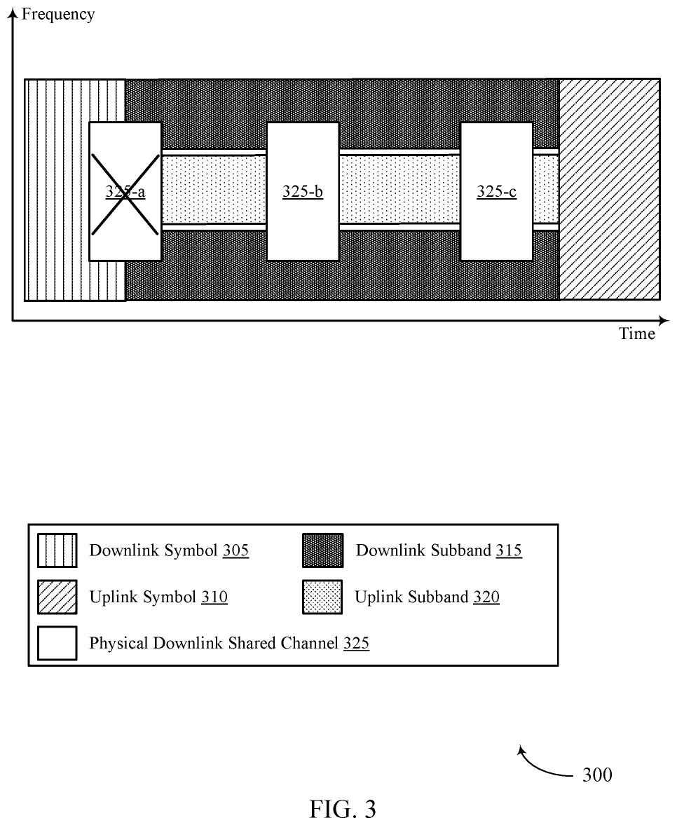

FIG. 3 illustrates an example of a slot structure 300 that supports techniques for single transmission occasions across different symbols in accordance with one or more aspects of the present disclosure. The slot structure 300 includes one or more full-duplex symbols and one or more non-full-duplex symbols. The full-duplex symbols may be referred to as subband full-duplex symbols and the non-full-duplex symbols may be referred to as non-subband full-duplex symbols. The non-full-duplex symbols include downlink symbol 305 and uplink symbol 310. The full-duplex symbols include downlink subband 315, which may include or be examples of downlink frequency bands (e.g., downlink subbands), and uplink subband 320, which may include or be examples of uplink frequency bands (e.g., uplink subbands). The network entity 105 may transmit, and the UE 115 may receive, downlink communications, such as physical downlink shared channel 325.

In the example of FIG. 3, the network entity 105 may transmit multiple occasions of the physical downlink shared channel 325 (e.g., physical downlink shared channel 325-a, physical downlink shared channel 325-b, and physical downlink shared channel 325-c), which in some examples may be based on repetitions of the physical downlink shared channel 325, a semi-persistent scheduling configuration for the physical downlink shared channel 325, among other examples. A single occasion of the physical downlink shared channel may be scheduled across both types of symbols.

Although depicted as a physical downlink shared channel, it is to be understood that the single occasion may be one occasion of one or more of a scheduled or configured physical downlink control channel without repetition, a scheduled or configured physical uplink control channel without repetition, a scheduled or configured physical uplink shared channel without repetition, a scheduled or configured physical downlink shared channel without repetition, a scheduled or configured physical downlink control channel with repetition, a scheduled or configured physical uplink control channel with repetition, a physical uplink shared channel with repetition, a scheduled or configured physical downlink shared channel with repetition, a scheduled or configured sounding reference signal, a scheduled or configured channel state information reference signal, a scheduled or configured transport block over multiple slots with repetition, a scheduled or configured transport block over multiple slots without repetition, multiple physical uplink shared channel scheduled by a single downlink control information, multiple physical downlink shared channel scheduled by a single downlink control information, or a combination thereof.

As depicted in FIG. 3, there is no gap period between the non-full-duplex symbols and the full-duplex symbols. That is, a filter may not change or there may not be a radio frequency retuning at the network entity 105 and/or the UE 115. The UE 115 may receive an indication that an occasion of a set of one or more occasions for a message occurs over a set of symbols. The set of symbols may include a set of full-duplex symbols including the downlink symbol 305 and the uplink symbol 310 and a set of non-full-duplex symbols including the downlink subband 315 and the uplink subband 320. The UE 115 may communicate the message via the occasion in accordance with a set of rules and based on the occasion being across at least one full-duplex symbol of the set of full-duplex symbols and at least one non-full-duplex symbol of the set of non-full-duplex symbols. In one example, the UE 115 may determine that the multi-symbol resource corresponding to the physical downlink shared channel has a directional conflict with a subband on at least one of the two subband full-duplex symbols and non-subband full-duplex symbols.

As depicted in the example of FIG. 3, the UE 115 may determine that there is a conflict between the physical downlink shared channel 325-a and the uplink subband 320. In some cases, the set of rules may indicate that this case is not allowed (e.g., any message transmission is not allowed), and the UE 115 may thus not expect a conflict between the physical downlink shared channel 325-a and the uplink subband 320. The set of rules may be pre-configured or may be decided and/or indicated by the network entity 105. In some examples, the set of rules may apply and put restriction to only certain scenarios or channels or reference signals. For example, the set of rules may indicate that such an overlap is not allowed in case the occasion is a physical downlink control channel occasion or a physical uplink control channel occasion, but is allowed for other types of signaling (e.g., a physical downlink shared channel occasion, a physical uplink shared channel occasion, one or more occasions of reference signals, among other examples). For instance, the set of rules may indicate that communication of a message via the occasion is allowed based on the message being a first type of message and the occasion including a multi-symbol resource having a transmission direction that conflicts with at least one subband of the at least one full-duplex symbol of the set of full-duplex symbols. The first type of message may include a physical uplink shared channel, or a physical downlink shared channel, or one or more reference signals.

Additionally, or alternatively, the set of rules may indicate that the resource or occasion is dropped (e.g., if configured resource cannot avoid the boundary between a full-duplex symbol and a non-full-duplex symbol. For example, the UE 115 may drop the message corresponding to the physical downlink shared channel 325-a in accordance with the set of rules and based on the occasion including a multi-symbol resource having a transmission direction that conflicts with at least one subband of the at least one full-duplex symbol of the set of full-duplex symbols. In some examples, this option may apply to semi-persistently scheduled physical downlink shared channel, physical uplink shared channel configured grant, among others.

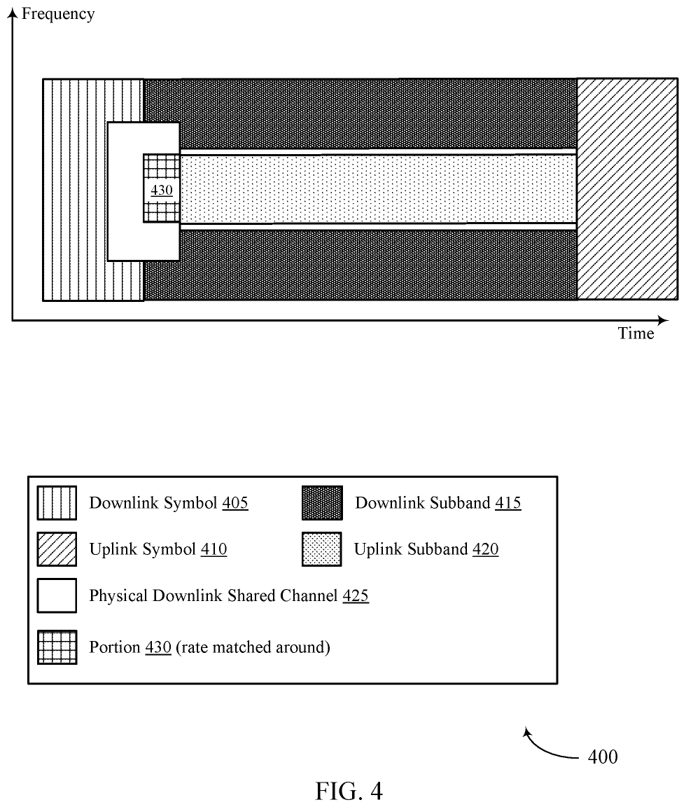

FIG. 4 illustrates an example of a slot structure 400 that supports techniques for single transmission occasions across different symbols in accordance with one or more aspects of the present disclosure. The slot structure 400 includes one or more full-duplex symbols and one or more non-full-duplex symbols. The full-duplex symbols may be referred to as subband full-duplex symbols and the non-full-duplex symbols may be referred to as non-subbband full-duplex symbols. The non-full-duplex symbols include downlink symbol 405 and uplink symbol 410. The full-duplex symbols include downlink subband 415, which may include or be examples of downlink frequency bands (e.g., downlink subbands), and uplink subband 420, which may include or be examples of uplink frequency bands (e.g., uplink subbands). The network entity 105 may transmit, and the UE 115 may receive, downlink communications, such as physical downlink shared channel 425.

In the example of FIG. 4, the network entity 105 may transmit a physical downlink shared channel 425. A single occasion of the physical downlink shared channel 425 may be scheduled across both types of symbols. Although depicted as a physical downlink shared channel, it is to be understood that the single occasion may be one occasion of one or more of a scheduled or configured physical downlink control channel without repetition, a scheduled or configured physical uplink control channel without repetition, a scheduled or configured physical uplink shared channel without repetition, a scheduled or configured physical downlink shared channel without repetition, a scheduled or configured physical downlink control channel with repetition, a scheduled or configured physical uplink control channel with repetition, a physical uplink shared channel with repetition, a scheduled or configured physical downlink shared channel with repetition, a scheduled or configured sounding reference signal, a scheduled or configured channel state information reference signal, a scheduled or configured transport block over multiple slots with repetition, a scheduled or configured transport block over multiple slots without repetition, multiple physical uplink shared channel scheduled by a single downlink control information, multiple physical downlink shared channel scheduled by a single downlink control information, or a combination thereof.

As depicted in FIG. 4, there is no gap period between the non-full-duplex symbols and the full-duplex symbols. That is, a filter may not change or there may not be a radio frequency retuning at the network entity 105 and/or the UE 115. The UE 115 may receive an indication that an occasion of a set of one or more occasions for a message occurs over a set of symbols. The set of symbols may include a set of full-duplex symbols including the downlink symbol 405 and the uplink symbol 410 and a set of non-full-duplex symbols including the downlink subband 415 and the uplink subband 420. The UE 115 may communicate the message via the occasion in accordance with a set of rules and based on the occasion being across at least one full-duplex symbol of the set of full-duplex symbols and at least one non-full-duplex symbol of the set of non-full-duplex symbols. In one example, the UE 115 may determine that the multi-symbol resource corresponding to the physical downlink shared channel has a directional conflict with a subband on at least one of the two subband full-duplex symbols and non-subband full-duplex symbols. For example, at least some resource blocks of the physical downlink shared channel 425 in a previous symbol may have a directional conflict in a later symbol.

In some examples, the set of rules may indicate that the UE 115 is to rate match around the conflicting resource blocks on reverse direction subbands. As depicted in the example of FIG. 4, the UE 115 may rate match around portion 430 that overlaps with the uplink subband 420 in the subband full-duplex symbol. The UE 115 may perform rate matching around one or more resource blocks of the message in accordance with the set of rules. The rate matching may be performed based on the occasion including the one or more resource blocks having a transmission direction that conflicts with at least one subband, or at least one guard band, or both, of the at least one full-duplex symbol of the set of full-duplex symbols, or at least one resource block of the set of non-full-duplex symbols. For example, for physical downlink shared channel 425 or physical downlink control channel, the UE 115 may rate match around in the subband full-duplex symbols, similar to downlink rate match pattern. In some examples, the UE 115 may cancel physical uplink control channel or physical uplink shared channel resource blocks in the downlink subband 415. In some examples, the UE 115 may rate match around physical uplink control channel or physical uplink shared channel resource blocks in the subband full-duplex symbols, similar to uplink cancellation for partial physical uplink shared channel cancellation in frequency. In some examples, the uplink cancellation may indicate the UE 115 to cancel one or more frequency resources, one or more time resources, or both.

In some examples, the UE 115 may support an implicit downlink rate matching around the conflicting resource block (using an implicit rule). Additionally, or alternatively, the UE 115 may support an implicit uplink cancellation rule around the conflicting resource block (using an implicit rule). In some examples, the UE 115 may receive, from the network entity 105, an indication to perform uplink cancellation for one or more resource blocks, or one or more symbols, or both, of the message in accordance with the set of rules. In some cases, the uplink cancellation may be performed based on the occasion including the one or more resource blocks having a transmission direction that conflicts with at least one subband, or at least one guard band, or both, of the at least one full-duplex symbol of the set of full-duplex symbols or at least one resource block of the set of non-full-duplex symbols.

Additionally, or alternatively, two explicit frequency domain resource allocations or time domain resource allocations for the same resource on different types of symbols may be indicated to the UE 115 or may be identified by the UE 115. For instance, the UE 115 may identify one or more occasions of the message associated with a set of frequency domain resource allocations, or a set of time domain resource allocations, or both, based on the set of rules. The set of frequency domain resource allocations, or a set of time domain resource allocations may be associated with the set of non-subband full-duplex symbols or slots or the set of full-duplex symbols or slots. As an example, a first frequency domain resource allocation, or a first time domain resource allocation, or both, may be associated with the full-duplex symbols (e.g., SBFD symbols). Additionally, a second frequency domain resource allocation, or a second time domain resource allocation, or both, may be associated with the non-full-duplex symbols (e.g., uplink symbols, downlink symbols, flexible symbols). The UE 115 may receive a control message indicating the set of frequency domain resource allocations, or the set of time domain resource allocations, or both, for one or more resource blocks of the one or more occasions. In some cases, the UE 115 may (e.g., implicitly) apply or determine which occasion(s), on which symbols, use the first frequency domain resource allocation and/or the first time domain resource allocation, as well as which occasion(s), on which symbols, use the second frequency domain resource allocation and/or the second time domain resource allocation, for example, based on a full-duplex time and frequency location indication. In some examples, communicating the message may be based on the set of frequency domain resource allocations, or the set of time domain resource allocations, or both.

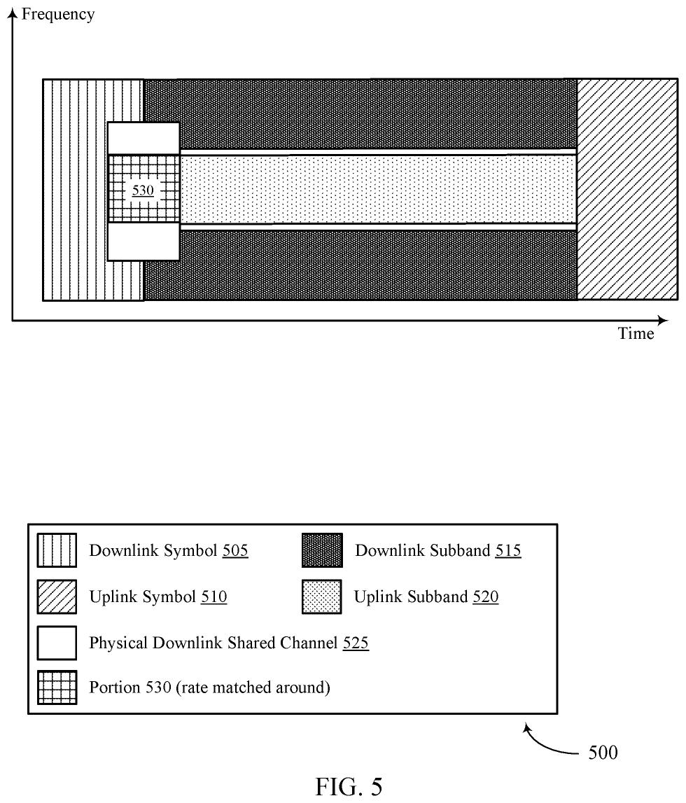

FIG. 5 illustrates an example of a slot structure 500 that supports techniques for single transmission occasions across different symbols in accordance with one or more aspects of the present disclosure. The slot structure 500 includes one or more full-duplex symbols and one or more non-full-duplex symbols. The full-duplex symbols may be referred to as subband full-duplex symbols and the non-full-duplex symbols may be referred to as non-subbband full-duplex symbols. The non-full-duplex symbols include downlink symbol 505 and uplink symbol 510. The full-duplex symbols include downlink subband 515, which may include or be examples of downlink frequency bands (e.g., downlink subbands), and uplink subband 520, which may include or be examples of uplink frequency bands (e.g., uplink subbands). The network entity 105 may transmit, and the UE 115 may receive, downlink communications, such as physical downlink shared channel 525.

In the example of FIG. 5, the network entity 105 may transmit a physical downlink shared channel 525. A single occasion of the physical downlink shared channel 525 may be scheduled across both types of symbols. Although depicted as a physical downlink shared channel, it is to be understood that the single occasion may be one occasion of one or more of a scheduled or configured physical downlink control channel without repetition, a scheduled or configured physical uplink control channel without repetition, a scheduled or configured physical uplink shared channel without repetition, a scheduled or configured physical downlink shared channel without repetition, a scheduled or configured physical downlink control channel with repetition, a scheduled or configured physical uplink control channel with repetition, a physical uplink shared channel with repetition, a scheduled or configured physical downlink shared channel with repetition, a scheduled or configured sounding reference signal, a scheduled or configured channel state information reference signal, a scheduled or configured transport block over multiple slots with repetition, a scheduled or configured transport block over multiple slots without repetition, multiple physical uplink shared channel scheduled by a single downlink control information, multiple physical downlink shared channel scheduled by a single downlink control information, or a combination thereof.

As depicted in FIG. 5, there is no gap period between the non-full-duplex symbols and the full-duplex symbols. That is, a filter may not change or there may not be a radio frequency retuning at the network entity 105 and/or the UE 115. The UE 115 may receive an indication that an occasion of a set of one or more occasions for a message occurs over a set of symbols. The set of symbols may include a set of full-duplex symbols including the downlink symbol 505 and the uplink symbol 510 and a set of non-full-duplex symbols including the downlink subband 515 and the uplink subband 520. The UE 115 may communicate the message via the occasion in accordance with a set of rules and based on the occasion being across at least one full-duplex symbol of the set of full-duplex symbols and at least one non-full-duplex symbol of the set of non-full-duplex symbols. In one example, the UE 115 may determine that the multi-symbol resource corresponding to the physical downlink shared channel has a directional conflict with a subband on at least one of the two subband full-duplex symbols and non-subband full-duplex symbols.

In some examples, the set of rules may indicate that the UE 115 is to rate match around the conflicting resource blocks (portion 530) on reverse direction subbands across both subband full-duplex symbols and non-subband full-duplex symbols. That is, the UE 115 may perform rate matching around one or more resource blocks of the message in accordance with the set of rules. In some cases, the rate matching is performed based on the occasion including the one or more resource blocks having a transmission direction that conflicts with at least one subband of the at least one full-duplex symbol of the set of full-duplex symbols. In some examples, the one or more resource blocks may correspond to the at least one subband or at least one guard band of the at least one full-duplex symbol and at least one subband of the at least one non-full-duplex symbol of the set of non-full-duplex symbols. For instance, the UE 115 may rate match around physical downlink control channel or physical downlink shared channel 525 resource blocks in uplink subband 520 in both subband full-duplex symbols and non-subband full-duplex symbols. Additionally, or alternatively, the UE 115 may rate match around physical uplink control channel or physical uplink shared channel resource blocks in downlink subband 515 in both subband full-duplex symbols and non-subband full-duplex symbols. As depicted in the example of FIG. 5, the UE 115 may rate match around resource blocks for the physical downlink shared channel 525 that overlap with the uplink subband 520 as well as downlink symbol 505.

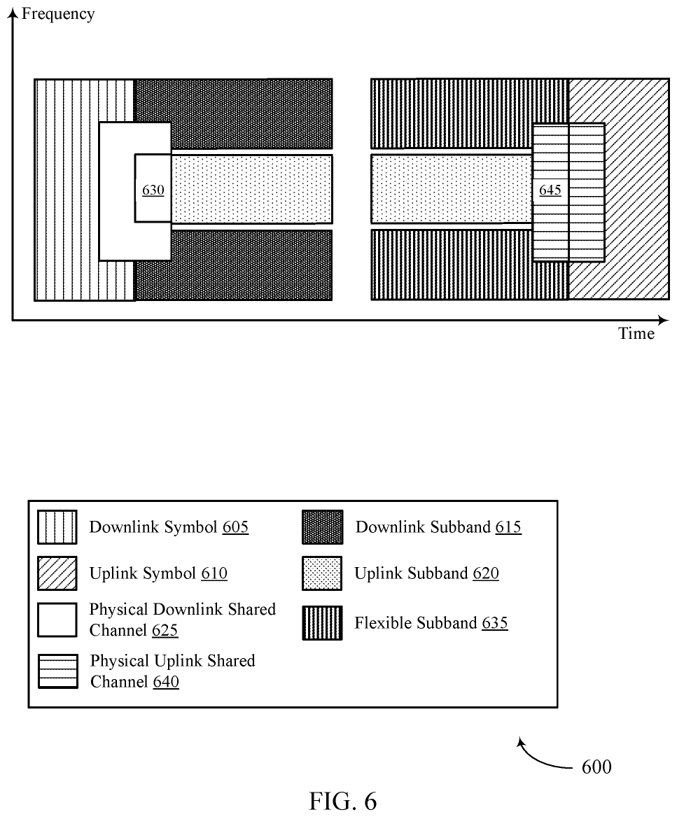

FIG. 6 illustrates an example of a slot structure 600 that supports techniques for single transmission occasions across different symbols in accordance with one or more aspects of the present disclosure. The slot structure 600 includes one or more full-duplex symbols and one or more non-full-duplex symbols. The full-duplex symbols may be referred to as subband full-duplex symbols and the non-full-duplex symbols may be referred to as non-subbband full-duplex symbols. The non-full-duplex symbols include downlink symbol 605 and uplink symbol 610. The full-duplex symbols include downlink subband 615, which may include or be examples of downlink frequency bands (e.g., downlink subbands), uplink subband 620, which may include or be examples of uplink frequency bands (e.g., uplink subbands), and flexible subband 635, which may include or be examples of flexible frequency bands (e.g., uplink or downlink subbands). The network entity 105 may transmit, and the UE 115 may receive, downlink communications, such as physical downlink shared channel 625. The UE 115 may transmit, and the network entity 105 may receive, uplink communications, such as physical uplink shared channel 640.

In the example of FIG. 6, the network entity 105 transmit a physical downlink shared channel 625. Additionally, or alternatively, the UE 115 transmit a physical uplink shared channel 640. A single occasion of the physical downlink shared channel 625 may be scheduled across both types of symbols. Additionally, or alternatively, the physical uplink shared channel 640 may be scheduled across both types of symbols. Although depicted as a physical downlink shared channel, it is to be understood that the single occasion may be one occasion of one or more of a scheduled or configured physical downlink control channel without repetition, a scheduled or configured physical uplink control channel without repetition, a scheduled or configured physical uplink shared channel without repetition, a scheduled or configured physical downlink shared channel without repetition, a scheduled or configured physical downlink control channel with repetition, a scheduled or configured physical uplink control channel with repetition, a physical uplink shared channel with repetition, a scheduled or configured physical downlink shared channel with repetition, a scheduled or configured sounding reference signal, a scheduled or configured channel state information reference signal, a scheduled or configured transport block over multiple slots with repetition, a scheduled or configured transport block over multiple slots without repetition, multiple physical uplink shared channel scheduled by a single downlink control information, multiple physical downlink shared channel scheduled by a single downlink control information, or a combination thereof.

As depicted in FIG. 6, there is no gap period between the non-full-duplex symbols and the full-duplex symbols. That is, a filter may not change or there may not be a radio frequency retuning at the network entity 105 and/or the UE 115. The UE 115 may receive an indication that an occasion of a set of one or more occasions for a message occurs over a set of symbols. The set of symbols may include a set of full-duplex symbols including the downlink symbol 605 and the uplink symbol 610 and a set of non-full-duplex symbols including the downlink subband 615, the uplink subband 620, and the flexible subband 635. The UE 115 may communicate the message via the occasion in accordance with a set of rules and based on the occasion being across at least one full-duplex symbol of the set of full-duplex symbols and at least one non-full-duplex symbol of the set of non-full-duplex symbols. In one example, the UE 115 may determine that the multi-symbol resource corresponding to the physical downlink shared channel has a directional conflict with a subband on at least one of the two subband full-duplex symbols and non-subband full-duplex symbols. For example, the UE 115 may determine that at least some resource blocks of the physical downlink shared channel 625 in a previous symbol have a directional conflict in a later symbol.

In some examples, the set of rules may indicate that the UE 115 may use the conflicting resource blocks over the portion 630 on reverse direction subbands, even with confliction. For example, the UE 115 may receive an indication or may implicitly update uplink resource blocks (conflicting with the physical downlink shared channel 625) to “downlink-only” if subband full-duplex is configured on a downlink symbol or on a flexible symbol. In some examples, the UE 115 may receive a control message indicating that the UE 115 update at least one subband of the at least one full-duplex symbol in accordance with the set of rules. In some cases, the at least one full-duplex symbol of the set of full-duplex symbols may correspond to a downlink symbol or a flexible symbol. The UE 115 may determine that the message to be communicated corresponds to a downlink transmission and the occasion includes a multi-symbol resource having a transmission direction that conflicts with at least one subband of the at least one full-duplex symbol of the set of full-duplex symbols. In such cases, the UE 115 communicating the message may include the UE 115 receiving the downlink transmission via the occasion based on the control message.

Additionally, or alternatively, if the subband full-duplex is configured on a flexible symbol, then the resource blocks outside uplink subband may become flexible subband. For instance, the UE 115 may transmit uplink using portion 645 in flexible subband 635 and uplink subband 620. The UE 115 may transmit such an uplink message based on receiving an indication. In some examples, the UE 115 may receive a control message indicating that the UE 115 update at least one subband of the at least one full-duplex symbol in accordance with the set of rules. In some cases, the at least one full-duplex symbol of the set of full-duplex symbols may correspond to a flexible symbol. The UE 115 may then determine that the message corresponds to an uplink transmission and the occasion includes a multi-symbol resource having a transmission direction that conflicts with at least one subband of the at least one full-duplex symbol of the set of full-duplex symbols. In such cases, the UE 115 communicating the message may include the UE 115 transmitting the uplink transmission via the occasion based on the control message.

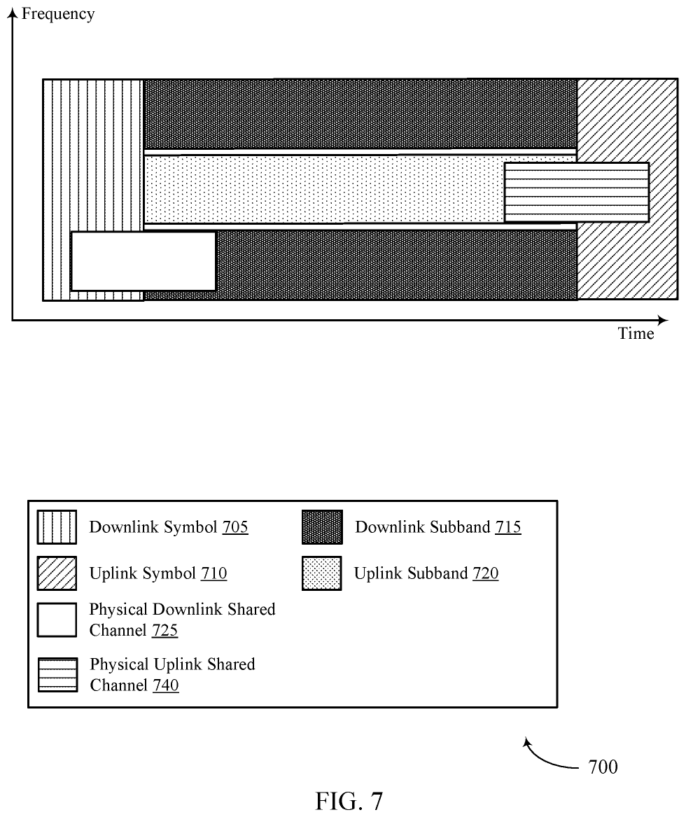

FIG. 7 illustrates an example of a slot structure 700 that supports techniques for single transmission occasions across different symbols in accordance with one or more aspects of the present disclosure. The slot structure 700 includes one or more full-duplex symbols and one or more non-full-duplex symbols. The full-duplex symbols may be referred to as subband full-duplex symbols and the non-full-duplex symbols may be referred to as non-subbband full-duplex symbols. The non-full-duplex symbols include downlink symbol 705 and uplink symbol 710. The full-duplex symbols include downlink subband 715, which may include or be examples of downlink frequency bands (e.g., downlink subbands), and uplink subband 720, which may include or be examples of uplink frequency bands (e.g., uplink subbands). The network entity 105 may transmit, and the UE 115 may receive, downlink communications, such as physical downlink shared channel 725. The UE 115 may transmit, and the network entity 105 may receive, uplink communications, such as physical uplink shared channel 740.

In the example of FIG. 7, the network entity 105 may transmit a physical downlink shared channel 725. Additionally, or alternatively, the UE 115 transmit a physical uplink shared channel 740. A single occasion of the physical downlink shared channel 525 may be scheduled across both types of symbols. Although depicted as a physical downlink shared channel, it is to be understood that the single occasion may be one occasion of one or more of a scheduled or configured physical downlink control channel without repetition, a scheduled or configured physical uplink control channel without repetition, a scheduled or configured physical uplink shared channel without repetition, a scheduled or configured physical downlink shared channel without repetition, a scheduled or configured physical downlink control channel with repetition, a scheduled or configured physical uplink control channel with repetition, a physical uplink shared channel with repetition, a scheduled or configured physical downlink shared channel with repetition, a scheduled or configured sounding reference signal, a scheduled or configured channel state information reference signal, a scheduled or configured transport block over multiple slots with repetition, a scheduled or configured transport block over multiple slots without repetition, multiple physical uplink shared channel scheduled by a single downlink control information, multiple physical downlink shared channel scheduled by a single downlink control information, or a combination thereof.

As depicted in FIG. 7, there is no gap period between the non-full-duplex symbols and the full-duplex symbols. That is, a filter may not change or there may not be a radio frequency retuning at the network entity 105 and/or the UE 115. The UE 115 may receive an indication that an occasion of a set of one or more occasions for a message occurs over a set of symbols. The set of symbols may include a set of full-duplex symbols including the downlink symbol 705 and the uplink symbol 710 and a set of non-full-duplex symbols including the downlink subband 715 and the uplink subband 720. The UE 115 may communicate the message via the occasion in accordance with a set of rules and based on the occasion being across at least one full-duplex symbol of the set of full-duplex symbols and at least one non-full-duplex symbol of the set of non-full-duplex symbols. In one example, the UE 115 may determine that the multi-symbol resource corresponding to the physical downlink shared channel 725 does not have a directional conflict with a subband on at least one of the two subband full-duplex symbols and non-subband full-duplex symbols. That is, the UE 115 may determine that no resource block of the physical downlink shared channel 725 in a previous symbol has conflict direction in a later symbol.

In some examples, the set of rules may indicate that the UE 115 may be able to communicate the physical downlink shared channel 725 message or the physical uplink shared channel 740 using their corresponding occasions that do not overlap with a subband that has a different transmission direction. For example, the UE 115 may determine that the message corresponds to a downlink transmission (associated with physical downlink shared channel 725) and the occasion includes a multi-symbol resource having a transmission direction that corresponds to a transmission direction of a first subband (downlink subband 715) of the at least one full-duplex symbol. In such cases, the message may be non-overlapping with one or more other subbands of the at least one full-duplex symbol. The UE 115 communicating the message may include the UE 115 receiving the downlink transmission via the first subband. Additionally, or alternatively, the UE 115 may determine that the message corresponds to an uplink transmission (associated with physical uplink shared channel 740) and the occasion includes a multi-symbol resource having a transmission direction that corresponds to a transmission direction of a first subband (uplink subband 720) of the at least one full-duplex symbol. In some cases, the message may be non-overlapping with one or more other subbands of the at least one full-duplex symbol. The UE 115 communicating the message may include the UE 115 transmitting the uplink transmission via the first subband.

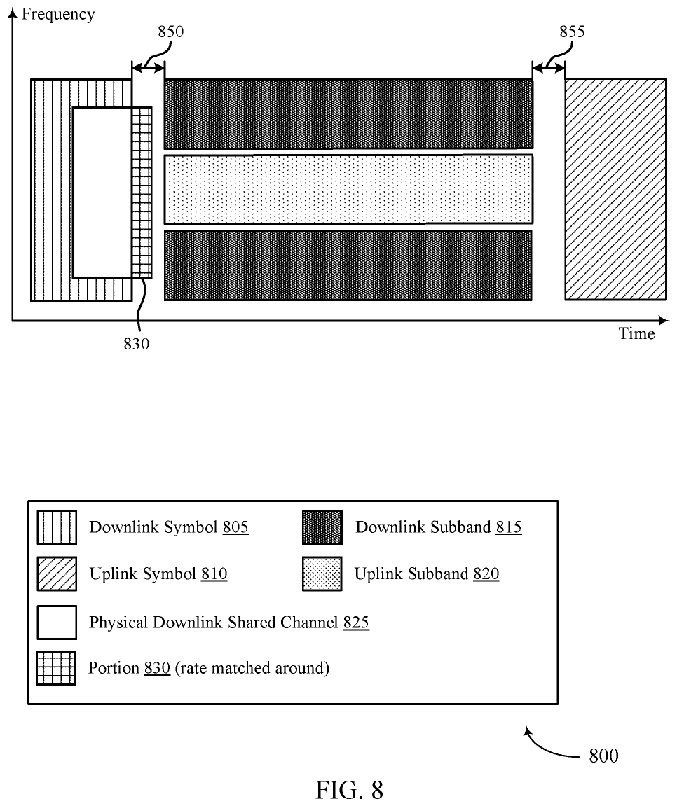

FIG. 8 illustrates an example of a slot structure 800 that supports techniques for single transmission occasions across different symbols in accordance with one or more aspects of the present disclosure. The slot structure 800 includes one or more full-duplex symbols and one or more non-full-duplex symbols. The full-duplex symbols may be referred to as subband full-duplex symbols and the non-full-duplex symbols may be referred to as non-subbband full-duplex symbols. The non-full-duplex symbols include downlink symbol 805 and uplink symbol 810. The full-duplex symbols include downlink subband 815, which may include or be examples of downlink frequency bands (e.g., downlink subbands), and uplink subband 820, which may include or be examples of uplink frequency bands (e.g., uplink subbands). The network entity 105 may transmit, and the UE 115 may receive, downlink communications, such as physical downlink shared channel 825.

In the example of FIG. 8, the network entity 105 may transmit a physical downlink shared channel 825. A single occasion of the physical downlink shared channel 825 may be scheduled across at least one type of symbol. Although depicted as a physical downlink shared channel, it is to be understood that the single occasion may be one occasion of one or more of a scheduled or configured physical downlink control channel without repetition, a scheduled or configured physical uplink control channel without repetition, a scheduled or configured physical uplink shared channel without repetition, a scheduled or configured physical downlink shared channel without repetition, a scheduled or configured physical downlink control channel with repetition, a scheduled or configured physical uplink control channel with repetition, a physical uplink shared channel with repetition, a scheduled or configured physical downlink shared channel with repetition, a scheduled or configured sounding reference signal, a scheduled or configured channel state information reference signal, a scheduled or configured transport block over multiple slots with repetition, a scheduled or configured transport block over multiple slots without repetition, multiple physical uplink shared channel scheduled by a single downlink control information, multiple physical downlink shared channel scheduled by a single downlink control information, or a combination thereof.

As depicted in FIG. 8, there is a gap period between the non-full-duplex symbols and the full-duplex symbols. For instance, there is a gap period 850 between the downlink symbol 805 and the full-duplex symbols. Additionally, there is a gap period 855 between the uplink symbol 810 and the full-duplex symbols. That is, a filter may change or there may be a radio frequency retuning at the network entity 105 and/or the UE 115. The UE 115 may receive an indication that an occasion of a set of one or more occasions for a message occurs over a set of symbols. The set of symbols may include a set of full-duplex symbols including the downlink symbol 805 and the uplink symbol 810 and a set of non-full-duplex symbols including the downlink subband 815 and the uplink subband 820. The UE 115 may communicate the message via the occasion in accordance with a set of rules and based on the occasion being across at least one full-duplex symbol of the set of full-duplex symbols and the gap period. In one example, the UE 115 may determine that the channel or reference signal from previous symbol type ends in the middle of filter tuning gap (or gap period 850). As depicted in the example of FIG. 8, the UE 115 may determine that the physical downlink shared channel 825 in the downlink symbol 805 ends in gap period 850 before the first subband full-duplex symbol (e.g., downlink-uplink-downlink symbol).

In some examples, the set of rules may indicate that such a case is not allowed (e.g., error case), and the UE 115 may not expect the physical downlink shared channel 825 in the downlink symbol 805 to end in gap period 850 before the first subband full-duplex symbol. Additionally, or alternatively, the set of rules may indicate that the resource or occasion is to be dropped by the UE 115 (if such a case cannot be avoided by the UE 115). In some examples, the UE 115 may drop a message of an occasion in accordance with the set of rules, where the occasion of the set of one or more occasions is across the at least one non-full-duplex symbol of the set of non-full-duplex symbols and a gap period 850 that is between the set of non-full-duplex symbols and the set of full-duplex symbols. In some cases, the UE 115 may determine that the message ends within the gap period 850.

In some examples, the set of rules may indicate that the UE 115 is to rate match around the portion 830 included in the gap period 850. The UE 115 may rate match around portion 830 to exclude the part overlapped with the gap period 850. For example, the UE 115 may perform rate matching around one or more resource blocks of a second message included in the occasion in accordance with the set of rules, where the one or more resource blocks overlap with the gap period 850. In some examples, the UE 115 may receive the message (corresponding to the physical downlink shared channel 825) via the occasion based on performing the rate matching around the one or more resource blocks (corresponding to the portion 830).

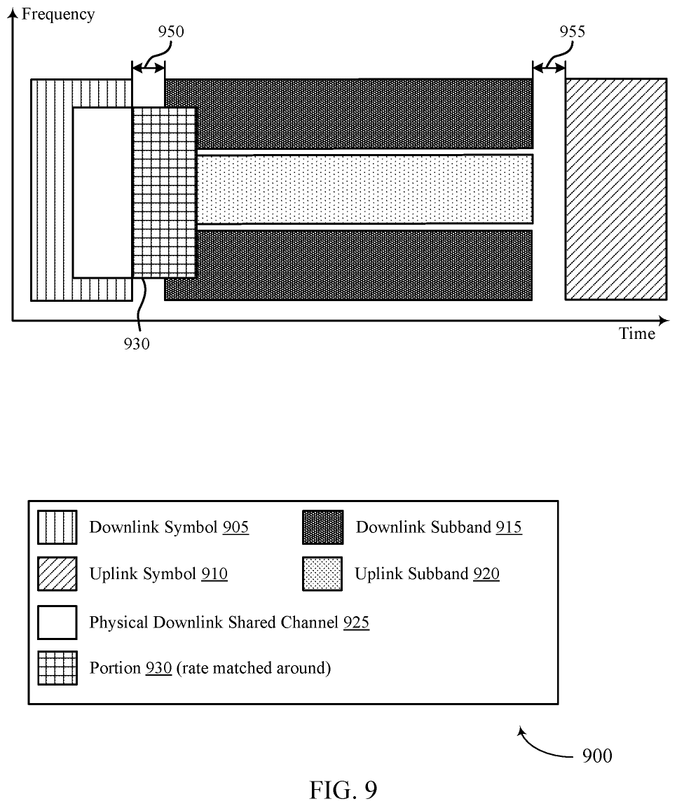

FIG. 9 illustrates an example of a slot structure 900 that supports techniques for single transmission occasions across different symbols in accordance with one or more aspects of the present disclosure. The slot structure 900 includes one or more full-duplex symbols and one or more non-full-duplex symbols. The full-duplex symbols may be referred to as subband full-duplex symbols and the non-full-duplex symbols may be referred to as non-subbband full-duplex symbols. The non-full-duplex symbols include downlink symbol 905 and uplink symbol 910. The full-duplex symbols include downlink subband 915, which may include or be examples of downlink frequency bands (e.g., downlink subbands), and uplink subband 920, which may include or be examples of uplink frequency bands (e.g., uplink subbands). The network entity 105 may transmit, and the UE 115 may receive, downlink communications, such as physical downlink shared channel 925.

In the example of FIG. 9, the network entity 105 may transmit a physical downlink shared channel 925. A single occasion of the physical downlink shared channel 925 may be scheduled across both types of symbols. Although depicted as a physical downlink shared channel, it is to be understood that the single occasion may be one occasion of one or more of a scheduled or configured physical downlink control channel without repetition, a scheduled or configured physical uplink control channel without repetition, a scheduled or configured physical uplink shared channel without repetition, a scheduled or configured physical downlink shared channel without repetition, a scheduled or configured physical downlink control channel with repetition, a scheduled or configured physical uplink control channel with repetition, a physical uplink shared channel with repetition, a scheduled or configured physical downlink shared channel with repetition, a scheduled or configured sounding reference signal, a scheduled or configured channel state information reference signal, a scheduled or configured transport block over multiple slots with repetition, a scheduled or configured transport block over multiple slots without repetition, multiple physical uplink shared channel scheduled by a single downlink control information, multiple physical downlink shared channel scheduled by a single downlink control information, or a combination thereof.

As depicted in FIG. 9, there is a gap period between the non-full-duplex symbols and the full-duplex symbols. For instance, there is a gap period 950 between the downlink symbol 905 and the full-duplex symbols. Additionally, there is a gap period 955 between the uplink symbol 910 and the full-duplex symbols. That is, a filter may change or there may be a radio frequency retuning at the network entity 105 and/or the UE 115. The UE 115 may receive an indication that an occasion of a set of one or more occasions for a message occurs over a set of symbols. The set of symbols may include a set of full-duplex symbols including the downlink symbol 905 and the uplink symbol 910 and a set of non-full-duplex symbols including the downlink subband 915 and the uplink subband 920. The UE 115 may communicate the message via the occasion in accordance with a set of rules and based on the occasion being across at least one full-duplex symbol of the set of full-duplex symbol, the gap period 950, and at least one non-full-duplex symbol of the set of non-full-duplex symbols. As depicted in the example of FIG. 9, the UE 115 may determine that the multi-symbol resource has directional conflict with a subband on at least one of the subband full-duplex symbols and non-subband full-duplex symbols. Additionally, the UE 115 may determine that the channel reference signal from a previous symbol type extends to the other symbol type after the gap period 950. For example, a physical uplink shared channel in the uplink symbol 910 may end in the second non-subband full-duplex symbol (e.g., downlink-uplink-downlink symbol) after the gap period 950. In some examples, a physical uplink shared channel in a non-subband full-duplex symbol (e.g., uplink-downlink-uplink symbol) may end in the second uplink symbol 910 after the gap period 955.

Additionally, physical downlink shared channel 925 in a non-subband full-duplex symbol (e.g., downlink-uplink symbol) may end in the second downlink symbol after the gap. In some examples, physical downlink shared channel 925 in a non-subband full-duplex symbol (e.g., uplink-downlink-uplink symbol) may end in the second downlink symbol after the gap period. In some cases, the physical downlink shared channel 925 in a downlink symbol 905 may end in the second non-subband full-duplex symbol (e.g., uplink-downlink-uplink symbol) after the gap.

As depicted in the example of FIG. 9, the UE 115 may determine that the occasion (corresponding to the physical downlink shared channel 925) is across the set of non-full-duplex symbols (corresponding to the downlink symbol 905), the set of full-duplex symbols, and a gap period 950 that is between the set of non-full-duplex symbols and the set of full-duplex symbols. In some examples, the set of rules may indicate that such a case is not allowed, and the UE 115 may not expect such a case to occur. In some examples, the set of rules may indicate that the UE 115 is to drop the resource or occasion. The UE 115 may drop the message in accordance with the set of rules and based on the occasion including a multi-symbol resource having a transmission direction that conflicts with at least one subband, or at least one guard band, or both, of the at least one full-duplex symbol of the set of full-duplex symbols or at least one or more resource blocks of the set of non-full-duplex symbols.

In some examples, the set of rules may indicate that the UE 115 is to rate match around the resource or occasion. The UE 115 may rate match around the portion 930 overlapping with the gap period 950 and after the gap period 950 if the portion 930 does not include a demodulation reference signal. In some cases, the rate matching may apply to certain channels or reference signals (e.g., semi-persistently scheduled signal or a configured grant). For instance, the UE 115 may perform rate matching around one or more resource blocks (corresponding to the portion 930) of the message (corresponding to the physical downlink shared channel 925) in accordance with the set of rules. The rate matching may be performed based on the occasion including the one or more resource blocks having a transmission direction that conflicts with at least one subband, or at least one guard band, or both, of the at least one full-duplex symbol of the set of full-duplex symbols or at least one or more resource blocks of the set of non-full-duplex symbols. Additionally, the one or more resource blocks may overlap with the gap period 950 and the at least one full-duplex symbol (e.g., downlink symbol 905) or the at least one or more resource blocks of the set of non-full-duplex symbols (e.g., corresponding to downlink subband 915 and uplink subband 920).

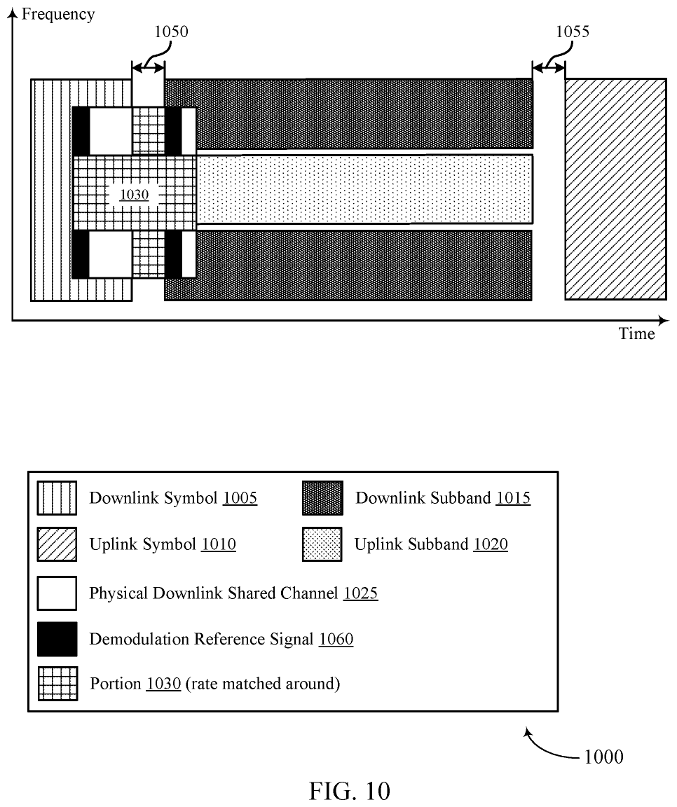

FIG. 10 illustrates an example of a slot structure 1000 that supports techniques for single transmission occasions across different symbols in accordance with one or more aspects of the present disclosure. The slot structure 1000 includes one or more full-duplex symbols and one or more non-full-duplex symbols. The full-duplex symbols may be referred to as subband full-duplex symbols and the non-full-duplex symbols may be referred to as non-subbband full-duplex symbols. The non-full-duplex symbols include downlink symbol 1005 and uplink symbol 1010. The full-duplex symbols include downlink subband 1015, which may include or be examples of downlink frequency bands (e.g., downlink subbands), and uplink subband 1020, which may include or be examples of uplink frequency bands (e.g., uplink subbands). The network entity 105 may transmit, and the UE 115 may receive, downlink communications, such as physical downlink shared channel 1025.

In the example of FIG. 10, the network entity 105 may transmit a physical downlink shared channel 1025. A single occasion of the physical downlink shared channel 1025 may be scheduled across both types of symbols. Although depicted as a physical downlink shared channel, it is to be understood that the single occasion may be one occasion of one or more of a scheduled or configured physical downlink control channel without repetition, a scheduled or configured physical uplink control channel without repetition, a scheduled or configured physical uplink shared channel without repetition, a scheduled or configured physical downlink shared channel without repetition, a scheduled or configured physical downlink control channel with repetition, a scheduled or configured physical uplink control channel with repetition, a physical uplink shared channel with repetition, a scheduled or configured physical downlink shared channel with repetition, a scheduled or configured sounding reference signal, a scheduled or configured channel state information reference signal, a scheduled or configured transport block over multiple slots with repetition, a scheduled or configured transport block over multiple slots without repetition, multiple physical uplink shared channel scheduled by a single downlink control information, multiple physical downlink shared channel scheduled by a single downlink control information, or a combination thereof.

As depicted in FIG. 10, there is a gap period between the non-full-duplex symbols and the full-duplex symbols. For instance, there is a gap period 1050 between the downlink symbol 1005 and the full-duplex symbols. Additionally, there is a gap period 1055 between the uplink symbol 1010 and the full-duplex symbols. That is, a filter may change or there may be a radio frequency retuning at the network entity 105 and/or the UE 115. The UE 115 may receive an indication that an occasion of a set of one or more occasions for a message occurs over a set of symbols. The set of symbols may include a set of full-duplex symbols including the downlink symbol 1005 and the uplink symbol 1010 and a set of non-full-duplex symbols including the downlink subband 1015 and the uplink subband 1020. The UE 115 may communicate the message via the occasion in accordance with a set of rules and based on the occasion being across at least one full-duplex symbol of the set of full-duplex symbol, the gap period 1050, and at least one non-full-duplex symbol of the set of non-full-duplex symbols.

As depicted in the example of FIG. 10, the UE 115 may determine that the multi-symbol resource has directional conflict with a subband on at least one of the subband full-duplex symbols and non-subband full-duplex symbols. In some examples, the set of rules may indicate that the UE 115 is to rate match around the resource blocks having a directional conflict with a subband. The set of rules may further indicate that the UE 115 is to rate match of both subband full-duplex symbols and non-subband full-duplex symbols. In some examples, the UE 115 may rate match around the subband full-duplex symbols (corresponding to the downlink symbol 1005), the gap period 1050, and non-subband full-duplex symbols (corresponding to downlink subband 1015 and uplink subband 1020).

In some examples, the occasion may be across the set of non-full-duplex symbols, the set of full-duplex symbols, and a gap period 1050 that is between the set of non-full-duplex symbols and the set of full-duplex symbols. The UE 115 may perform rate matching around one or more resource blocks 1030 of the message in accordance with the set of rules. The rate matching may be performed based on the occasion includes the one or more resource blocks having a transmission direction that conflicts with at least one subband, or at least one guard band, or both, of the at least one full-duplex symbol of the set of full-duplex symbols or at least one or more resource blocks of the set of non-full-duplex symbols. The one or more resource blocks may overlap with the gap period 1050, each subband (downlink subband 1015 and uplink subband 1020) of the at least one subband, and at least one subband of the at least one non-full-duplex symbol (downlink symbol 1005) of the set of non-full-duplex symbols corresponding to the at least one subband of the at least one full-duplex symbol.

The UE 115 may receive, either by RRC or by a downlink control information signal, the set of rules indicating that the UE 115 is to rate match around resource blocks 1030 for physical downlink shared channel 1025 (including demodulation reference signal 1060) in subband full-duplex symbols. In some examples, a first portion of the physical downlink shared channel 1025 overlapping with the downlink symbol 1005 and a second portion of the physical downlink shared channel 1025 overlapping with the downlink subband 1015 and the uplink subband 1020 of subband full-duplex symbols may include demodulation reference signal 1060. In such cases, if the UE 115 or the network entity 105 cannot maintain phase continuity with the gap period 1050, in case of a downlink channel, the set of rules may indicate that the UE 115 is to bundle demodulation reference signal 1060 symbols within the part before the gap period 1050, and to also bundle demodulation reference signal 1060 symbols within the part after the gap period 1050.

In some examples, the UE 115 may bundle, in accordance with the set of rules, one or more demodulation reference signal 1060 symbols included in the occasion prior to the gap period 1050 that is between the set of non-full-duplex symbols and the set of full-duplex symbols. The UE 115 may also bundle, in accordance with the set of rules, one or more demodulation reference signal 1060 symbols included in the occasion after the gap period 1050 that is between the set of non-full-duplex symbols and the set of full-duplex symbols.

In case of uplink channel, the set of rules may indicate that the network entity 105 is to bundle demodulation reference signal 1060 symbols within the part before the gap period 1050, and is to bundle demodulation reference signal 1060 symbols within the part after the gap period 1050. In some examples, the nominal time (for uplink demodulation reference signal bundling) restarts at the symbol boundary. The set of rules may include a condition of the gap period 1050 causing phase continuity not to be maintained across transmissions of physical uplink control channel repetition within the nominal time. In some cases, the UE 115 may not keep phase coherency across the slot types.

In some examples, the UE 115 may inform the network entity 105 that the filter change may cause phase discontinuity. In response, the network entity 105 may bundle the two parts separately. Alternatively, both the UE 115 and the network entity 105 may bundle both parts. The nominal time may not break or restart. In some cases, the UE may inform to the network entity 105, that filter change may not cause phase discontinuity. In some examples, the network entity 105 may perform uplink cancellation for one or more resource blocks of the message in accordance with the set of rules. In some examples, the uplink cancellation may be performed based on the occasion including the one or more resource blocks having a transmission direction that conflicts with at least one subband, or at least one guard band, or both, of the at least one full-duplex symbol of the set of full-duplex symbols or at least one or more resource blocks of the set of non-full-duplex symbols. The one or more resource blocks may overlap with the gap period and the at least one full-duplex symbol or at least one or more resource blocks of the set of non-full-duplex symbols.

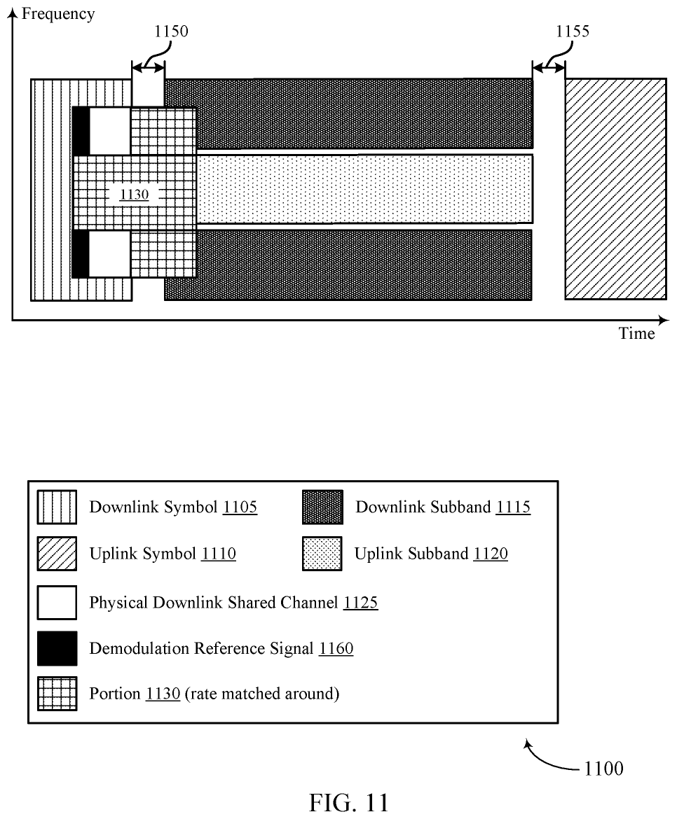

FIG. 11 illustrates an example of a slot structure 1100 that supports techniques for single transmission occasions across different symbols in accordance with one or more aspects of the present disclosure. The slot structure 1100 includes one or more full-duplex symbols and one or more non-full-duplex symbols. The full-duplex symbols may be referred to as subband full-duplex symbols and the non-full-duplex symbols may be referred to as non-subbband full-duplex symbols. The non-full-duplex symbols include downlink symbol 1105 and uplink symbol 1110. The full-duplex symbols include downlink subband 1115, which may include or be examples of downlink frequency bands (e.g., downlink subbands), and uplink subband 1120, which may include or be examples of uplink frequency bands (e.g., uplink subbands). The network entity 105 may transmit, and the UE 115 may receive, downlink communications, such as physical downlink shared channel 1125.

In the example of FIG. 11, the network entity 105 may transmit a physical downlink shared channel 1125. A single occasion of the physical downlink shared channel 1125 may be scheduled across both types of symbols. Although depicted as a physical downlink shared channel, it is to be understood that the single occasion may be one occasion of one or more of a scheduled or configured physical downlink control channel without repetition, a scheduled or configured physical uplink control channel without repetition, a scheduled or configured physical uplink shared channel without repetition, a scheduled or configured physical downlink shared channel without repetition, a scheduled or configured physical downlink control channel with repetition, a scheduled or configured physical uplink control channel with repetition, a physical uplink shared channel with repetition, a scheduled or configured physical downlink shared channel with repetition, a scheduled or configured sounding reference signal, a scheduled or configured channel state information reference signal, a scheduled or configured transport block over multiple slots with repetition, a scheduled or configured transport block over multiple slots without repetition, multiple physical uplink shared channel scheduled by a single downlink control information, multiple physical downlink shared channel scheduled by a single downlink control information, or a combination thereof.

As depicted in FIG. 11, there is a gap period between the non-full-duplex symbols and the full-duplex symbols. For instance, there is a gap period 1150 between the downlink symbol 1105 and the full-duplex symbols. Additionally, there is a gap period 1155 between the uplink symbol 1110 and the full-duplex symbols. That is, a filter may change or there may be a radio frequency retuning at the network entity 105 and/or the UE 115. The UE 115 may receive an indication that an occasion of a set of one or more occasions for a message occurs over a set of symbols. The set of symbols may include a set of full-duplex symbols including the downlink symbol 1105 and the uplink symbol 1110 and a set of non-full-duplex symbols including the downlink subband 1115 and the uplink subband 1120. The UE 115 may communicate the message via the occasion in accordance with a set of rules and based on the occasion being across at least one full-duplex symbol of the set of full-duplex symbol, the gap period 1150, and at least one non-full-duplex symbol of the set of non-full-duplex symbols.

As depicted in the example of FIG. 11, the UE 115 may determine that the multi-symbol resource has directional conflict with a subband on at least one of the subband full-duplex symbols and non-subband full-duplex symbols. In some examples, the set of rules may indicate that the conflicting resource blocks on reverse direction subbands are dropped across both subband full-duplex symbols and non-subband full-duplex symbols. In some examples, a first portion of the physical downlink shared channel 1125 may include demodulation reference signal 1160. For example, the UE 115 may drop one or more resource blocks of the message in accordance with the set of rules and based on the one or more resource blocks having a transmission direction that conflicts with at least one subband, or at least one guard band, or both, of the at least one full-duplex symbol of the set of full-duplex symbols or at least one or more resource blocks of the set of non-full-duplex symbols. The one or more resource blocks may overlap with the gap period 1150, each subband of the at least one subband, and at least one subband of the at least one non-full-duplex symbol of the set of non-full-duplex symbols corresponding to the at least one subband of the at least one full-duplex symbol. In this case, the occasion may be across the set of non-full-duplex symbols, the set of full-duplex symbols, and the gap period 1150 that is between the set of non-full-duplex symbols and the set of full-duplex symbols.

In some examples, the set of rules may indicate that such a configuration is not allowed, and the UE 115 may not expect the occasion to be across the set of non-full-duplex symbols, the set of full-duplex symbols, and the gap period 1150 that is between the set of non-full-duplex symbols and the set of full-duplex symbols. Additionally, or alternatively, the set of rules may indicate that, if the UE 115 cannot maintain phase continuity, then the UE 115 may rate match around the portion 1130 without the demodulation reference signal 1160. For instance, the UE 115 may perform rate matching around the one or more resource blocks of the message in accordance with the set of rules. For example, the rate matching may be performed based on one or more demodulation reference signal symbols being included in the occasion prior to the gap period 1150 that is between the set of non-full-duplex symbols and the set of full-duplex symbols.

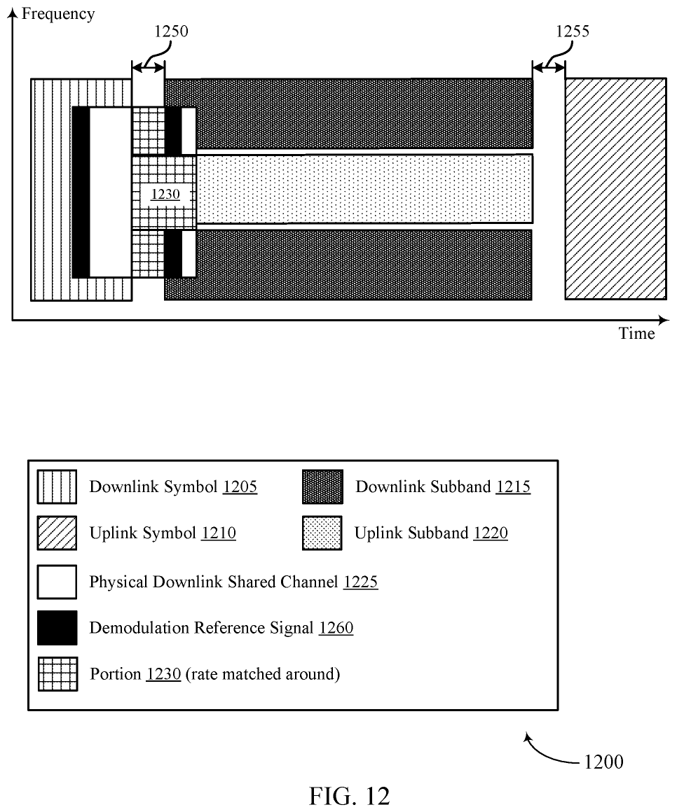

FIG. 12 illustrates an example of a slot structure 1200 that supports techniques for single transmission occasions across different symbols in accordance with one or more aspects of the present disclosure. The slot structure 1200 includes one or more full-duplex symbols and one or more non-full-duplex symbols. The full-duplex symbols may be referred to as subband full-duplex symbols and the non-full-duplex symbols may be referred to as non-subbband full-duplex symbols. The non-full-duplex symbols include downlink symbol 1205 and uplink symbol 1210. The full-duplex symbols include downlink subband 1215, which may include or be examples of downlink frequency bands (e.g., downlink subbands), and uplink subband 1220, which may include or be examples of uplink frequency bands (e.g., uplink subbands). The network entity 105 may transmit, and the UE 115 may receive, downlink communications, such as physical downlink shared channel 1225.

In the example of FIG. 12, the network entity 105 may transmit a physical downlink shared channel 1225. A single occasion of the physical downlink shared channel 1225 may be scheduled across both types of symbols. Although depicted as a physical downlink shared channel, it is to be understood that the single occasion may be one occasion of one or more of a scheduled or configured physical downlink control channel without repetition, a scheduled or configured physical uplink control channel without repetition, a scheduled or configured physical uplink shared channel without repetition, a scheduled or configured physical downlink shared channel without repetition, a scheduled or configured physical downlink control channel with repetition, a scheduled or configured physical uplink control channel with repetition, a physical uplink shared channel with repetition, a scheduled or configured physical downlink shared channel with repetition, a scheduled or configured sounding reference signal, a scheduled or configured channel state information reference signal, a scheduled or configured transport block over multiple slots with repetition, a scheduled or configured transport block over multiple slots without repetition, multiple physical uplink shared channel scheduled by a single downlink control information, multiple physical downlink shared channel scheduled by a single downlink control information, or a combination thereof.

As depicted in FIG. 12, there is a gap period between the non-full-duplex symbols and the full-duplex symbols. For instance, there is a gap period 1250 between the downlink symbol 1205 and the full-duplex symbols. Additionally, there is a gap period 1255 between the uplink symbol 1210 and the full-duplex symbols. That is, a filter may change or there may be a radio frequency retuning at the network entity 105 and/or the UE 115. The UE 115 may receive an indication that an occasion of a set of one or more occasions for a message occurs over a set of symbols. The set of symbols may include a set of full-duplex symbols including the downlink symbol 1205 and the uplink symbol 1210 and a set of non-full-duplex symbols including the downlink subband 1215 and the uplink subband 1220. The UE 115 may communicate the message via the occasion in accordance with a set of rules and based on the occasion being across at least one full-duplex symbol of the set of full-duplex symbol, the gap period 1250, and at least one non-full-duplex symbol of the set of non-full-duplex symbols.

As depicted in the example of FIG. 12, the UE 115 may determine that the multi-symbol resource has directional conflict with a subband on at least one of the subband full-duplex symbols and non-subband full-duplex symbols. In some examples, the set of rules may indicate that the conflicting resource blocks on reverse direction subbands are dropped across both subband full-duplex symbols and non-subband full-duplex symbols. In some examples, a first portion of the physical downlink shared channel 1225 may include demodulation reference signal 1260. In some examples, the set of rules may indicate that the UE 115 is to rate match across the conflicting resource blocks that has a directional conflict with a subband in subband full-duplex symbols.

The UE 115 may perform rate matching around one or more resource blocks (correspond to portion 1230) of the message in accordance with the set of rules and based on the occasion including the one or more resource blocks having a transmission direction that conflicts with at least one subband, or at least one guard band, or both, of the at least one full-duplex symbol of the set of full-duplex symbols or at least one or more resource blocks of the set of non-full-duplex symbols. In some examples, the one or more resource blocks overlap with the gap period and each subband of the at least one subband. The rate matching may be performed based on one or more demodulation reference signal 1260 symbols being included in the occasion prior to and after the gap period 1250 that is between the set of non-full-duplex symbols and the set of full-duplex symbols. In some examples, the set of rules may indicate that the UE 115 may rate match around a channel or reference signal correspond to resource elements overlapping with the gap period 1250. In some cases, the one or more resource blocks (e.g., portion 1230) may further overlap with a remaining portion of the message after the occasion prior to the gap period 1250. The rate matching may be performed based on the one or more demodulation reference signal 1260 symbols being included in the occasion prior to the gap period 1250 that is between the set of non-full-duplex symbols and the set of full-duplex symbols.

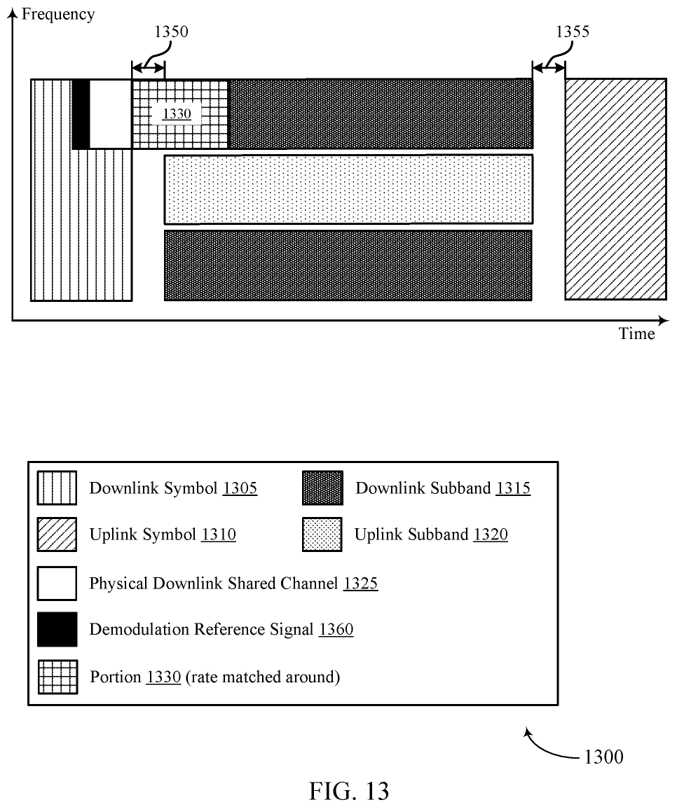

FIG. 13 illustrates an example of a slot structure 1300 that supports techniques for single transmission occasions across different symbols in accordance with one or more aspects of the present disclosure. The slot structure 1300 includes one or more full-duplex symbols and one or more non-full-duplex symbols. The full-duplex symbols may be referred to as subband full-duplex symbols and the non-full-duplex symbols may be referred to as non-subbband full-duplex symbols. The non-full-duplex symbols include downlink symbol 1305 and uplink symbol 1310. The full-duplex symbols include downlink subband 1315, which may include or be examples of downlink frequency bands (e.g., downlink subbands), and uplink subband 1320, which may include or be examples of uplink frequency bands (e.g., uplink subbands). The network entity 105 may transmit, and the UE 115 may receive, downlink communications, such as physical downlink shared channel 1325.

In the example of FIG. 13, the network entity 105 may transmit a physical downlink shared channel 1325. A single occasion of the physical downlink shared channel 1325 may be scheduled across both types of symbols. Although depicted as a physical downlink shared channel, it is to be understood that the single occasion may be one occasion of one or more of a scheduled or configured physical downlink control channel without repetition, a scheduled or configured physical uplink control channel without repetition, a scheduled or configured physical uplink shared channel without repetition, a scheduled or configured physical downlink shared channel without repetition, a scheduled or configured physical downlink control channel with repetition, a scheduled or configured physical uplink control channel with repetition, a physical uplink shared channel with repetition, a scheduled or configured physical downlink shared channel with repetition, a scheduled or configured sounding reference signal, a scheduled or configured channel state information reference signal, a scheduled or configured transport block over multiple slots with repetition, a scheduled or configured transport block over multiple slots without repetition, multiple physical uplink shared channel scheduled by a single downlink control information, multiple physical downlink shared channel scheduled by a single downlink control information, or a combination thereof.

As depicted in FIG. 13, there is a gap period between the non-full-duplex symbols and the full-duplex symbols. For instance, there is a gap period 1350 between the downlink symbol 1305 and the full-duplex symbols. Additionally, there is a gap period 1355 between the uplink symbol 1310 and the full-duplex symbols. That is, a filter may change or there may be a radio frequency retuning at the network entity 105 and/or the UE 115. The UE 115 may receive an indication that an occasion of a set of one or more occasions for a message occurs over a set of symbols. The set of symbols may include a set of full-duplex symbols including the downlink symbol 1305 and the uplink symbol 1310 and a set of non-full-duplex symbols including the downlink subband 1315 and the uplink subband 1320. The UE 115 may communicate the message via the occasion in accordance with a set of rules and based on the occasion being across at least one full-duplex symbol of the set of full-duplex symbol, the gap period 1350, and at least one non-full-duplex symbol of the set of non-full-duplex symbols.

As depicted in the example of FIG. 13, the UE 115 may determine that the multi-symbol resource has no directional conflict with a subband on both of the subband full-duplex symbols and non-subband full-duplex symbols (in addition to the gap period 1350). In some examples, the set of rules may indicate that such a case is not allowed, and the UE 115 may accordingly not expect such a case for communications. Additionally, or alternatively, the set of rules may indicate that the UE 115 is to drop the resource or occasion. In the example of FIG. 13, the occasion corresponding to the physical downlink shared channel 1325 is across the set of non-full-duplex symbols (downlink subband 1315), the set of full-duplex symbols (downlink symbol 1305), and a gap period 1350 that is between the set of non-full-duplex symbols and the set of full-duplex symbols. The UE 115 may drop one or more resource blocks of the message in accordance with the set of rules and based on the occasion including the one or more resource blocks having a transmission direction that is same as at least one subband, or at least one guard band, or both, of the at least one full-duplex symbol of the set of full-duplex symbols or at least one or more resource blocks of the set of non-full-duplex symbols. In some cases, the message may be non-overlapping with one or more other subbands of the at least one full-duplex symbol (e.g., the message corresponding to the physical downlink shared channel 1325 does not overlap with the uplink subband 1320).

In some examples, the set of rules may indicate that the UE 115 is to rate match around part of the resource or occasion. For example, the UE 115 may rate match around the portion 1330 including the gap period 1350 and after the gap period 1350, if it does not include demodulation reference signal 1360. For example, the UE 115 may perform rate matching around one or more resource blocks (portion 1330) of the message in accordance with the set of rules and based on the occasion including the one or more resource blocks having a transmission direction that is same as at least one subband, or at least one guard band, or both, of the at least one full-duplex symbol of the set of full-duplex symbols or at least one or more resource blocks of the set of non-full-duplex symbols. In some examples, the message may be non-overlapping with one or more other subbands of the at least one full-duplex symbol, and the rate matching may be performed based on one or more demodulation reference signal symbols being included in the occasion prior to the gap period that is between the set of non-full-duplex symbols and the set of full-duplex symbols.

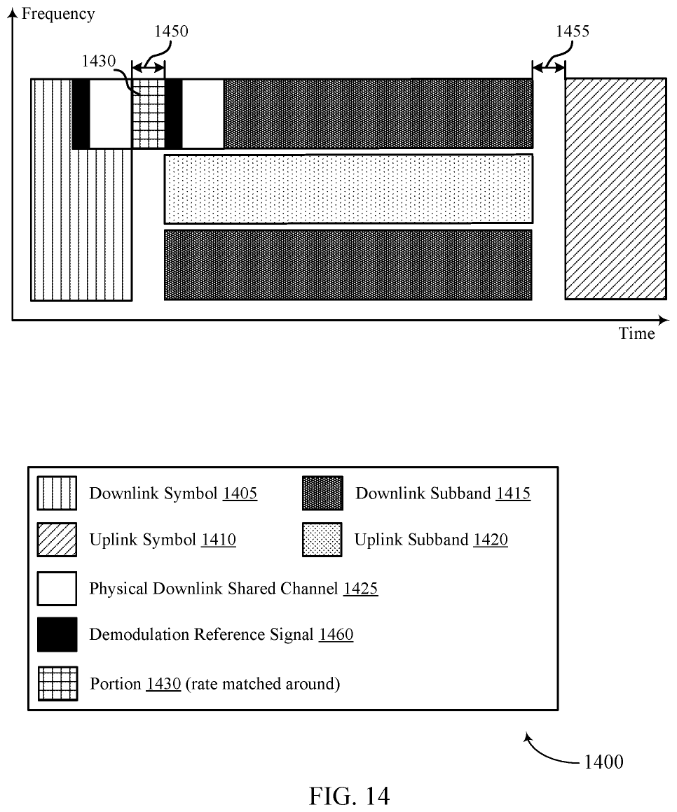

FIG. 14 illustrates an example of a slot structure 1400 that supports techniques for single transmission occasions across different symbols in accordance with one or more aspects of the present disclosure. The slot structure 1400 includes one or more full-duplex symbols and one or more non-full-duplex symbols. The full-duplex symbols may be referred to as subband full-duplex symbols and the non-full-duplex symbols may be referred to as non-subbband full-duplex symbols. The non-full-duplex symbols include downlink symbol 1405 and uplink symbol 1410. The full-duplex symbols include downlink subband 1415, which may include or be examples of downlink frequency bands (e.g., downlink subbands), and uplink subband 1420, which may include or be examples of uplink frequency bands (e.g., uplink subbands). The network entity 105 may transmit, and the UE 115 may receive, downlink communications, such as physical downlink shared channel 1425.

In the example of FIG. 14, the network entity 105 may transmit a physical downlink shared channel 1425. A single occasion of the physical downlink shared channel 1425 may be scheduled across both types of symbols. Although depicted as a physical downlink shared channel, it is to be understood that the single occasion may be one occasion of one or more of a scheduled or configured physical downlink control channel without repetition, a scheduled or configured physical uplink control channel without repetition, a scheduled or configured physical uplink shared channel without repetition, a scheduled or configured physical downlink shared channel without repetition, a scheduled or configured physical downlink control channel with repetition, a scheduled or configured physical uplink control channel with repetition, a physical uplink shared channel with repetition, a scheduled or configured physical downlink shared channel with repetition, a scheduled or configured sounding reference signal, a scheduled or configured channel state information reference signal, a scheduled or configured transport block over multiple slots with repetition, a scheduled or configured transport block over multiple slots without repetition, multiple physical uplink shared channel scheduled by a single downlink control information, multiple physical downlink shared channel scheduled by a single downlink control information, or a combination thereof.

As depicted in FIG. 14, there is a gap period between the non-full-duplex symbols and the full-duplex symbols. For instance, there is a gap period 1450 between the downlink symbol 1405 and the full-duplex symbols. Additionally, there is a gap period 1455 between the uplink symbol 1410 and the full-duplex symbols. That is, a filter may change or there may be a radio frequency retuning at the network entity 105 and/or the UE 115. The UE 115 may receive an indication that an occasion of a set of one or more occasions for a message occurs over a set of symbols. The set of symbols may include a set of full-duplex symbols including the downlink symbol 1405 and the uplink symbol 1410 and a set of non-full-duplex symbols including the downlink subband 1415 and the uplink subband 1420. The UE 115 may communicate the message via the occasion in accordance with a set of rules and based on the occasion being across at least one full-duplex symbol of the set of full-duplex symbol, the gap period 1450, and at least one non-full-duplex symbol of the set of non-full-duplex symbols.

As depicted in the example of FIG. 14, the UE 115 may determine that the multi-symbol resource has no directional conflict with a subband on both of the subband full-duplex symbols and non-subband full-duplex symbols (in addition to the gap period 1450). In some examples, the set of rules may indicate that such a case is allowed. In some cases, the set of rules indicate that the UE 115 is to rate match around the gap period 1450 if both parts have demodulation reference signal 1460. In the example of FIG. 14, both a first portion of the physical downlink shared channel 1425 before the gap period 1450 and a second portion of the physical downlink shared channel 1425 after the gap period 1450 include demodulation reference signal 1460. The UE 115 may rate match around portion 1430 in accordance with the set of rules. For example, the UE 115 may perform rate matching around one or more resource blocks (portion 1430) of the message in accordance with the set of rules and based on the occasion including the one or more resource blocks having a transmission direction that is same as at least one subband, or at least one guard band, or both, of the at least one full-duplex symbol of the set of full-duplex symbols or at least one or more resource blocks of the set of non-full-duplex symbols. The message may be non-overlapping with one or more other subbands of the at least one full-duplex symbol, and the one or more resource blocks may overlap with the gap period 1450. In such a case, the occasion may be across the set of non-full-duplex symbols, the set of full-duplex symbols, and the gap period 1450 that is between the set of non-full-duplex symbols and the set of full-duplex symbols.

In some examples, if the UE 115 or the network entity 105 cannot maintain phase continuity with the gap period 1450, in case of a downlink channel, the set of rules may indicate that the UE 115 is to bundle symbols within the part before the gap, and also bundles demodulation reference signal 1460 symbols within the part after the gap period 1450. In case of an uplink channel, the set of rules indicate that the network entity 105 is to bundle demodulation reference signal 1460 symbols within the part before the gap period 1450, and also the network entity 105 is to bundle demodulation reference signal 1460 symbols within the part after the gap period 1450. For instance, the UE 115 may bundle, in accordance with the set of rules, one or more demodulation reference signal symbols included in the occasion prior to the gap period that is between the set of non-full-duplex symbols and the set of full-duplex symbols. The UE 115 may additionally bundle, in accordance with the set of rules, one or more demodulation reference signal symbols included in the occasion after the gap period that is between the set of non-full-duplex symbols and the set of full-duplex symbols.

In some examples, a nominal time for uplink demodulation reference signal bundling may restart at the symbol boundary, if the gap period 1450 which causes phase continuity not to be maintained across transmissions of physical uplink control channel repetition within the nominal time. In such cases, the UE 115 may not be able to keep phase coherency across the slot types. In some examples, the UE 115 may inform the network entity 105 that the filter change may cause phase discontinuity, so that the network entity 105 can bundle the two parts separately. In some examples, the UE 115 and the network entity 105 may bundle both parts (prior to and after the gap period 1450). The nominal time may not break or restart. In some examples, the UE 115 may inform the network entity 105 that filter change may not cause phase discontinuity.

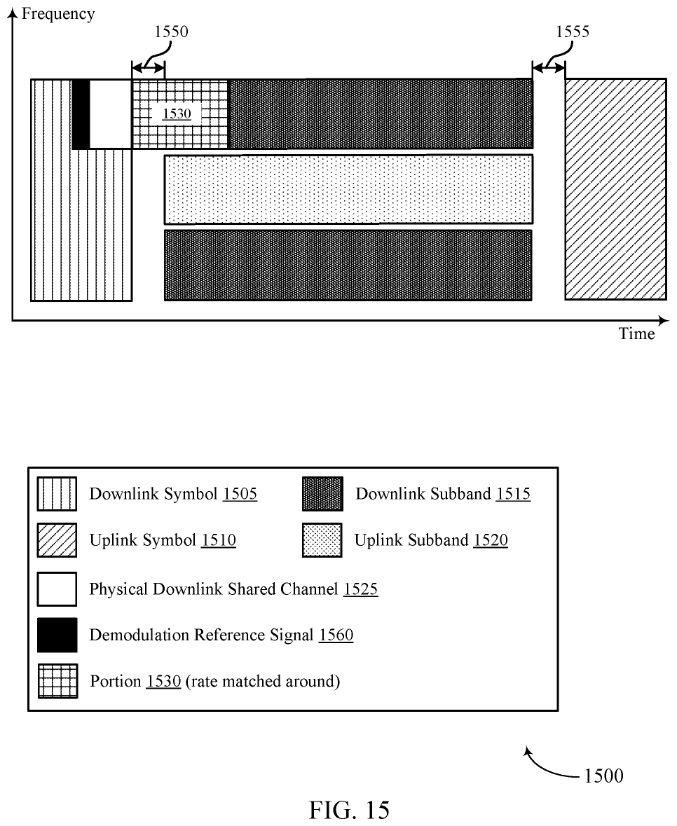

FIG. 15 illustrates an example of a slot structure 1500 that supports techniques for single transmission occasions across different symbols in accordance with one or more aspects of the present disclosure. The slot structure 1500 includes one or more full-duplex symbols and one or more non-full-duplex symbols. The full-duplex symbols may be referred to as subband full-duplex symbols and the non-full-duplex symbols may be referred to as non-subbband full-duplex symbols. The non-full-duplex symbols include downlink symbol 1505 and uplink symbol 1510. The full-duplex symbols include downlink subband 1515, which may include or be examples of downlink frequency bands (e.g., downlink subbands), and uplink subband 1520, which may include or be examples of uplink frequency bands (e.g., uplink subbands). The network entity 105 may transmit, and the UE 115 may receive, downlink communications, such as physical downlink shared channel 1525.

In the example of FIG. 15, the network entity 105 may transmit a physical downlink shared channel 1525. A single occasion of the physical downlink shared channel 1525 may be scheduled across both types of symbols. Although depicted as a physical downlink shared channel, it is to be understood that the single occasion may be one occasion of one or more of a scheduled or configured physical downlink control channel without repetition, a scheduled or configured physical uplink control channel without repetition, a scheduled or configured physical uplink shared channel without repetition, a scheduled or configured physical downlink shared channel without repetition, a scheduled or configured physical downlink control channel with repetition, a scheduled or configured physical uplink control channel with repetition, a physical uplink shared channel with repetition, a scheduled or configured physical downlink shared channel with repetition, a scheduled or configured sounding reference signal, a scheduled or configured channel state information reference signal, a scheduled or configured transport block over multiple slots with repetition, a scheduled or configured transport block over multiple slots without repetition, multiple physical uplink shared channel scheduled by a single downlink control information, multiple physical downlink shared channel scheduled by a single downlink control information, or a combination thereof.

As depicted in FIG. 15, there is a gap period between the non-full-duplex symbols and the full-duplex symbols. For instance, there is a gap period 1550 between the downlink symbol 1505 and the full-duplex symbols. Additionally, there is a gap period 1555 between the uplink symbol 1510 and the full-duplex symbols. That is, a filter may change or there may be a radio frequency retuning at the network entity 105 and/or the UE 115. The UE 115 may receive an indication that an occasion of a set of one or more occasions for a message occurs over a set of symbols. The set of symbols may include a set of full-duplex symbols including the downlink symbol 1505 and the uplink symbol 1510 and a set of non-full-duplex symbols including the downlink subband 1515 and the uplink subband 1520. The UE 115 may communicate the message via the occasion in accordance with a set of rules and based on the occasion being across at least one full-duplex symbol of the set of full-duplex symbol, the gap period 1550, and at least one non-full-duplex symbol of the set of non-full-duplex symbols.

As depicted in the example of FIG. 15, the UE 115 may determine that the multi-symbol resource has no directional conflict with a subband on both of the subband full-duplex symbols and non-subband full-duplex symbols (in addition to the gap period 1550). In some examples, the set of rules may indicate that such a case is allowed. For example, the set of rules indicate that the UE 115 is to rate match around the gap period 1550 if one part has demodulation reference signal 1460. The occasion (corresponding to the physical downlink shared channel 1525) across the set of non-full-duplex symbols, the set of full-duplex symbols, and a gap period 1550 that is between the set of non-full-duplex symbols and the set of full-duplex symbols. The UE 115 may perform rate matching around one or more resource blocks (portion 1530) of the message in accordance with the set of rules and based on the occasion including the one or more resource blocks having a transmission direction that is configured same as at least one subband, or at least one guard band, or both, of the at least one full-duplex symbol of the set of full-duplex symbols or at least one or more resource blocks of the set of non-full-duplex symbols. In some examples, the message may be non-overlapping with one or more other subbands of the at least one full-duplex symbol, and the one or more resource blocks (portion 1530) may overlap with the gap period and each subband of the at least one subband. In some examples, the set of rules may indicate that such a case is not allowed, and the UE 115 may not expect such an occasion. In some examples, the UE 115 may not maintain phase continuity, and the set of rules may indicate that the UE 115 is to rate match around the other portion 1530 without demodulation reference signal 1560.

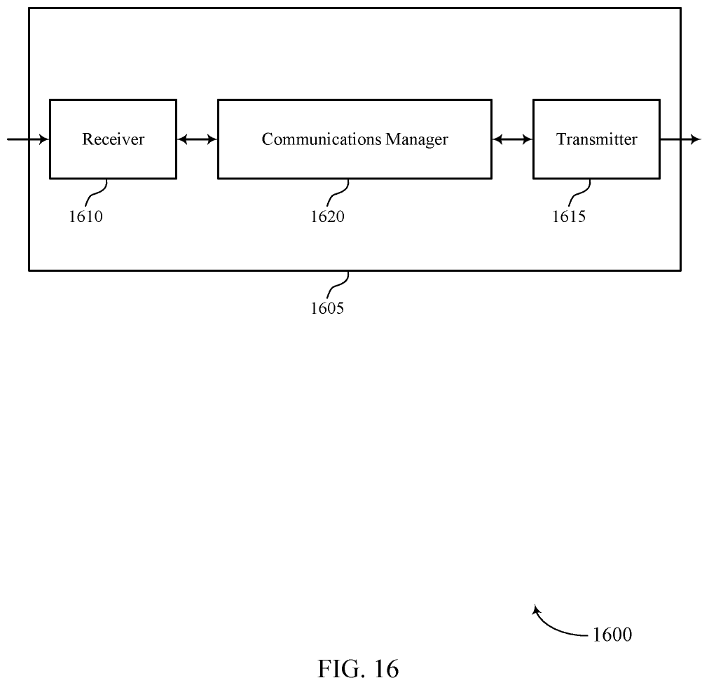

FIG. 16 illustrates a block diagram 1600 of a device 1605 that supports techniques for single transmission occasions across different symbols in accordance with one or more aspects of the present disclosure. The device 1605 may be an example of aspects of a UE 115 as described herein. The device 1605 may include a receiver 1610, a transmitter 1615, and a communications manager 1620. The device 1605 may also include a processor. Each of these components may be in communication with one another (e.g., via one or more buses).

The receiver 1610 may provide a means for receiving information such as packets, user data, control information, or any combination thereof associated with various information channels (e.g., control channels, data channels, information channels related to techniques for single transmission occasions across different symbols). Information may be passed on to other components of the device 1605. The receiver 1610 may utilize a single antenna or a set of multiple antennas.

The transmitter 1615 may provide a means for transmitting signals generated by other components of the device 1605. For example, the transmitter 1615 may transmit information such as packets, user data, control information, or any combination thereof associated with various information channels (e.g., control channels, data channels, information channels related to techniques for single transmission occasions across different symbols). In some examples, the transmitter 1615 may be co-located with a receiver 1610 in a transceiver module. The transmitter 1615 may utilize a single antenna or a set of multiple antennas.

The communications manager 1620, the receiver 1610, the transmitter 1615, or various combinations thereof or various components thereof may be examples of means for performing various aspects of techniques for single transmission occasions across different symbols as described herein. For example, the communications manager 1620, the receiver 1610, the transmitter 1615, or various combinations or components thereof may support a method for performing one or more of the functions described herein.

In some examples, the communications manager 1620, the receiver 1610, the transmitter 1615, or various combinations or components thereof may be implemented in hardware (e.g., in communications management circuitry). The hardware may include a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1620, the receiver 1610, the transmitter 1615, or various combinations or components thereof may be implemented in code (e.g., as communications management software) executed by a processor. If implemented in code executed by a processor, the functions of the communications manager 1620, the receiver 1610, the transmitter 1615, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 1620 may be configured to perform various operations (e.g., receiving, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations as described herein.

For example, the communications manager 1620 may be configured as or otherwise support a means for receiving an indication that an occasion of a set of one or more occasions for a message occurs over a set of multiple symbols, where the set of multiple symbols includes a set of full-duplex symbols and a set of non-full-duplex symbols. The communications manager 1620 may be configured as or otherwise support a means for communicating the message via the occasion in accordance with a set of rules and based on the occasion being across at least one full-duplex symbol of the set of full-duplex symbols and at least one non-full-duplex symbol of the set of non-full-duplex symbols.

By including or configuring the communications manager 1620 in accordance with examples as described herein, the device 1605 (e.g., a processor controlling or otherwise coupled with the receiver 1610, the transmitter 1615, the communications manager 1620, or a combination thereof) may support techniques for reduced processing, reduced power consumption, and more efficient utilization of communication resources.

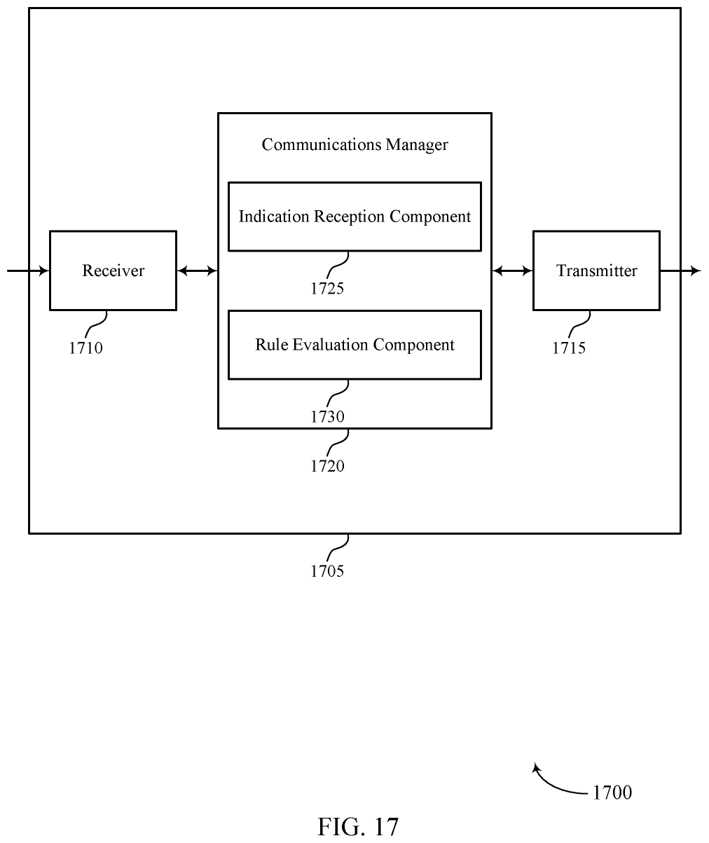

FIG. 17 illustrates a block diagram 1700 of a device 1705 that supports techniques for single transmission occasions across different symbols in accordance with one or more aspects of the present disclosure. The device 1705 may be an example of aspects of a device 1605 or a UE 115 as described herein. The device 1705 may include a receiver 1710, a transmitter 1715, and a communications manager 1720. The device 1705 may also include a processor. Each of these components may be in communication with one another (e.g., via one or more buses).

The receiver 1710 may provide a means for receiving information such as packets, user data, control information, or any combination thereof associated with various information channels (e.g., control channels, data channels, information channels related to techniques for single transmission occasions across different symbols). Information may be passed on to other components of the device 1705. The receiver 1710 may utilize a single antenna or a set of multiple antennas.

The transmitter 1715 may provide a means for transmitting signals generated by other components of the device 1705. For example, the transmitter 1715 may transmit information such as packets, user data, control information, or any combination thereof associated with various information channels (e.g., control channels, data channels, information channels related to techniques for single transmission occasions across different symbols). In some examples, the transmitter 1715 may be co-located with a receiver 1710 in a transceiver module. The transmitter 1715 may utilize a single antenna or a set of multiple antennas.

The device 1705, or various components thereof, may be an example of means for performing various aspects of techniques for single transmission occasions across different symbols as described herein. For example, the communications manager 1720 may include an indication reception component 1725 a rule evaluation component 1730, or any combination thereof. The communications manager 1720 may be an example of aspects of a communications manager 1620 as described herein. In some examples, the communications manager 1720, or various components thereof, may be configured to perform various operations (e.g., receiving, obtaining, monitoring, outputting, transmitting) using or otherwise in cooperation with the receiver 1710, the transmitter 1715, or both. For example, the communications manager 1720 may receive information from the receiver 1710, send information to the transmitter 1715, or be integrated in combination with the receiver 1710, the transmitter 1715, or both to obtain information, output information, or perform various other operations as described herein.

The indication reception component 1725 may be configured as or otherwise support a means for receiving an indication that an occasion of a set of one or more occasions for a message occurs over a set of multiple symbols, where the set of multiple symbols includes a set of full-duplex symbols and a set of non-full-duplex symbols. The rule evaluation component 1730 may be configured as or otherwise support a means for communicating the message via the occasion in accordance with a set of rules and based on the occasion being across at least one full-duplex symbol of the set of full-duplex symbols and at least one non-full-duplex symbol of the set of non-full-duplex symbols.

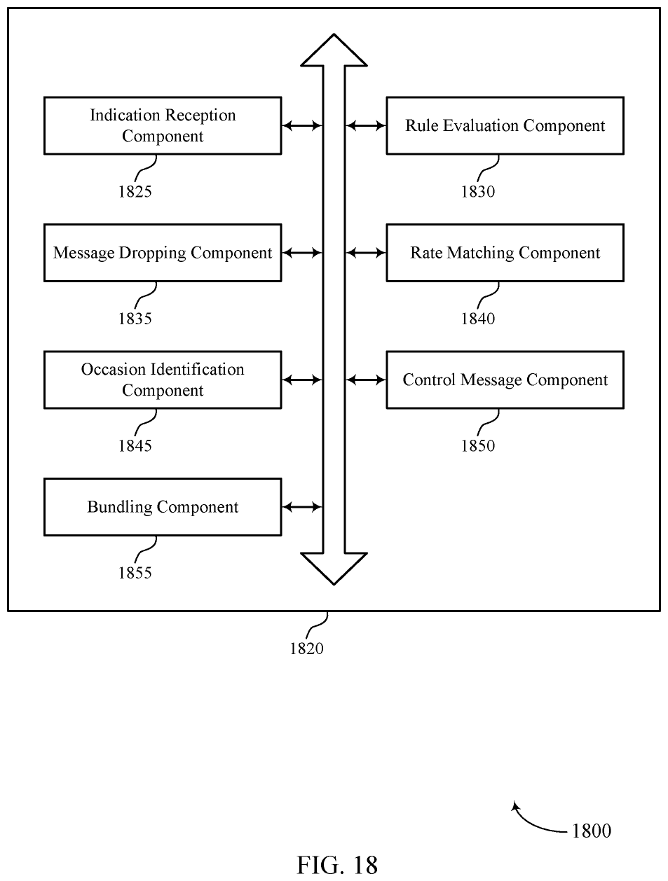

FIG. 18 illustrates a block diagram 1800 of a communications manager 1820 that supports techniques for single transmission occasions across different symbols in accordance with one or more aspects of the present disclosure. The communications manager 1820 may be an example of aspects of a communications manager 1620, a communications manager 1720, or both, as described herein. The communications manager 1820, or various components thereof, may be an example of means for performing various aspects of techniques for single transmission occasions across different symbols as described herein. For example, the communications manager 1820 may include an indication reception component 1825, a rule evaluation component 1830, a message dropping component 1835, a rate matching component 1840, an occasion identification component 1845, a control message component 1850, a bundling component 1855, or any combination thereof. Each of these components may communicate, directly or indirectly, with one another (e.g., via one or more buses).

The indication reception component 1825 may be configured as or otherwise support a means for receiving an indication that an occasion of a set of one or more occasions for a message occurs over a set of multiple symbols, where the set of multiple symbols includes a set of full-duplex symbols and a set of non-full-duplex symbols. The rule evaluation component 1830 may be configured as or otherwise support a means for communicating the message via the occasion in accordance with a set of rules and based on the occasion being across at least one full-duplex symbol of the set of full-duplex symbols and at least one non-full-duplex symbol of the set of non-full-duplex symbols.

In some examples, the set of rules indicate that communication of the message via the occasion is allowed based on the message being a first type of message and the occasion including a multi-symbol resource having a transmission direction that conflicts with at least one subband of the at least one full-duplex symbol of the set of full-duplex symbols. In some examples, the first type of message includes a physical uplink shared channel, or a physical downlink shared channel, or one or more reference signals.

In some examples, the message dropping component 1835 may be configured as or otherwise support a means for dropping the message in accordance with the set of rules and based on the occasion including a multi-symbol resource having a transmission direction that conflicts with at least one subband of the at least one full-duplex symbol of the set of full-duplex symbols.

In some examples, the rate matching component 1840 may be configured as or otherwise support a means for performing rate matching around one or more resource blocks of the message in accordance with the set of rules, where the rate matching is performed based on the occasion including the one or more resource blocks having a transmission direction that conflicts with at least one subband, or at least one guard band, or both, of the at least one full-duplex symbol of the set of full-duplex symbols, or at least one resource block of the set of non-full-duplex symbols.

In some examples, the indication reception component 1825 may be configured as or otherwise support a means for receiving, from a network entity, an indication to perform uplink cancellation for one or more resource blocks, or one or more symbols, or both, of the message in accordance with the set of rules, where the uplink cancellation is performed based on the occasion including the one or more resource blocks having a transmission direction that conflicts with at least one subband, or at least one guard band, or both, of the at least one full-duplex symbol of the set of full-duplex symbols or at least one resource block of the set of non-full-duplex symbols.

In some examples, the occasion identification component 1845 may be configured as or otherwise support a means for identifying one or more respective occasions of the message associated with a first frequency domain resource allocation of the plurality of frequency domain resource allocations, or a first time domain resource allocation of the plurality of time domain resource allocations, or both, based at least in part on the set of rules and the set of full-duplex symbols, wherein communicating the message is based at least in part on the first frequency domain resource allocation, or the first time domain resource allocation, or both for the set of non-full-duplex symbols. In some examples, the occasion identification component 1845 may be configured as or otherwise support a means for identifying one or more respective occasions of the message associated with a second frequency domain resource allocation of the plurality of frequency domain resource allocations, or a second time domain resource allocation of the plurality of time domain resource allocations, or both, for the set of non-full-duplex symbols, based at least in part on the set of rules and the set of non-full-duplex symbols, wherein communicating the message is based at least in part on the second frequency domain resource allocation, or the second time domain resource allocation, or both. In some examples, the control message component 1850 may be configured as or otherwise support a means for receiving a control message indicating a plurality of frequency domain resource allocations, or a plurality of time domain resource allocations, or both, for one or more resource blocks of one or more occasions of the message.

In some examples, the rate matching component 1840 may be configured as or otherwise support a means for performing rate matching around one or more resource blocks of the message in accordance with the set of rules, where the rate matching is performed based on the occasion including the one or more resource blocks having a transmission direction that conflicts with at least one subband of the at least one full-duplex symbol of the set of full-duplex symbols, and where the one or more resource blocks correspond to the at least one subband or at least one guard band of the at least one full-duplex symbol and at least one subband of the at least one non-full-duplex symbol of the set of non-full-duplex symbols.

In some examples, the control message component 1850 may be configured as or otherwise support a means for receiving a control message indicating that the UE update at least one subband of the at least one full-duplex symbol in accordance with the set of rules, where the at least one full-duplex symbol of the set of full-duplex symbols corresponds to a downlink symbol or a flexible symbol. In some examples, the rule evaluation component 1830 may be configured as or otherwise support a means for determining that the message corresponds to a downlink transmission and the occasion includes a multi-symbol resource having a transmission direction that conflicts with at least one subband of the at least one full-duplex symbol of the set of full-duplex symbols, where communicating the message includes receiving the downlink transmission via the occasion based on the control message.

In some examples, the control message component 1850 may be configured as or otherwise support a means for receiving a control message indicating that the UE update at least one subband of the at least one full-duplex symbol in accordance with the set of rules, where the at least one full-duplex symbol of the set of full-duplex symbols corresponds to a flexible symbol. In some examples, the rule evaluation component 1830 may be configured as or otherwise support a means for determining that the message corresponds to an uplink transmission and the occasion includes a multi-symbol resource having a transmission direction that conflicts with at least one subband of the at least one full-duplex symbol of the set of full-duplex symbols, where communicating the message includes transmitting the uplink transmission via the occasion based on the control message.

In some examples, the rule evaluation component 1830 may be configured as or otherwise support a means for determining that the message corresponds to a downlink transmission and the occasion includes a multi-symbol resource having a transmission direction that corresponds to a transmission direction of a first subband of the at least one full-duplex symbol, where the message is non-overlapping with one or more other subbands of the at least one full-duplex symbol, and where communicating the message includes receiving the downlink transmission via the first subband.

In some examples, the rule evaluation component 1830 may be configured as or otherwise support a means for determining that the message corresponds to an uplink transmission and the occasion includes a multi-symbol resource having a transmission direction that corresponds to a transmission direction of a first subband of the at least one full-duplex symbol, where the message is non-overlapping with one or more other subbands of the at least one full-duplex symbol, and where communicating the message includes transmitting the uplink transmission via the first subband.

In some examples, a second occasion of the set of one or more occasions is across the at least one non-full-duplex symbol of the set of non-full-duplex symbols and a gap period that is between the set of non-full-duplex symbols and the set of full-duplex symbols, and the message dropping component 1835 may be configured as or otherwise support a means for dropping a second message of the second occasion in accordance with the set of rules.

In some examples, a second occasion of the set of one or more occasions is across the at least one non-full-duplex symbol of the set of non-full-duplex symbols and a gap period that is between the set of non-full-duplex symbols and the set of full-duplex symbols, and the rate matching component 1840 may be configured as or otherwise support a means for performing rate matching around one or more resource blocks of a second message included in the second occasion in accordance with the set of rules, where the one or more resource blocks overlap with the gap period. In some examples, a second occasion of the set of one or more occasions is across the at least one non-full-duplex symbol of the set of non-full-duplex symbols and a gap period that is between the set of non-full-duplex symbols and the set of full-duplex symbols, and the rate matching component 1840 may be configured as or otherwise support a means for receiving the second message via the second occasion based on performing the rate matching around the one or more resource blocks.

In some examples, the occasion is across the set of non-full-duplex symbols, and the message dropping component 1835 may be configured as or otherwise support a means for dropping the message in accordance with the set of rules and based on the occasion including a multi-symbol resource having a transmission direction that conflicts with at least one subband, or at least one guard band, or both, of the at least one full-duplex symbol of the set of full-duplex symbols or at least one or more resource blocks of the set of non-full-duplex symbols.

In some examples, the occasion is across the set of non-full-duplex symbols, and the rate matching component 1840 may be configured as or otherwise support a means for performing rate matching around one or more resource blocks of the message in accordance with the set of rules, where the rate matching is performed based on the occasion including the one or more resource blocks having a transmission direction that conflicts with at least one subband, or at least one guard band, or both, of the at least one full-duplex symbol of the set of full-duplex symbols or at least one or more resource blocks of the set of non-full-duplex symbols, and where the one or more resource blocks overlap with the gap period and the at least one full-duplex symbol or the at least one or more resource blocks of the set of non-full-duplex symbols.

In some examples, the occasion is across the set of non-full-duplex symbols, and the rate matching component 1840 may be configured as or otherwise support a means for performing rate matching around one or more resource blocks of the message in accordance with the set of rules, where the rate matching is performed based on the occasion including the one or more resource blocks having a transmission direction that conflicts with at least one subband, or at least one guard band, or both, of the at least one full-duplex symbol of the set of full-duplex symbols or at least one or more resource blocks of the set of non-full-duplex symbols, and where the one or more resource blocks overlap with the gap period, each subband of the at least one subband, and at least one subband of the at least one non-full-duplex symbol of the set of non-full-duplex symbols corresponding to the at least one subband of the at least one full-duplex symbol.

In some examples, the bundling component 1855 may be configured as or otherwise support a means for bundling, in accordance with the set of rules, one or more demodulation reference signal symbols included in the occasion prior to the gap period that is between the set of non-full-duplex symbols and the set of full-duplex symbols. In some examples, the bundling component 1855 may be configured as or otherwise support a means for bundling, in accordance with the set of rules, one or more demodulation reference signal symbols included in the occasion after the gap period that is between the set of non-full-duplex symbols and the set of full-duplex symbols.

In some examples, the occasion is across the set of non-full-duplex symbols, and the message dropping component 1835 may be configured as or otherwise support a means for dropping one or more resource blocks of the message in accordance with the set of rules and based on the one or more resource blocks having a transmission direction that conflicts with at least one subband, or at least one guard band, or both, of the at least one full-duplex symbol of the set of full-duplex symbols or at least one or more resource blocks of the set of non-full-duplex symbols, and where the one or more resource blocks overlap with the gap period, each subband of the at least one subband, and at least one subband of the at least one non-full-duplex symbol of the set of non-full-duplex symbols corresponding to the at least one subband of the at least one full-duplex symbol.

In some examples, the rate matching component 1840 may be configured as or otherwise support a means for performing rate matching around the one or more resource blocks of the message in accordance with the set of rules, where the rate matching is performed based on one or more demodulation reference signal symbols being included in the occasion prior to the gap period that is between the set of non-full-duplex symbols and the set of full-duplex symbols.

In some examples, the occasion is across the set of non-full-duplex symbols, and the rate matching component 1840 may be configured as or otherwise support a means for performing rate matching around one or more resource blocks of the message in accordance with the set of rules and based on the occasion including the one or more resource blocks having a transmission direction that conflicts with at least one subband, or at least one guard band, or both, of the at least one full-duplex symbol of the set of full-duplex symbols or at least one or more resource blocks of the set of non-full-duplex symbols, where the one or more resource blocks overlap with the gap period and each subband of the at least one subband, and where the rate matching is performed based on one or more demodulation reference signal symbols being included in the occasion prior to and after the gap period that is between the set of non-full-duplex symbols and the set of full-duplex symbols.

In some examples, the one or more resource blocks further overlap with a remaining portion of the message after the occasion prior to the gap period. In some examples, the rate matching is performed based on the one or more demodulation reference signal symbols being included in the occasion prior to the gap period that is between the set of non-full-duplex symbols and the set of full-duplex symbols.

In some examples, the occasion is across the set of non-full-duplex symbols, and the message dropping component 1835 may be configured as or otherwise support a means for dropping one or more resource blocks of the message in accordance with the set of rules and based on the occasion including the one or more resource blocks having a transmission direction that is same as at least one subband, or at least one guard band, or both, of the at least one full-duplex symbol of the set of full-duplex symbols or at least one or more resource blocks of the set of non-full-duplex symbols, where the message is non-overlapping with one or more other subbands of the at least one full-duplex symbol.

In some examples, the occasion is across the set of non-full-duplex symbols, and the rate matching component 1840 may be configured as or otherwise support a means for performing rate matching around one or more resource blocks of the message in accordance with the set of rules and based on the occasion including the one or more resource blocks having a transmission direction that is same as at least one subband, or at least one guard band, or both, of the at least one full-duplex symbol of the set of full-duplex symbols or at least one or more resource blocks of the set of non-full-duplex symbols, where the message is non-overlapping with one or more other subbands of the at least one full-duplex symbol, and where the rate matching is performed based on one or more demodulation reference signal symbols being included in the occasion prior to the gap period that is between the set of non-full-duplex symbols and the set of full-duplex symbols.

In some examples, the occasion is across the set of non-full-duplex symbols, and the rate matching component 1840 may be configured as or otherwise support a means for performing rate matching around one or more resource blocks of the message in accordance with the set of rules and based on the occasion including the one or more resource blocks having a transmission direction that is same as at least one subband, or at least one guard band, or both, of the at least one full-duplex symbol of the set of full-duplex symbols or at least one or more resource blocks of the set of non-full-duplex symbols, where the message is non-overlapping with one or more other subbands of the at least one full-duplex symbol, and where the one or more resource blocks overlap with the gap period.

In some examples, the bundling component 1855 may be configured as or otherwise support a means for bundling, in accordance with the set of rules, one or more demodulation reference signal symbols included in the occasion prior to the gap period that is between the set of non-full-duplex symbols and the set of full-duplex symbols. In some examples, the bundling component 1855 may be configured as or otherwise support a means for bundling, in accordance with the set of rules, one or more demodulation reference signal symbols included in the occasion after the gap period that is between the set of non-full-duplex symbols and the set of full-duplex symbols.

In some examples, the occasion is across the set of non-full-duplex symbols, and the rate matching component 1840 may be configured as or otherwise support a means for performing rate matching around one or more resource blocks of the message in accordance with the set of rules and based on the occasion including the one or more resource blocks having a transmission direction that is configured same as at least one subband, or at least one guard band, or both, of the at least one full-duplex symbol of the set of full-duplex symbols or at least one or more resource blocks of the set of non-full-duplex symbols, where the message is non-overlapping with one or more other subbands of the at least one full-duplex symbol, and where the one or more resource blocks overlap with the gap period and each subband of the at least one subband.

In some examples, the control message component 1850 may be configured as or otherwise support a means for receiving, from a network entity, a control signal indicating the set of rules, where communicating the message is based on receiving the control signal.

In some examples, the message includes a physical downlink control channel without repetition, a physical uplink control channel without repetition, a physical uplink shared channel without repetition, physical downlink shared channel without repetition, a physical downlink control channel with repetition, a physical uplink control channel with repetition, a physical uplink shared channel with repetition, physical downlink shared channel with repetition, a sounding reference signal, a channel state information reference signal, a transport block over multiple slots with repetition, a transport block over multiple slots without repetition, multiple physical uplink shared channel scheduled by a single downlink control information, multiple physical downlink shared channel scheduled by a single downlink control information, or a combination thereof.

In some examples, the set of full-duplex symbols and the set of non-full-duplex symbols are included in same slot or in different slots. In some examples, the set of full-duplex symbols and the set of non-full-duplex symbols included in different slots include physical uplink shared channel repetition type B or supports transport block processing over multiple slots or both.

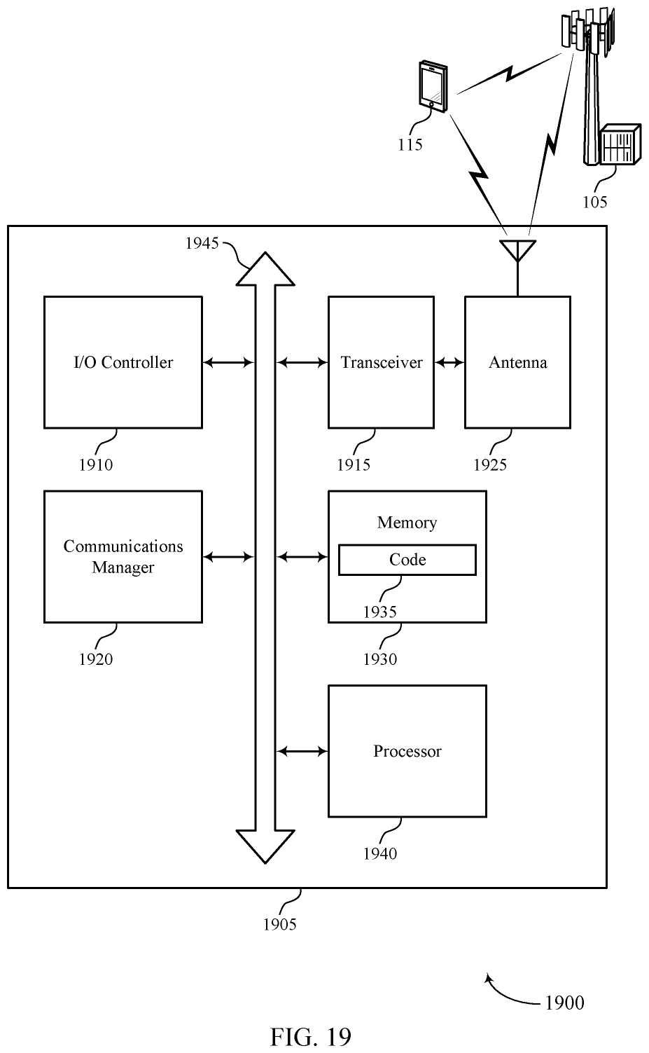

FIG. 19 illustrates a diagram of a system 1900 including a device 1905 that supports techniques for single transmission occasions across different symbols in accordance with one or more aspects of the present disclosure. The device 1905 may be an example of or include the components of a device 1605, a device 1705, or a UE 115 as described herein. The device 1905 may communicate (e.g., wirelessly) with one or more network entities 105, one or more UEs 115, or any combination thereof. The device 1905 may include components for bi-directional voice and data communications including components for transmitting and receiving communications, such as a communications manager 1920, an input/output (I/O) controller 1910, a transceiver 1915, an antenna 1925, a memory 1930, code 1935, and a processor 1940. These components may be in electronic communication or otherwise coupled (e.g., operatively, communicatively, functionally, electronically, electrically) via one or more buses (e.g., a bus 1945).

The I/O controller 1910 may manage input and output signals for the device 1905. The I/O controller 1910 may also manage peripherals not integrated into the device 1905. In some cases, the I/O controller 1910 may represent a physical connection or port to an external peripheral. In some cases, the I/O controller 1910 may utilize an operating system such as iOS®, ANDROID®, MS-DOS®, MS-WINDOWS®, OS/2®, UNIX®, LINUX®, or another known operating system. Additionally, or alternatively, the I/O controller 1910 may represent or interact with a modem, a keyboard, a mouse, a touchscreen, or a similar device. In some cases, the I/O controller 1910 may be implemented as part of a processor, such as the processor 1940. In some cases, a user may interact with the device 1905 via the I/O controller 1910 or via hardware components controlled by the I/O controller 1910.

In some cases, the device 1905 may include a single antenna 1925. However, in some other cases, the device 1905 may have more than one antenna 1925, which may be capable of concurrently transmitting or receiving multiple wireless transmissions. The transceiver 1915 may communicate bi-directionally, via the one or more antennas 1925, wired, or wireless links as described herein. For example, the transceiver 1915 may represent a wireless transceiver and may communicate bi-directionally with another wireless transceiver. The transceiver 1915 may also include a modem to modulate the packets, to provide the modulated packets to one or more antennas 1925 for transmission, and to demodulate packets received from the one or more antennas 1925. The transceiver 1915, or the transceiver 1915 and one or more antennas 1925, may be an example of a transmitter 1615, a transmitter 1715, a receiver 1610, a receiver 1710, or any combination thereof or component thereof, as described herein.

The memory 1930 may include random access memory (RAM) and read-only memory (ROM). The memory 1930 may store computer-readable, computer-executable code 1935 including instructions that, when executed by the processor 1940, cause the device 1905 to perform various functions described herein. The code 1935 may be stored in a non-transitory computer-readable medium such as system memory or another type of memory. In some cases, the code 1935 may not be directly executable by the processor 1940 but may cause a computer (e.g., when compiled and executed) to perform functions described herein. In some cases, the memory 1930 may contain, among other things, a basic I/O system (BIOS) which may control basic hardware or software operation such as the interaction with peripheral components or devices.

The processor 1940 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1940 may be configured to operate a memory array using a memory controller. In some other cases, a memory controller may be integrated into the processor 1940. The processor 1940 may be configured to execute computer-readable instructions stored in a memory (e.g., the memory 1930) to cause the device 1905 to perform various functions (e.g., functions or tasks supporting techniques for single transmission occasions across different symbols). For example, the device 1905 or a component of the device 1905 may include a processor 1940 and memory 1930 coupled with or to the processor 1940, the processor 1940 and memory 1930 configured to perform various functions described herein.

For example, the communications manager 1920 may be configured as or otherwise support a means for receiving an indication that an occasion of a set of one or more occasions for a message occurs over a set of multiple symbols, where the set of multiple symbols includes a set of full-duplex symbols and a set of non-full-duplex symbols. The communications manager 1920 may be configured as or otherwise support a means for communicating the message via the occasion in accordance with a set of rules and based on the occasion being across at least one full-duplex symbol of the set of full-duplex symbols and at least one non-full-duplex symbol of the set of non-full-duplex symbols.

By including or configuring the communications manager 1920 in accordance with examples as described herein, the device 1905 may support techniques for improved communication reliability, reduced latency, improved user experience related to reduced processing, reduced power consumption, more efficient utilization of communication resources, and improved coordination between devices.

In some examples, the communications manager 1920 may be configured to perform various operations (e.g., receiving, monitoring, transmitting) using or otherwise in cooperation with the transceiver 1915, the one or more antennas 1925, or any combination thereof. Although the communications manager 1920 is illustrated as a separate component, in some examples, one or more functions described with reference to the communications manager 1920 may be supported by or performed by the processor 1940, the memory 1930, the code 1935, or any combination thereof. For example, the code 1935 may include instructions executable by the processor 1940 to cause the device 1905 to perform various aspects of techniques for single transmission occasions across different symbols as described herein, or the processor 1940 and the memory 1930 may be otherwise configured to perform or support such operations.

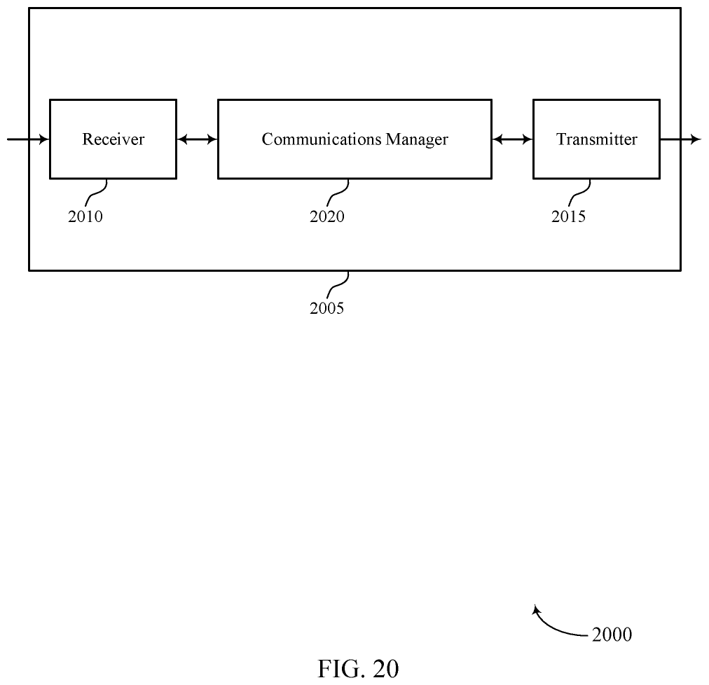

FIG. 20 illustrates a block diagram 2000 of a device 2005 that supports techniques for single transmission occasions across different symbols in accordance with one or more aspects of the present disclosure. The device 2005 may be an example of aspects of a network entity 105 as described herein. The device 2005 may include a receiver 2010, a transmitter 2015, and a communications manager 2020. The device 2005 may also include a processor. Each of these components may be in communication with one another (e.g., via one or more buses).

The receiver 2010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 2005. In some examples, the receiver 2010 may support obtaining information by receiving signals via one or more antennas. Additionally, or alternatively, the receiver 2010 may support obtaining information by receiving signals via one or more wired (e.g., electrical, fiber optic) interfaces, wireless interfaces, or any combination thereof.

The transmitter 2015 may provide a means for outputting (e.g., transmitting, providing, conveying, sending) information generated by other components of the device 2005. For example, the transmitter 2015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 2015 may support outputting information by transmitting signals via one or more antennas. Additionally, or alternatively, the transmitter 2015 may support outputting information by transmitting signals via one or more wired (e.g., electrical, fiber optic) interfaces, wireless interfaces, or any combination thereof. In some examples, the transmitter 2015 and the receiver 2010 may be co-located in a transceiver, which may include or be coupled with a modem.

The communications manager 2020, the receiver 2010, the transmitter 2015, or various combinations thereof or various components thereof may be examples of means for performing various aspects of techniques for single transmission occasions across different symbols as described herein. For example, the communications manager 2020, the receiver 2010, the transmitter 2015, or various combinations or components thereof may support a method for performing one or more of the functions described herein.

In some examples, the communications manager 2020, the receiver 2010, the transmitter 2015, or various combinations or components thereof may be implemented in hardware (e.g., in communications management circuitry). The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 2020, the receiver 2010, the transmitter 2015, or various combinations or components thereof may be implemented in code (e.g., as communications management software) executed by a processor. If implemented in code executed by a processor, the functions of the communications manager 2020, the receiver 2010, the transmitter 2015, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 2020 may be configured to perform various operations (e.g., receiving, obtaining, monitoring, outputting, transmitting) using or otherwise in cooperation with the receiver 2010, the transmitter 2015, or both. For example, the communications manager 2020 may receive information from the receiver 2010, send information to the transmitter 2015, or be integrated in combination with the receiver 2010, the transmitter 2015, or both to obtain information, output information, or perform various other operations as described herein.

The communications manager 2020 may support wireless communication at a network entity in accordance with examples as disclosed herein. For example, the communications manager 2020 may be configured as or otherwise support a means for transmitting, to a UE, an indication that an occasion of a set of one or more occasions for a message occurs over a set of multiple symbols, where the set of multiple symbols includes a set of full-duplex symbols and a set of non-full-duplex symbols. The communications manager 2020 may be configured as or otherwise support a means for communicating the message via the occasion in accordance with a set of rules and based on the occasion being across at least one full-duplex symbol of the set of full-duplex symbols and at least one non-full-duplex symbol of the set of non-full-duplex symbols.

By including or configuring the communications manager 2020 in accordance with examples as described herein, the device 2005 (e.g., a processor controlling or otherwise coupled with the receiver 2010, the transmitter 2015, the communications manager 2020, or a combination thereof) may support techniques for reduced processing, reduced power consumption, and more efficient utilization of communication resources.

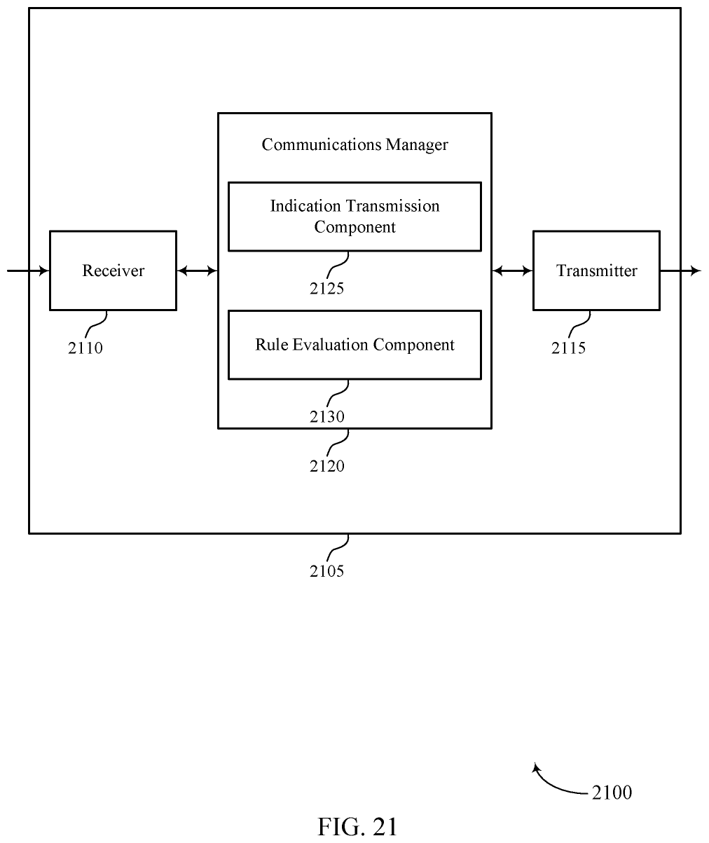

FIG. 21 illustrates a block diagram 2100 of a device 2105 that supports techniques for single transmission occasions across different symbols in accordance with one or more aspects of the present disclosure. The device 2105 may be an example of aspects of a device 2005 or a network entity 105 as described herein. The device 2105 may include a receiver 2110, a transmitter 2115, and a communications manager 2120. The device 2105 may also include a processor. Each of these components may be in communication with one another (e.g., via one or more buses).

The receiver 2110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 2105. In some examples, the receiver 2110 may support obtaining information by receiving signals via one or more antennas. Additionally, or alternatively, the receiver 2110 may support obtaining information by receiving signals via one or more wired (e.g., electrical, fiber optic) interfaces, wireless interfaces, or any combination thereof.

The transmitter 2115 may provide a means for outputting (e.g., transmitting, providing, conveying, sending) information generated by other components of the device 2105. For example, the transmitter 2115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 2115 may support outputting information by transmitting signals via one or more antennas. Additionally, or alternatively, the transmitter 2115 may support outputting information by transmitting signals via one or more wired (e.g., electrical, fiber optic) interfaces, wireless interfaces, or any combination thereof. In some examples, the transmitter 2115 and the receiver 2110 may be co-located in a transceiver, which may include or be coupled with a modem.

The device 2105, or various components thereof, may be an example of means for performing various aspects of techniques for single transmission occasions across different symbols as described herein. For example, the communications manager 2120 may include an indication transmission component 2125 a rule evaluation component 2130, or any combination thereof. The communications manager 2120 may be an example of aspects of a communications manager 2020 as described herein. In some examples, the communications manager 2120, or various components thereof, may be configured to perform various operations (e.g., receiving, obtaining, monitoring, outputting, transmitting) using or otherwise in cooperation with the receiver 2110, the transmitter 2115, or both. For example, the communications manager 2120 may receive information from the receiver 2110, send information to the transmitter 2115, or be integrated in combination with the receiver 2110, the transmitter 2115, or both to obtain information, output information, or perform various other operations as described herein.

The communications manager 2120 may support wireless communication at a network entity in accordance with examples as disclosed herein. The indication transmission component 2125 may be configured as or otherwise support a means for transmitting, to a UE, an indication that an occasion of a set of one or more occasions for a message occurs over a set of multiple symbols, where the set of multiple symbols includes a set of full-duplex symbols and a set of non-full-duplex symbols. The rule evaluation component 2130 may be configured as or otherwise support a means for communicating the message via the occasion in accordance with a set of rules and based on the occasion being across at least one full-duplex symbol of the set of full-duplex symbols and at least one non-full-duplex symbol of the set of non-full-duplex symbols.

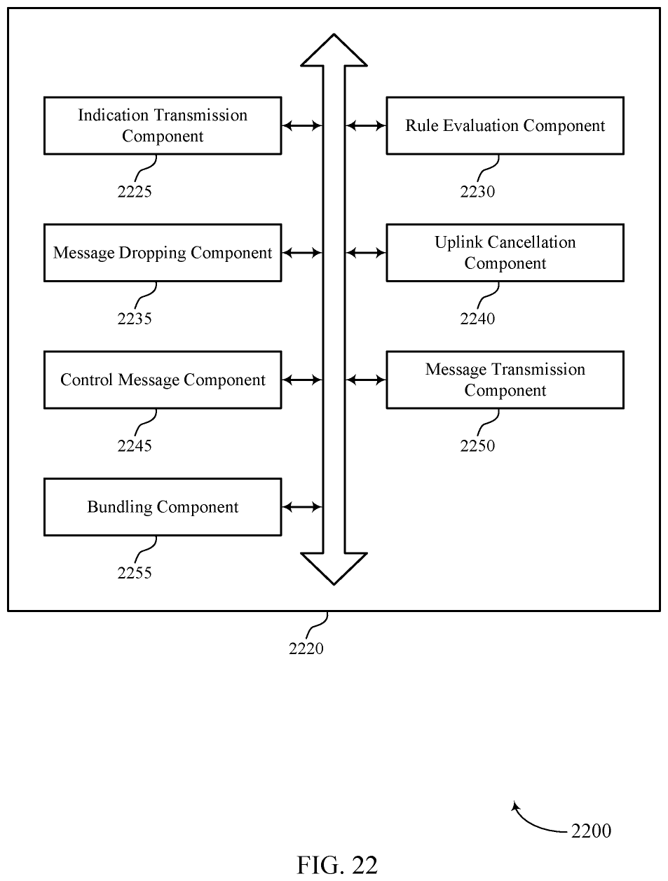

FIG. 22 illustrates a block diagram 2200 of a communications manager 2220 that supports techniques for single transmission occasions across different symbols in accordance with one or more aspects of the present disclosure. The communications manager 2220 may be an example of aspects of a communications manager 2020, a communications manager 2120, or both, as described herein. The communications manager 2220, or various components thereof, may be an example of means for performing various aspects of techniques for single transmission occasions across different symbols as described herein. For example, the communications manager 2220 may include an indication transmission component 2225, a rule evaluation component 2230, a message dropping component 2235, an uplink cancellation component 2240, a control message component 2245, a message transmission component 2250, a bundling component 2255, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 2220 may support wireless communication at a network entity in accordance with examples as disclosed herein. The indication transmission component 2225 may be configured as or otherwise support a means for transmitting, to a UE, an indication that an occasion of a set of one or more occasions for a message occurs over a set of multiple symbols, where the set of multiple symbols includes a set of full-duplex symbols and a set of non-full-duplex symbols. The rule evaluation component 2230 may be configured as or otherwise support a means for communicating the message via the occasion in accordance with a set of rules and based on the occasion being across at least one full-duplex symbol of the set of full-duplex symbols and at least one non-full-duplex symbol of the set of non-full-duplex symbols.

In some examples, the set of rules indicate that communication of the message via the occasion is allowed based on the message being a first type of message and the occasion including a multi-symbol resource having a transmission direction that conflicts with at least one subband of the at least one full-duplex symbol of the set of full-duplex symbols. In some examples, the first type of message includes a physical uplink shared channel, or a physical downlink shared channel, or one or more reference signals.

In some examples, the message dropping component 2235 may be configured as or otherwise support a means for dropping the message in accordance with the set of rules and based on the occasion including a multi-symbol resource having a transmission direction that conflicts with at least one subband of the at least one full-duplex symbol of the set of full-duplex symbols.

In some examples, the uplink cancellation component 2240 may be configured as or otherwise support a means for performing uplink cancellation for one or more resource blocks of the message in accordance with the set of rules, where the uplink cancellation is performed based on the occasion including the one or more resource blocks having a transmission direction that conflicts with at least one subband, or at least one guard band, or both, of the at least one full-duplex symbol of the set of full-duplex symbols or at least one resource block of the set of non-full-duplex symbols.

In some examples, the uplink cancellation component 2240 may be configured as or otherwise support a means for transmitting, to the UE, an indication to perform the uplink cancellation for the one or more resource blocks, or one or more symbols, or both, of the message in accordance with the set of rules.

In some examples, the control message component 2245 may be configured as or otherwise support a means for transmitting a control message indicating a set of multiple frequency domain resource allocations, or a set of multiple time domain resource allocations, or both, for one or more resource blocks of the message.

In some examples, the uplink cancellation component 2240 may be configured as or otherwise support a means for performing uplink cancellation for one or more resource blocks, or one or more symbols, or both, of the message in accordance with the set of rules, where the uplink cancellation is performed based on the occasion including the one or more resource blocks having a transmission direction that conflicts with at least one subband of the at least one full-duplex symbol of the set of full-duplex symbols, and where the one or more resource blocks correspond to the at least one subband, or at least one guard band, or both, of the at least one full-duplex symbol and at least one subband of the at least one non-full-duplex symbol of the set of non-full-duplex symbols.

In some examples, the control message component 2245 may be configured as or otherwise support a means for transmitting a control message indicating that the UE update at least one subband of the at least one full-duplex symbol in accordance with the set of rules, where the at least one full-duplex symbol of the set of full-duplex symbols corresponds to a downlink symbol or a flexible symbol. In some examples, the rule evaluation component 2230 may be configured as or otherwise support a means for determining that the message corresponds to a downlink transmission and the occasion includes a multi-symbol resource having a transmission direction that conflicts with at least one subband of the at least one full-duplex symbol of the set of full-duplex symbols, where communicating the message includes transmitting the downlink transmission via the occasion based on the control message.

In some examples, the control message component 2245 may be configured as or otherwise support a means for transmitting a control message indicating that the UE update at least one subband of the at least one full-duplex symbol in accordance with the set of rules, where the at least one full-duplex symbol of the set of full-duplex symbols corresponds to a flexible symbol. In some examples, the rule evaluation component 2230 may be configured as or otherwise support a means for determining that the message corresponds to an uplink transmission and the occasion includes a multi-symbol resource having a transmission direction that conflicts with at least one subband of the at least one full-duplex symbol of the set of full-duplex symbols, where communicating the message includes receiving the uplink transmission via the occasion based on the control message.

In some examples, the rule evaluation component 2230 may be configured as or otherwise support a means for determining that the message corresponds to a downlink transmission and the occasion includes a multi-symbol resource having a transmission direction that corresponds to a transmission direction of a first subband of the at least one full-duplex symbol, where the message is non-overlapping with one or more other subbands of the at least one full-duplex symbol, and where communicating the message includes transmitting the downlink transmission via the first subband.

In some examples, the rule evaluation component 2230 may be configured as or otherwise support a means for determining that the message corresponds to an uplink transmission and the occasion includes a multi-symbol resource having a transmission direction that corresponds to a transmission direction of a first subband of the at least one full-duplex symbol, where the message is non-overlapping with one or more other subbands of the at least one full-duplex symbol, and where communicating the message includes receiving the uplink transmission via the first subband.

In some examples, a second occasion of the set of one or more occasions is across the at least one non-full-duplex symbol of the set of non-full-duplex symbols and a gap period that is between the set of non-full-duplex symbols and the set of full-duplex symbols, and the message transmission component 2250 may be configured as or otherwise support a means for dropping a second message of the second occasion in accordance with the set of rules.

In some examples, a second occasion of the set of one or more occasions is across the at least one non-full-duplex symbol of the set of non-full-duplex symbols and a gap period that is between the set of non-full-duplex symbols and the set of full-duplex symbols, and the uplink cancellation component 2240 may be configured as or otherwise support a means for performing uplink cancellation for one or more resource blocks, or one or more symbols, or both, of a second message included in the second occasion in accordance with the set of rules, where the one or more resource blocks overlap with the gap period. In some examples, a second occasion of the set of one or more occasions is across the at least one non-full-duplex symbol of the set of non-full-duplex symbols and a gap period that is between the set of non-full-duplex symbols and the set of full-duplex symbols, and the rule evaluation component 2230 may be configured as or otherwise support a means for receiving the second message via the second occasion based on performing the uplink cancellation for the one or more resource blocks.

In some examples, the occasion is across the set of non-full-duplex symbols, and the message dropping component 2235 may be configured as or otherwise support a means for dropping the message in accordance with the set of rules and based on the occasion including a multi-symbol resource having a transmission direction that conflicts with at least one subband, or at least one guard band, or both, of the at least one full-duplex symbol of the set of full-duplex symbols or at least one or more resource blocks of the set of non-full-duplex symbols or at least one or more resource blocks of the set of non-full-duplex symbols.

In some examples, the occasion is across the set of non-full-duplex symbols, and the uplink cancellation component 2240 may be configured as or otherwise support a means for performing uplink cancellation for one or more resource blocks, or one or more symbols, or both, of the message in accordance with the set of rules, where the uplink cancellation is performed based on the occasion including the one or more resource blocks having a transmission direction that conflicts with at least one subband, or at least one guard band, or both, of the at least one full-duplex symbol of the set of full-duplex symbols or at least one or more resource blocks of the set of non-full-duplex symbols, and where the one or more resource blocks overlap with the gap period and the at least one full-duplex symbol or at least one or more resource blocks of the set of non-full-duplex symbols.

In some examples, the occasion is across the set of non-full-duplex symbols, and the uplink cancellation component 2240 may be configured as or otherwise support a means for performing uplink cancellation for one or more resource blocks, or one or more symbols, or both, of the message in accordance with the set of rules, where the uplink cancellation is performed based on the occasion including the one or more resource blocks having a transmission direction that conflicts with at least one subband, or at least one guard band, or both, of the at least one full-duplex symbol of the set of full-duplex symbols or at least one or more resource blocks of the set of non-full-duplex symbols, and where the one or more resource blocks overlap with the gap period, each subband of the at least one subband, and at least one subband of the at least one non-full-duplex symbol of the set of non-full-duplex symbols corresponding to the at least one subband of the at least one full-duplex symbol.

In some examples, the bundling component 2255 may be configured as or otherwise support a means for bundling, in accordance with the set of rules, one or more demodulation reference signal symbols included in the occasion prior to the gap period that is between the set of non-full-duplex symbols and the set of full-duplex symbols. In some examples, the bundling component 2255 may be configured as or otherwise support a means for bundling, in accordance with the set of rules, one or more demodulation reference signal symbols included in the occasion after the gap period that is between the set of non-full-duplex symbols and the set of full-duplex symbols.

In some examples, the occasion is across the set of non-full-duplex symbols, and the message dropping component 2235 may be configured as or otherwise support a means for dropping one or more resource blocks of the message in accordance with the set of rules and based on the occasion including the one or more resource blocks having a transmission direction that conflicts with at least one subband, or at least one guard band, or both, of the at least one full-duplex symbol of the set of full-duplex symbols or at least one or more resource blocks of the set of non-full-duplex symbols, and where the one or more resource blocks overlap with the gap period, each subband of the at least one subband, and at least one subband of the at least one non-full-duplex symbol of the set of non-full-duplex symbols corresponding to the at least one subband of the at least one full-duplex symbol.

In some examples, the uplink cancellation component 2240 may be configured as or otherwise support a means for performing uplink cancellation for the one or more resource blocks, or one or more symbols, or both, of the message in accordance with the set of rules, where the uplink cancellation is performed based on one or more demodulation reference signal symbols being included in the occasion prior to the gap period that is between the set of non-full-duplex symbols and the set of full-duplex symbols.

In some examples, the occasion is across the set of non-full-duplex symbols, and the uplink cancellation component 2240 may be configured as or otherwise support a means for performing uplink cancellation for one or more resource blocks, or one or more symbols, or both, of the message in accordance with the set of rules and based on the occasion including the one or more resource blocks having a transmission direction that conflicts with at least one subband, or at least one guard band, or both, of the at least one full-duplex symbol of the set of full-duplex symbols or at least one or more resource blocks of the set of non-full-duplex symbols, where the one or more resource blocks overlap with the gap period and each subband of the at least one subband, and where the uplink cancellation is performed based on one or more demodulation reference signal symbols being included in the occasion prior to and after the gap period that is between the set of non-full-duplex symbols and the set of full-duplex symbols.

In some examples, the one or more resource blocks further overlap with a remaining portion of the message after the occasion prior to the gap period. In some examples, the uplink cancellation is performed based on one or more demodulation reference signal symbols being included in the occasion prior to the gap period that is between the set of non-full-duplex symbols and the set of full-duplex symbols.

In some examples, the occasion is across the set of non-full-duplex symbols, and the message dropping component 2235 may be configured as or otherwise support a means for dropping one or more resource blocks of the message in accordance with the set of rules and based on the occasion including the one or more resource blocks having a transmission direction that is configured same as at least one subband, or at least one guard band, or both, of the at least one full-duplex symbol of the set of full-duplex symbols or at least one or more resource blocks of the set of non-full-duplex symbols, where the message is non-overlapping with one or more other subbands of the at least one full-duplex symbol.

In some examples, the occasion is across the set of non-full-duplex symbols, and the uplink cancellation component 2240 may be configured as or otherwise support a means for performing uplink cancellation for one or more resource blocks, or one or more symbols, or both, of the message in accordance with the set of rules and based on the occasion including the one or more resource blocks having a transmission direction that is configured same as at least one subband, or at least one guard band, or both, of the at least one full-duplex symbol of the set of full-duplex symbols or at least one or more resource blocks of the set of non-full-duplex symbols, where the message is non-overlapping with one or more other subbands of the at least one full-duplex symbol, and where the uplink cancellation is performed based on one or more demodulation reference signal symbols being included in the occasion prior to the gap period that is between the set of non-full-duplex symbols and the set of full-duplex symbols.

In some examples, the occasion is across the set of non-full-duplex symbols, and the uplink cancellation component 2240 may be configured as or otherwise support a means for performing uplink cancellation for one or more resource blocks, or one or more symbols, or both, of the message in accordance with the set of rules and based on the occasion including the one or more resource blocks having a transmission direction that is same as at least one subband of the at least one full-duplex symbol of the set of full-duplex symbols, where the message is non-overlapping with one or more other subbands of the at least one full-duplex symbol, and where the one or more resource blocks overlap with the gap period.

In some examples, the bundling component 2255 may be configured as or otherwise support a means for bundling, in accordance with the set of rules, one or more demodulation reference signal symbols included in the occasion prior to the gap period that is between the set of non-full-duplex symbols and the set of full-duplex symbols. In some examples, the bundling component 2255 may be configured as or otherwise support a means for bundling, in accordance with the set of rules, one or more demodulation reference signal symbols included in the occasion after the gap period that is between the set of non-full-duplex symbols and the set of full-duplex symbols.

In some examples, the occasion is across the set of non-full-duplex symbols, and the uplink cancellation component 2240 may be configured as or otherwise support a means for performing uplink cancellation for one or more resource blocks, or one or more symbols, or both, of the message in accordance with the set of rules and based on the occasion including the one or more resource blocks having a transmission direction that is same as at least one subband, or at least one guard band, or both, of the at least one full-duplex symbol of the set of full-duplex symbols or at least one or more resource blocks of the set of non-full-duplex symbols, where the message is non-overlapping with one or more other subbands of the at least one full-duplex symbol, and where the one or more resource blocks overlap with the gap period and each subband of the at least one subband.

In some examples, the message transmission component 2250 may be configured as or otherwise support a means for transmitting, to the UE, a control signal indicating the set of rules, where communicating the message is based on receiving the control signal.

In some examples, the message includes at least one of a physical downlink control channel without repetition, a physical uplink control channel without repetition, a physical uplink shared channel without repetition, physical downlink shared channel without repetition, a physical downlink control channel with repetition, a physical uplink control channel with repetition, a physical uplink shared channel with repetition, physical downlink shared channel with repetition, a sounding reference signal, a channel state information reference signal, a transport block over multiple slots with repetition, a transport block over multiple slots without repetition, multiple physical uplink shared channel scheduled by a single downlink control information, multiple physical downlink shared channel scheduled by a single downlink control information, or a combination thereof.

In some examples, the set of full-duplex symbols and the set of non-full-duplex symbols are included in same slot or in different slots. In some examples, the set of full-duplex symbols and the set of non-full-duplex symbols included in different slots include physical uplink shared channel repetition type B or supports transport block processing over multiple slots or both.

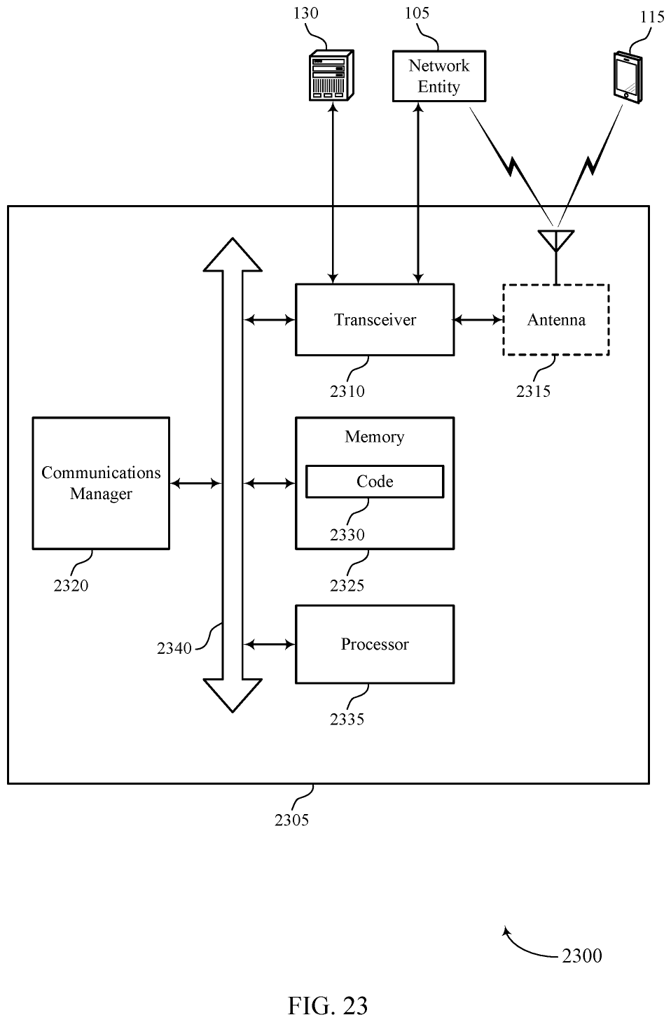

FIG. 23 illustrates a diagram of a system 2300 including a device 2305 that supports techniques for single transmission occasions across different symbols in accordance with one or more aspects of the present disclosure. The device 2305 may be an example of or include the components of a device 2005, a device 2105, or a network entity 105 as described herein. The device 2305 may communicate with one or more network entities 105, one or more UEs 115, or any combination thereof, which may include communications over one or more wired interfaces, over one or more wireless interfaces, or any combination thereof. The device 2305 may include components that support outputting and obtaining communications, such as a communications manager 2320, a transceiver 2310, an antenna 2315, a memory 2325, code 2330, and a processor 2335. These components may be in electronic communication or otherwise coupled (e.g., operatively, communicatively, functionally, electronically, electrically) via one or more buses (e.g., a bus 2340).

The transceiver 2310 may support bi-directional communications via wired links, wireless links, or both as described herein. In some examples, the transceiver 2310 may include a wired transceiver and may communicate bi-directionally with another wired transceiver. Additionally, or alternatively, in some examples, the transceiver 2310 may include a wireless transceiver and may communicate bi-directionally with another wireless transceiver. In some examples, the device 2305 may include one or more antennas 2315, which may be capable of transmitting or receiving wireless transmissions (e.g., concurrently). The transceiver 2310 may also include a modem to modulate signals, to provide the modulated signals for transmission (e.g., by one or more antennas 2315, by a wired transmitter), to receive modulated signals (e.g., from one or more antennas 2315, from a wired receiver), and to demodulate signals. In some implementations, the transceiver 2310 may include one or more interfaces, such as one or more interfaces coupled with the one or more antennas 2315 that are configured to support various receiving or obtaining operations, or one or more interfaces coupled with the one or more antennas 2315 that are configured to support various transmitting or outputting operations, or a combination thereof. In some implementations, the transceiver 2310 may include or be configured for coupling with one or more processors or memory components that are operable to perform or support operations based on received or obtained information or signals, or to generate information or other signals for transmission or other outputting, or any combination thereof. In some implementations, the transceiver 2310, or the transceiver 2310 and the one or more antennas 2315, or the transceiver 2310 and the one or more antennas 2315 and one or more processors or memory components (for example, the processor 2335, or the memory 2325, or both), may be included in a chip or chip assembly that is installed in the device 2305. In some examples, the transceiver may be operable to support communications via one or more communications links (e.g., a communication link 125, a backhaul communication link 120, a midhaul communication link 162, a fronthaul communication link 168).

The memory 2325 may include RAM and ROM. The memory 2325 may store computer-readable, computer-executable code 2330 including instructions that, when executed by the processor 2335, cause the device 2305 to perform various functions described herein. The code 2330 may be stored in a non-transitory computer-readable medium such as system memory or another type of memory. In some cases, the code 2330 may not be directly executable by the processor 2335 but may cause a computer (e.g., when compiled and executed) to perform functions described herein. In some cases, the memory 2325 may contain, among other things, a BIOS which may control basic hardware or software operation such as the interaction with peripheral components or devices.

The processor 2335 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 2335 may be configured to operate a memory array using a memory controller. In some other cases, a memory controller may be integrated into the processor 2335. The processor 2335 may be configured to execute computer-readable instructions stored in a memory (e.g., the memory 2325) to cause the device 2305 to perform various functions (e.g., functions or tasks supporting techniques for single transmission occasions across different symbols). For example, the device 2305 or a component of the device 2305 may include a processor 2335 and memory 2325 coupled with the processor 2335, the processor 2335 and memory 2325 configured to perform various functions described herein. The processor 2335 may be an example of a cloud-computing platform (e.g., one or more physical nodes and supporting software such as operating systems, virtual machines, or container instances) that may host the functions (e.g., by executing code 2330) to perform the functions of the device 2305. The processor 2335 may be any one or more suitable processors capable of executing scripts or instructions of one or more software programs stored in the device 2305 (such as within the memory 2325). In some implementations, the processor 2335 may be a component of a processing system. A processing system may generally refer to a system or series of machines or components that receives inputs and processes the inputs to produce a set of outputs (which may be passed to other systems or components of, for example, the device 2305). For example, a processing system of the device 2305 may refer to a system including the various other components or subcomponents of the device 2305, such as the processor 2335, or the transceiver 2310, or the communications manager 2320, or other components or combinations of components of the device 2305. The processing system of the device 2305 may interface with other components of the device 2305, and may process information received from other components (such as inputs or signals) or output information to other components. For example, a chip or modem of the device 2305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 2305 may transmit information output from the chip or modem. Additionally, or alternatively, in some implementations, the one or more interfaces may refer to an interface between the processing system of the chip or modem and a receiver, such that the device 2305 may obtain information or signal inputs, and the information may be passed to the processing system. A person having ordinary skill in the art will readily recognize that a first interface also may obtain information or signal inputs, and a second interface also may output information or signal outputs.

In some examples, a bus 2340 may support communications of (e.g., within) a protocol layer of a protocol stack. In some examples, a bus 2340 may support communications associated with a logical channel of a protocol stack (e.g., between protocol layers of a protocol stack), which may include communications performed within a component of the device 2305, or between different components of the device 2305 that may be co-located or located in different locations (e.g., where the device 2305 may refer to a system in which one or more of the communications manager 2320, the transceiver 2310, the memory 2325, the code 2330, and the processor 2335 may be located in one of the different components or divided between different components).

In some examples, the communications manager 2320 may manage aspects of communications with a core network 130 (e.g., via one or more wired or wireless backhaul links). For example, the communications manager 2320 may manage the transfer of data communications for client devices, such as one or more UEs 115. In some examples, the communications manager 2320 may manage communications with other network entities 105, and may include a controller or scheduler for controlling communications with UEs 115 in cooperation with other network entities 105. In some examples, the communications manager 2320 may support an X2 interface within an LTE/LTE-A wireless communications network technology to provide communication between network entities 105.

The communications manager 2320 may support wireless communication at a network entity in accordance with examples as disclosed herein. For example, the communications manager 2320 may be configured as or otherwise support a means for transmitting, to a UE, an indication that an occasion of a set of one or more occasions for a message occurs over a set of multiple symbols, where the set of multiple symbols includes a set of full-duplex symbols and a set of non-full-duplex symbols. The communications manager 2320 may be configured as or otherwise support a means for communicating the message via the occasion in accordance with a set of rules and based on the occasion being across at least one full-duplex symbol of the set of full-duplex symbols and at least one non-full-duplex symbol of the set of non-full-duplex symbols.

By including or configuring the communications manager 2320 in accordance with examples as described herein, the device 2305 may support techniques for improved communication reliability, reduced latency, improved user experience related to reduced processing, reduced power consumption, more efficient utilization of communication resources, and improved coordination between devices.

In some examples, the communications manager 2320 may be configured to perform various operations (e.g., receiving, obtaining, monitoring, outputting, transmitting) using or otherwise in cooperation with the transceiver 2310, the one or more antennas 2315 (e.g., where applicable), or any combination thereof. Although the communications manager 2320 is illustrated as a separate component, in some examples, one or more functions described with reference to the communications manager 2320 may be supported by or performed by the transceiver 2310, the processor 2335, the memory 2325, the code 2330, or any combination thereof. For example, the code 2330 may include instructions executable by the processor 2335 to cause the device 2305 to perform various aspects of techniques for single transmission occasions across different symbols as described herein, or the processor 2335 and the memory 2325 may be otherwise configured to perform or support such operations.

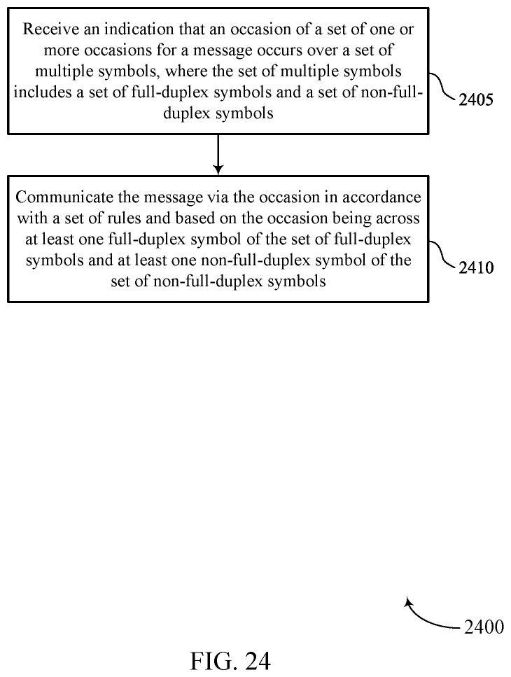

FIG. 24 illustrates a flowchart showing a method 2400 that supports techniques for single transmission occasions across different symbols in accordance with one or more aspects of the present disclosure. The operations of the method 2400 may be implemented by a UE or its components as described herein. For example, the operations of the method 2400 may be performed by a UE 115 as described with reference to FIGS. 1 through 19. In some examples, a UE may execute a set of instructions to control the functional elements of the UE to perform the described functions. Additionally, or alternatively, the UE may perform aspects of the described functions using special-purpose hardware.

At 2405, the method may include receiving an indication that an occasion of a set of one or more occasions for a message occurs over a set of multiple symbols, where the set of multiple symbols includes a set of full-duplex symbols and a set of non-full-duplex symbols. The operations of 2405 may be performed in accordance with examples as disclosed herein. In some examples, aspects of the operations of 2405 may be performed by an indication reception component 1825 as described with reference to FIG. 18.

At 2410, the method may include communicating the message via the occasion in accordance with a set of rules and based on the occasion being across at least one full-duplex symbol of the set of full-duplex symbols and at least one non-full-duplex symbol of the set of non-full-duplex symbols. The operations of 2410 may be performed in accordance with examples as disclosed herein. In some examples, aspects of the operations of 2410 may be performed by a rule evaluation component 1830 as described with reference to FIG. 18.

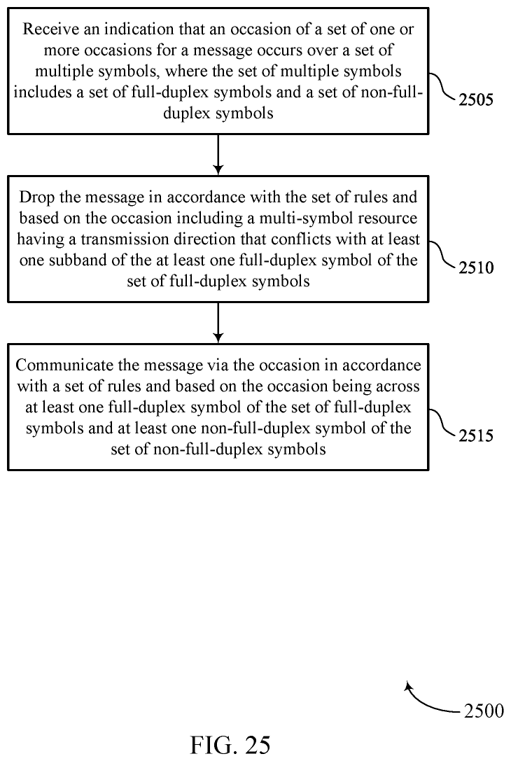

FIG. 25 illustrates a flowchart showing a method 2500 that supports techniques for single transmission occasions across different symbols in accordance with one or more aspects of the present disclosure. The operations of the method 2500 may be implemented by a UE or its components as described herein. For example, the operations of the method 2500 may be performed by a UE 115 as described with reference to FIGS. 1 through 19. In some examples, a UE may execute a set of instructions to control the functional elements of the UE to perform the described functions. Additionally, or alternatively, the UE may perform aspects of the described functions using special-purpose hardware.

At 2505, the method may include receiving an indication that an occasion of a set of one or more occasions for a message occurs over a set of multiple symbols, where the set of multiple symbols includes a set of full-duplex symbols and a set of non-full-duplex symbols. The operations of 2505 may be performed in accordance with examples as disclosed herein. In some examples, aspects of the operations of 2505 may be performed by an indication reception component 1825 as described with reference to FIG. 18.

At 2510, the method may include dropping the message in accordance with the set of rules and based on the occasion including a multi-symbol resource having a transmission direction that conflicts with at least one subband of the at least one full-duplex symbol of the set of full-duplex symbols. The operations of 2510 may be performed in accordance with examples as disclosed herein. In some examples, aspects of the operations of 2510 may be performed by a message dropping component 1835 as described with reference to FIG. 18.

At 2515, the method may include communicating the message via the occasion in accordance with a set of rules and based on the occasion being across at least one full-duplex symbol of the set of full-duplex symbols and at least one non-full-duplex symbol of the set of non-full-duplex symbols. The operations of 2515 may be performed in accordance with examples as disclosed herein. In some examples, aspects of the operations of 2515 may be performed by a rule evaluation component 1830 as described with reference to FIG. 18.

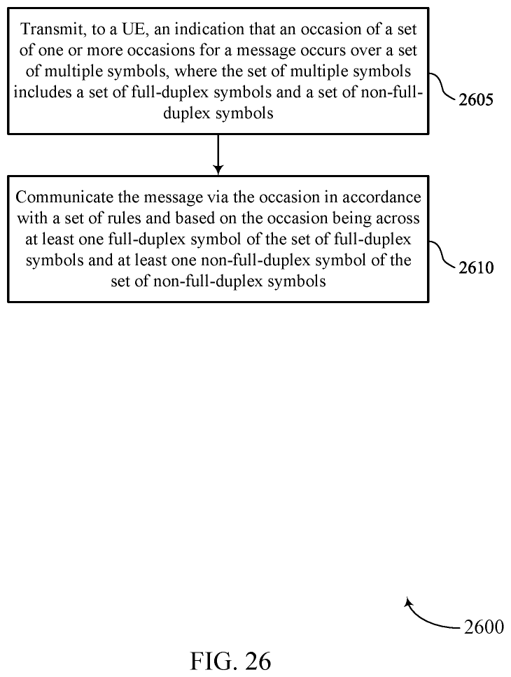

FIG. 26 illustrates a flowchart showing a method 2600 that supports techniques for single transmission occasions across different symbols in accordance with one or more aspects of the present disclosure. The operations of the method 2600 may be implemented by a network entity or its components as described herein. For example, the operations of the method 2600 may be performed by a network entity as described with reference to FIGS. 1 through 15 and 20 through 23. In some examples, a network entity may execute a set of instructions to control the functional elements of the network entity to perform the described functions. Additionally, or alternatively, the network entity may perform aspects of the described functions using special-purpose hardware.

At 2605, the method may include transmitting, to a UE, an indication that an occasion of a set of one or more occasions for a message occurs over a set of multiple symbols, where the set of multiple symbols includes a set of full-duplex symbols and a set of non-full-duplex symbols. The operations of 2605 may be performed in accordance with examples as disclosed herein. In some examples, aspects of the operations of 2605 may be performed by an indication transmission component 2225 as described with reference to FIG. 22.

At 2610, the method may include communicating the message via the occasion in accordance with a set of rules and based on the occasion being across at least one full-duplex symbol of the set of full-duplex symbols and at least one non-full-duplex symbol of the set of non-full-duplex symbols. The operations of 2610 may be performed in accordance with examples as disclosed herein. In some examples, aspects of the operations of 2610 may be performed by a rule evaluation component 2230 as described with reference to FIG. 22.

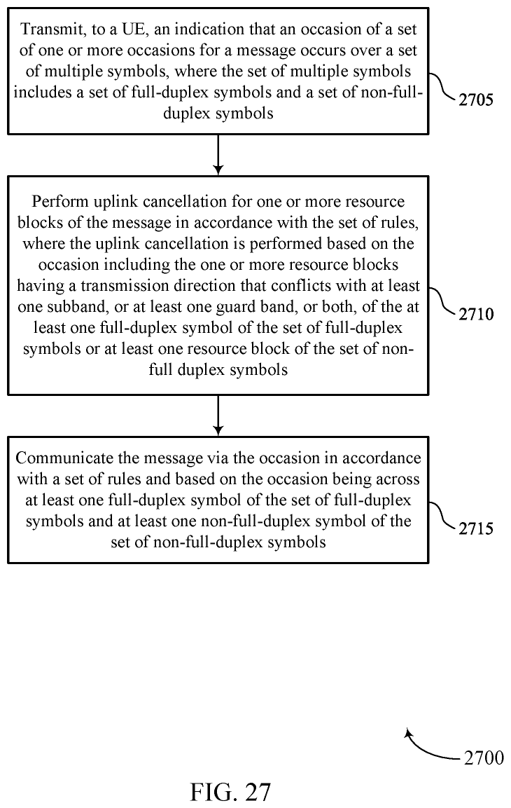

FIG. 27 illustrates a flowchart showing a method 2700 that supports techniques for single transmission occasions across different symbols in accordance with one or more aspects of the present disclosure. The operations of the method 2700 may be implemented by a network entity or its components as described herein. For example, the operations of the method 2700 may be performed by a network entity as described with reference to FIGS. 1 through 15 and 20 through 23. In some examples, a network entity may execute a set of instructions to control the functional elements of the network entity to perform the described functions. Additionally, or alternatively, the network entity may perform aspects of the described functions using special-purpose hardware.

At 2705, the method may include transmitting, to a UE, an indication that an occasion of a set of one or more occasions for a message occurs over a set of multiple symbols, where the set of multiple symbols includes a set of full-duplex symbols and a set of non-full-duplex symbols. The operations of 2705 may be performed in accordance with examples as disclosed herein. In some examples, aspects of the operations of 2705 may be performed by an indication transmission component 2225 as described with reference to FIG. 22.

At 2710, the method may include performing uplink cancellation for one or more resource blocks, or one or more symbols, or both, of the message in accordance with the set of rules, where the uplink cancellation is performed based on the occasion including the one or more resource blocks having a transmission direction that conflicts with at least one subband, or at least one guard band, or both, of the at least one full-duplex symbol of the set of full-duplex symbols or at least one resource block of the set of non-full-duplex symbols. The operations of 2710 may be performed in accordance with examples as disclosed herein. In some examples, aspects of the operations of 2710 may be performed by an uplink cancellation component 2240 as described with reference to FIG. 22.

At 2715, the method may include communicating the message via the occasion in accordance with a set of rules and based on the occasion being across at least one full-duplex symbol of the set of full-duplex symbols and at least one non-full-duplex symbol of the set of non-full-duplex symbols. The operations of 2715 may be performed in accordance with examples as disclosed herein. In some examples, aspects of the operations of 2715 may be performed by a rule evaluation component 2230 as described with reference to FIG. 22.

The following provides an overview of aspects of the present disclosure:

Aspect 1: A method for wireless communication at a UE, comprising: receiving an indication that an occasion of a set of one or more occasions for a message occurs over a plurality of symbols, wherein the plurality of symbols comprises a set of full-duplex symbols and a set of non-full-duplex symbols; and communicating the message via the occasion in accordance with a set of rules and based at least in part on the occasion being across at least one full-duplex symbol of the set of full-duplex symbols and at least one non-full-duplex symbol of the set of non-full-duplex symbols.

Aspect 2: The method of aspect 1, wherein the set of rules indicate that communication of the message via the occasion is allowed based at least in part on the message being a first type of message and the occasion comprising a multi-symbol resource having a transmission direction that conflicts with at least one subband of the at least one full-duplex symbol of the set of full-duplex symbols.

Aspect 3: The method of aspect 2, wherein the first type of message comprises a physical uplink shared channel, or a physical downlink shared channel, or one or more reference signals.

Aspect 4: The method of any of aspects 1 through 3, further comprising: dropping the message in accordance with the set of rules and based at least in part on the occasion comprising a multi-symbol resource having a transmission direction that conflicts with at least one subband of the at least one full-duplex symbol of the set of full-duplex symbols.

Aspect 5: The method of any of aspects 1 through 4, further comprising: performing rate matching around one or more resource blocks of the message in accordance with the set of rules, wherein the rate matching is performed based at least in part on the occasion comprising the one or more resource blocks having a transmission direction that conflicts with at least one subband, or at least one guard band, or both, of the at least one full-duplex symbol of the set of full-duplex symbols, or at least one resource block of the set of non-full-duplex symbols.

Aspect 6: The method of any of aspects 1 through 5, further comprising: receiving, from a network entity, an indication to perform uplink cancellation for one or more resource blocks, or one or more symbols, or both, of the message in accordance with the set of rules, wherein the uplink cancellation is performed based at least in part on the occasion comprising the one or more resource blocks having a transmission direction that conflicts with at least one subband, or at least one guard band, or both, of the at least one full-duplex symbol of the set of full-duplex symbols or at least one resource block of the set of non-full-duplex symbols.

Aspect 7: The method of any of aspects 1 through 6, further comprising: receiving a control message indicating a plurality of frequency domain resource allocations, or a plurality of time domain resource allocations, or both, for one or more resource blocks of one or more occasions of the message; identifying one or more respective occasions of the message associated with a first frequency domain resource allocation of the plurality of frequency domain resource allocations, or a first time domain resource allocation of the plurality of time domain resource allocations, or both, for the set of full-duplex symbols, based at least in part on the set of rules and the set of full-duplex symbols, wherein communicating the message is based at least in part on the first frequency domain resource allocation, or first the time domain resource allocation, or both; and identifying one or more respective occasions of the message associated with a second frequency domain resource allocation of the plurality of frequency domain resource allocations, or a second time domain resource allocation of the plurality of time domain resource allocations, or both, for the set of non-full-duplex symbols, based at least in part on the set of rules and the set of non-full-duplex symbols, wherein communicating the message is based at least in part on the second frequency domain resource allocation, or the second time domain resource allocation, or both.

Aspect 8: The method of any of aspects 1 through 7, further comprising: performing rate matching around one or more resource blocks of the message in accordance with the set of rules, wherein the rate matching is performed based at least in part on the occasion comprising the one or more resource blocks having a transmission direction that conflicts with at least one subband of the at least one full-duplex symbol of the set of full-duplex symbols, and wherein the one or more resource blocks correspond to the at least one subband or at least one guard band of the at least one full-duplex symbol and at least one subband of the at least one non-full-duplex symbol of the set of non-full-duplex symbols.

Aspect 9: The method of any of aspects 1 through 8, further comprising: receiving a control message indicating that the UE update at least one subband of the at least one full-duplex symbol in accordance with the set of rules, wherein the at least one full-duplex symbol of the set of full-duplex symbols corresponds to a downlink symbol or a flexible symbol; and determining that the message corresponds to a downlink transmission and the occasion comprises a multi-symbol resource having a transmission direction that conflicts with at least one subband of the at least one full-duplex symbol of the set of full-duplex symbols, wherein communicating the message comprises receiving the downlink transmission via the occasion based at least in part on the control message.

Aspect 10: The method of any of aspects 1 through 9, further comprising: receiving a control message indicating that the UE update at least one subband of the at least one full-duplex symbol in accordance with the set of rules, wherein the at least one full-duplex symbol of the set of full-duplex symbols corresponds to a flexible symbol; and determining that the message corresponds to an uplink transmission and the occasion comprises a multi-symbol resource having a transmission direction that conflicts with at least one subband of the at least one full-duplex symbol of the set of full-duplex symbols, wherein communicating the message comprises transmitting the uplink transmission via the occasion based at least in part on the control message.

Aspect 11: The method of any of aspects 1 through 10, further comprising: determining that the message corresponds to a downlink transmission and the occasion comprises a multi-symbol resource having a transmission direction that corresponds to a transmission direction of a first subband of the at least one full-duplex symbol, wherein the message is non-overlapping with one or more other subbands of the at least one full-duplex symbol, and wherein communicating the message comprises receiving the downlink transmission via the first subband.

Aspect 12: The method of any of aspects 1 through 11, further comprising: determining that the message corresponds to an uplink transmission and the occasion comprises a multi-symbol resource having a transmission direction that corresponds to a transmission direction of a first subband of the at least one full-duplex symbol, wherein the message is non-overlapping with one or more other subbands of the at least one full-duplex symbol, and wherein communicating the message comprises transmitting the uplink transmission via the first subband.

Aspect 13: The method of any of aspects 1 through 12, wherein a second occasion of the set of one or more occasions is across the at least one non-full-duplex symbol of the set of non-full-duplex symbols and a gap period that is between the set of non-full-duplex symbols and the set of full-duplex symbols, the method further comprising: dropping a second message of the second occasion in accordance with the set of rules.

Aspect 14: The method of any of aspects 1 through 13, wherein a second occasion of the set of one or more occasions is across the at least one non-full-duplex symbol of the set of non-full-duplex symbols and a gap period that is between the set of non-full-duplex symbols and the set of full-duplex symbols, the method further comprising: performing rate matching around one or more resource blocks of a second message included in the second occasion in accordance with the set of rules, wherein the one or more resource blocks overlap with the gap period; and receiving the second message via the second occasion based at least in part on performing the rate matching around the one or more resource blocks.

Aspect 15: The method of any of aspects 1 through 14, wherein the occasion is across the set of non-full-duplex symbols, the set of full-duplex symbols, and a gap period that is between the set of non-full-duplex symbols and the set of full-duplex symbols, the method further comprising: dropping the message in accordance with the set of rules and based at least in part on the occasion comprising a multi-symbol resource having a transmission direction that conflicts with at least one subband, or at least one guard band, or both, of the at least one full-duplex symbol of the set of full-duplex symbols or at least one or more resource blocks of the set of non-full-duplex symbols.

Aspect 16: The method of any of aspects 1 through 15, wherein the occasion is across the set of non-full-duplex symbols, the set of full-duplex symbols, and a gap period that is between the set of non-full-duplex symbols and the set of full-duplex symbols, the method further comprising: performing rate matching around one or more resource blocks of the message in accordance with the set of rules, wherein the rate matching is performed based at least in part on the occasion comprising the one or more resource blocks having a transmission direction that conflicts with at least one subband, or at least one guard band, or both, of the at least one full-duplex symbol of the set of full-duplex symbols or at least one or more resource blocks of the set of non-full-duplex symbols, and wherein the one or more resource blocks overlap with the gap period and the at least one full-duplex symbol or the at least one or more resource blocks of the set of non-full-duplex symbols.

Aspect 17: The method of any of aspects 1 through 16, wherein the occasion is across the set of non-full-duplex symbols, the set of full-duplex symbols, and a gap period that is between the set of non-full-duplex symbols and the set of full-duplex symbols, the method further comprising: performing rate matching around one or more resource blocks of the message in accordance with the set of rules, wherein the rate matching is performed based at least in part on the occasion comprising the one or more resource blocks having a transmission direction that conflicts with at least one subband, or at least one guard band, or both, of the at least one full-duplex symbol of the set of full-duplex symbols or at least one or more resource blocks of the set of non-full-duplex symbols, and wherein the one or more resource blocks overlap with the gap period, each subband of the at least one subband, and at least one subband of the at least one non-full-duplex symbol of the set of non-full-duplex symbols corresponding to the at least one subband of the at least one full-duplex symbol.

Aspect 18: The method of aspect 17, further comprising: bundling, in accordance with the set of rules, one or more demodulation reference signal symbols included in the occasion prior to the gap period that is between the set of non-full-duplex symbols and the set of full-duplex symbols; and bundling, in accordance with the set of rules, one or more demodulation reference signal symbols included in the occasion after the gap period that is between the set of non-full-duplex symbols and the set of full-duplex symbols.

Aspect 19: The method of any of aspects 1 through 18, wherein the occasion is across the set of non-full-duplex symbols, the set of full-duplex symbols, and a gap period that is between the set of non-full-duplex symbols and the set of full-duplex symbols, the method further comprising: dropping one or more resource blocks of the message in accordance with the set of rules and based at least in part on the one or more resource blocks having a transmission direction that conflicts with at least one subband, or at least one guard band, or both, of the at least one full-duplex symbol of the set of full-duplex symbols or at least one or more resource blocks of the set of non-full-duplex symbols, and wherein the one or more resource blocks overlap with the gap period, each subband of the at least one subband, and at least one subband of the at least one non-full-duplex symbol of the set of non-full-duplex symbols corresponding to the at least one subband of the at least one full-duplex symbol.

Aspect 20: The method of aspect 19, further comprising: performing rate matching around the one or more resource blocks of the message in accordance with the set of rules, wherein the rate matching is performed based at least in part on one or more demodulation reference signal symbols being included in the occasion prior to the gap period that is between the set of non-full-duplex symbols and the set of full-duplex symbols.

Aspect 21: The method of any of aspects 1 through 20, wherein the occasion is across the set of non-full-duplex symbols, the set of full-duplex symbols, and a gap period that is between the set of non-full-duplex symbols and the set of full-duplex symbols, the method further comprising: performing rate matching around one or more resource blocks of the message in accordance with the set of rules and based at least in part on the occasion comprising the one or more resource blocks having a transmission direction that conflicts with at least one subband, or at least one guard band, or both, of the at least one full-duplex symbol of the set of full-duplex symbols or at least one or more resource blocks of the set of non-full-duplex symbols, wherein the one or more resource blocks overlap with the gap period and each subband of the at least one subband, and wherein the rate matching is performed based at least in part on one or more demodulation reference signal symbols being included in the occasion prior to and after the gap period that is between the set of non-full-duplex symbols and the set of full-duplex symbols.

Aspect 22: The method of aspect 21, wherein the one or more resource blocks further overlap with a remaining portion of the message after the occasion prior to the gap period, and the rate matching is performed based at least in part on the one or more demodulation reference signal symbols being included in the occasion prior to the gap period that is between the set of non-full-duplex symbols and the set of full-duplex symbols.

Aspect 23: The method of any of aspects 1 through 22, wherein the occasion is across the set of non-full-duplex symbols, the set of full-duplex symbols, and a gap period that is between the set of non-full-duplex symbols and the set of full-duplex symbols, the method further comprising: dropping one or more resource blocks of the message in accordance with the set of rules and based at least in part on the occasion comprising the one or more resource blocks having a transmission direction that is same as at least one subband, or at least one guard band, or both, of the at least one full-duplex symbol of the set of full-duplex symbols or at least one or more resource blocks of the set of non-full-duplex symbols, wherein the message is non-overlapping with one or more other subbands of the at least one full-duplex symbol.

Aspect 24: The method of any of aspects 1 through 23, wherein the occasion is across the set of non-full-duplex symbols, the set of full-duplex symbols, and a gap period that is between the set of non-full-duplex symbols and the set of full-duplex symbols, the method further comprising: performing rate matching around one or more resource blocks of the message in accordance with the set of rules and based at least in part on the occasion comprising the one or more resource blocks having a transmission direction that is same as at least one subband, or at least one guard band, or both, of the at least one full-duplex symbol of the set of full-duplex symbols or at least one or more resource blocks of the set of non-full-duplex symbols, wherein the message is non-overlapping with one or more other subbands of the at least one full-duplex symbol, and wherein the rate matching is performed based at least in part on one or more demodulation reference signal symbols being included in the occasion prior to the gap period that is between the set of non-full-duplex symbols and the set of full-duplex symbols.

Aspect 25: The method of any of aspects 1 through 24, wherein the occasion is across the set of non-full-duplex symbols, the set of full-duplex symbols, and a gap period that is between the set of non-full-duplex symbols and the set of full-duplex symbols, the method further comprising: performing rate matching around one or more resource blocks of the message in accordance with the set of rules and based at least in part on the occasion comprising the one or more resource blocks having a transmission direction that is same as at least one subband, or at least one guard band, or both, of the at least one full-duplex symbol of the set of full-duplex symbols or at least one or more resource blocks of the set of non-full-duplex symbols, wherein the message is non-overlapping with one or more other subbands of the at least one full-duplex symbol, and wherein the one or more resource blocks overlap with the gap period.

Aspect 26: The method of aspect 25, further comprising: bundling, in accordance with the set of rules, one or more demodulation reference signal symbols included in the occasion prior to the gap period that is between the set of non-full-duplex symbols and the set of full-duplex symbols; and bundling, in accordance with the set of rules, one or more demodulation reference signal symbols included in the occasion after the gap period that is between the set of non-full-duplex symbols and the set of full-duplex symbols.

Aspect 27: The method of any of aspects 1 through 26, wherein the occasion is across the set of non-full-duplex symbols, the set of full-duplex symbols, and a gap period that is between the set of non-full-duplex symbols and the set of full-duplex symbols, the method further comprising: performing rate matching around one or more resource blocks of the message in accordance with the set of rules and based at least in part on the occasion comprising the one or more resource blocks having a transmission direction that is configured same as at least one subband, or at least one guard band, or both, of the at least one full-duplex symbol of the set of full-duplex symbols or at least one or more resource blocks of the set of non-full-duplex symbols, wherein the message is non-overlapping with one or more other subbands of the at least one full-duplex symbol, and wherein the one or more resource blocks overlap with the gap period and each subband of the at least one subband.

Aspect 28: The method of any of aspects 1 through 27, further comprising: receiving, from a network entity, a control signal indicating the set of rules, wherein communicating the message is based at least in part on receiving the control signal.

Aspect 29: The method of any of aspects 1 through 28, wherein the message comprises a physical downlink control channel without repetition, a physical uplink control channel without repetition, a physical uplink shared channel without repetition, physical downlink shared channel without repetition, a physical downlink control channel with repetition, a physical uplink control channel with repetition, a physical uplink shared channel with repetition, physical downlink shared channel with repetition, a sounding reference signal, a channel state information reference signal, a transport block over multiple slots with repetition, a transport block over multiple slots without repetition, multiple physical uplink shared channel scheduled by a single downlink control information, multiple physical downlink shared channel scheduled by a single downlink control information, or a combination thereof.

Aspect 30: The method of any of aspects 1 through 29, wherein the set of full-duplex symbols and the set of non-full-duplex symbols are included in same slot or in different slots.

Aspect 31: The method of any of aspects 1 through 30, wherein the set of full-duplex symbols and the set of non-full-duplex symbols included in different slots comprise physical uplink shared channel repetition type B or supports transport block processing over multiple slots or both.

Aspect 32: A method for wireless communication at a network entity, comprising: transmitting, to a UE, an indication that an occasion of a set of one or more occasions for a message occurs over a plurality of symbols, wherein the plurality of symbols comprises a set of full-duplex symbols and a set of non-full-duplex symbols; and communicating the message via the occasion in accordance with a set of rules and based at least in part on the occasion being across at least one full-duplex symbol of the set of full-duplex symbols and at least one non-full-duplex symbol of the set of non-full-duplex symbols.

Aspect 33: The method of aspect 32, wherein the set of rules indicate that communication of the message via the occasion is allowed based at least in part on the message being a first type of message and the occasion comprising a multi-symbol resource having a transmission direction that conflicts with at least one subband of the at least one full-duplex symbol of the set of full-duplex symbols.

Aspect 34: The method of aspect 33, wherein the first type of message comprises a physical uplink shared channel, or a physical downlink shared channel, or one or more reference signals.

Aspect 35: The method of any of aspects 32 through 34, further comprising: dropping the message in accordance with the set of rules and based at least in part on the occasion comprising a multi-symbol resource having a transmission direction that conflicts with at least one subband of the at least one full-duplex symbol of the set of full-duplex symbols.

Aspect 36: The method of any of aspects 32 through 35, further comprising: performing uplink cancellation for one or more resource blocks, or one or more symbols, or both, of the message in accordance with the set of rules, wherein the uplink cancellation is performed based at least in part on the occasion comprising the one or more resource blocks having a transmission direction that conflicts with at least one subband, or at least one guard band, or both, of the at least one full-duplex symbol of the set of full-duplex symbols or at least one resource block of the set of non-full-duplex symbols.

Aspect 37: The method of aspect 36, further comprising: transmitting, to the UE, an indication to perform the uplink cancellation for the one or more resource blocks, or one or more symbols, or both, of the message in accordance with the set of rules.

Aspect 38: The method of any of aspects 32 through 37, further comprising: transmitting a control message indicating a plurality of frequency domain resource allocations, or a plurality of time domain resource allocations, or both, for one or more resource blocks of the message.

Aspect 39: The method of any of aspects 32 through 38, further comprising: performing uplink cancellation for one or more resource blocks, or one or more symbols, or both, of the message in accordance with the set of rules, wherein the uplink cancellation is performed based at least in part on the occasion comprising the one or more resource blocks having a transmission direction that conflicts with at least one subband of the at least one full-duplex symbol of the set of full-duplex symbols, and wherein the one or more resource blocks correspond to the at least one subband, or at least one guard band, or both, of the at least one full-duplex symbol and at least one subband of the at least one non-full-duplex symbol of the set of non-full-duplex symbols.

Aspect 40: The method of any of aspects 32 through 39, further comprising: transmitting a control message indicating that the UE update at least one subband of the at least one full-duplex symbol in accordance with the set of rules, wherein the at least one full-duplex symbol of the set of full-duplex symbols corresponds to a downlink symbol or a flexible symbol; and determining that the message corresponds to a downlink transmission and the occasion comprises a multi-symbol resource having a transmission direction that conflicts with at least one subband of the at least one full-duplex symbol of the set of full-duplex symbols, wherein communicating the message comprises transmitting the downlink transmission via the occasion based at least in part on the control message.

Aspect 41: The method of any of aspects 32 through 40, further comprising: transmitting a control message indicating that the UE update at least one subband of the at least one full-duplex symbol in accordance with the set of rules, wherein the at least one full-duplex symbol of the set of full-duplex symbols corresponds to a flexible symbol; and determining that the message corresponds to an uplink transmission and the occasion comprises a multi-symbol resource having a transmission direction that conflicts with at least one subband of the at least one full-duplex symbol of the set of full-duplex symbols, wherein communicating the message comprises receiving the uplink transmission via the occasion based at least in part on the control message.

Aspect 42: The method of any of aspects 32 through 41, further comprising: determining that the message corresponds to a downlink transmission and the occasion comprises a multi-symbol resource having a transmission direction that corresponds to a transmission direction of a first subband of the at least one full-duplex symbol, wherein the message is non-overlapping with one or more other subbands of the at least one full-duplex symbol, and wherein communicating the message comprises transmitting the downlink transmission via the first subband.

Aspect 43: The method of any of aspects 32 through 42, further comprising: determining that the message corresponds to an uplink transmission and the occasion comprises a multi-symbol resource having a transmission direction that corresponds to a transmission direction of a first subband of the at least one full-duplex symbol, wherein the message is non-overlapping with one or more other subbands of the at least one full-duplex symbol, and wherein communicating the message comprises receiving the uplink transmission via the first subband.

Aspect 44: The method of any of aspects 32 through 43, wherein a second occasion of the set of one or more occasions is across the at least one non-full-duplex symbol of the set of non-full-duplex symbols and a gap period that is between the set of non-full-duplex symbols and the set of full-duplex symbols, the method further comprising: dropping a second message of the second occasion in accordance with the set of rules.

Aspect 45: The method of any of aspects 32 through 44, wherein a second occasion of the set of one or more occasions is across the at least one non-full-duplex symbol of the set of non-full-duplex symbols and a gap period that is between the set of non-full-duplex symbols and the set of full-duplex symbols, the method further comprising: performing uplink cancellation for one or more resource blocks, or one or more symbols, or both, of a second message included in the second occasion in accordance with the set of rules, wherein the one or more resource blocks overlap with the gap period; and receiving the second message via the second occasion based at least in part on performing the uplink cancellation for the one or more resource blocks.

Aspect 46: The method of any of aspects 32 through 45, wherein the occasion is across the set of non-full-duplex symbols, the set of full-duplex symbols, and a gap period that is between the set of non-full-duplex symbols and the set of full-duplex symbols, the method further comprising: dropping the message in accordance with the set of rules and based at least in part on the occasion comprising a multi-symbol resource having a transmission direction that conflicts with at least one subband, or at least one guard band, or both, of the at least one full-duplex symbol of the set of full-duplex symbols or at least one or more resource blocks of the set of non-full-duplex symbols or at least one or more resource blocks of the set of non-full-duplex symbols.

Aspect 47: The method of any of aspects 32 through 46, wherein the occasion is across the set of non-full-duplex symbols, the set of full-duplex symbols, and a gap period that is between the set of non-full-duplex symbols and the set of full-duplex symbols, the method further comprising: performing uplink cancellation for one or more resource blocks, or one or more symbols, or both, of the message in accordance with the set of rules, wherein the uplink cancellation is performed based at least in part on the occasion comprising the one or more resource blocks having a transmission direction that conflicts with at least one subband, or at least one guard band, or both, of the at least one full-duplex symbol of the set of full-duplex symbols or at least one or more resource blocks of the set of non-full-duplex symbols, and wherein the one or more resource blocks overlap with the gap period and the at least one full-duplex symbol or at least one or more resource blocks of the set of non-full-duplex symbols.

Aspect 48: The method of any of aspects 32 through 47, wherein the occasion is across the set of non-full-duplex symbols, the set of full-duplex symbols, and a gap period that is between the set of non-full-duplex symbols and the set of full-duplex symbols, the method further comprising: performing uplink cancellation for one or more resource blocks, or one or more symbols, or both, of the message in accordance with the set of rules, wherein the uplink cancellation is performed based at least in part on the occasion comprising the one or more resource blocks having a transmission direction that conflicts with at least one subband, or at least one guard band, or both, of the at least one full-duplex symbol of the set of full-duplex symbols or at least one or more resource blocks of the set of non-full-duplex symbols, and wherein the one or more resource blocks overlap with the gap period, each subband of the at least one subband, and at least one subband of the at least one non-full-duplex symbol of the set of non-full-duplex symbols corresponding to the at least one subband of the at least one full-duplex symbol.

Aspect 49: The method of aspect 48, further comprising: bundling, in accordance with the set of rules, one or more demodulation reference signal symbols included in the occasion prior to the gap period that is between the set of non-full-duplex symbols and the set of full-duplex symbols; and bundling, in accordance with the set of rules, one or more demodulation reference signal symbols included in the occasion after the gap period that is between the set of non-full-duplex symbols and the set of full-duplex symbols.

Aspect 50: The method of any of aspects 32 through 49, wherein the occasion is across the set of non-full-duplex symbols, the set of full-duplex symbols, and a gap period that is between the set of non-full-duplex symbols and the set of full-duplex symbols, the method further comprising: dropping one or more resource blocks of the message in accordance with the set of rules and based at least in part on the occasion comprising the one or more resource blocks having a transmission direction that conflicts with at least one subband, or at least one guard band, or both, of the at least one full-duplex symbol of the set of full-duplex symbols or at least one or more resource blocks of the set of non-full-duplex symbols, and wherein the one or more resource blocks overlap with the gap period, each subband of the at least one subband, and at least one subband of the at least one non-full-duplex symbol of the set of non-full-duplex symbols corresponding to the at least one subband of the at least one full-duplex symbol.

Aspect 51: The method of aspect 50, further comprising: performing uplink cancellation for the one or more resource blocks of the message in accordance with the set of rules, wherein the uplink cancellation is performed based at least in part on one or more demodulation reference signal symbols being included in the occasion prior to the gap period that is between the set of non-full-duplex symbols and the set of full-duplex symbols.

Aspect 52: The method of any of aspects 32 through 51, wherein the occasion is across the set of non-full-duplex symbols, the set of full-duplex symbols, and a gap period that is between the set of non-full-duplex symbols and the set of full-duplex symbols, the method further comprising: performing uplink cancellation for one or more resource blocks, or one or more symbols, or both, of the message in accordance with the set of rules and based at least in part on the occasion comprising the one or more resource blocks having a transmission direction that conflicts with at least one subband, or at least one guard band, or both, of the at least one full-duplex symbol of the set of full-duplex symbols or at least one or more resource blocks of the set of non-full-duplex symbols, wherein the one or more resource blocks overlap with the gap period and each subband of the at least one subband, and wherein the uplink cancellation is performed based at least in part on one or more demodulation reference signal symbols being included in the occasion prior to and after the gap period that is between the set of non-full-duplex symbols and the set of full-duplex symbols.

Aspect 53: The method of aspect 52, wherein the one or more resource blocks further overlap with a remaining portion of the message after the occasion prior to the gap period, and the uplink cancellation is performed based at least in part on one or more demodulation reference signal symbols being included in the occasion prior to the gap period that is between the set of non-full-duplex symbols and the set of full-duplex symbols.

Aspect 54: The method of any of aspects 32 through 53, wherein the occasion is across the set of non-full-duplex symbols, the set of full-duplex symbols, and a gap period that is between the set of non-full-duplex symbols and the set of full-duplex symbols, the method further comprising: dropping one or more resource blocks of the message in accordance with the set of rules and based at least in part on the occasion comprising the one or more resource blocks having a transmission direction that is configured same as at least one subband, or at least one guard band, or both, of the at least one full-duplex symbol of the set of full-duplex symbols or at least one or more resource blocks of the set of non-full-duplex symbols, wherein the message is non-overlapping with one or more other subbands of the at least one full-duplex symbol.

Aspect 55: The method of any of aspects 32 through 54, wherein the occasion is across the set of non-full-duplex symbols, the set of full-duplex symbols, and a gap period that is between the set of non-full-duplex symbols and the set of full-duplex symbols, the method further comprising: performing uplink cancellation for one or more resource blocks, or one or more symbols, or both, of the message in accordance with the set of rules and based at least in part on the occasion comprising the one or more resource blocks having a transmission direction that is configured same as at least one subband, or at least one guard band, or both, of the at least one full-duplex symbol of the set of full-duplex symbols or at least one or more resource blocks of the set of non-full-duplex symbols, wherein the message is non-overlapping with one or more other subbands of the at least one full-duplex symbol, and wherein the uplink cancellation is performed based at least in part on one or more demodulation reference signal symbols being included in the occasion prior to the gap period that is between the set of non-full-duplex symbols and the set of full-duplex symbols.

Aspect 56: The method of any of aspects 32 through 55, wherein the occasion is across the set of non-full-duplex symbols, the set of full-duplex symbols, and a gap period that is between the set of non-full-duplex symbols and the set of full-duplex symbols, the method further comprising: performing uplink cancellation for one or more resource blocks, or one or more symbols, or both, of the message in accordance with the set of rules and based at least in part on the occasion comprising the one or more resource blocks having a transmission direction that is same as at least one subband of the at least one full-duplex symbol of the set of full-duplex symbols, wherein the message is non-overlapping with one or more other subbands of the at least one full-duplex symbol, and wherein the one or more resource blocks overlap with the gap period.

Aspect 57: The method of aspect 56, further comprising: bundling, in accordance with the set of rules, one or more demodulation reference signal symbols included in the occasion prior to the gap period that is between the set of non-full-duplex symbols and the set of full-duplex symbols; and bundling, in accordance with the set of rules, one or more demodulation reference signal symbols included in the occasion after the gap period that is between the set of non-full-duplex symbols and the set of full-duplex symbols.

Aspect 58: The method of any of aspects 32 through 57, wherein the occasion is across the set of non-full-duplex symbols, the set of full-duplex symbols, and a gap period that is between the set of non-full-duplex symbols and the set of full-duplex symbols, the method further comprising: performing uplink cancellation for one or more resource blocks, or one or more symbols, or both, of the message in accordance with the set of rules and based at least in part on the occasion comprising the one or more resource blocks having a transmission direction that is same as at least one subband, or at least one guard band, or both, of the at least one full-duplex symbol of the set of full-duplex symbols or at least one or more resource blocks of the set of non-full-duplex symbols, wherein the message is non-overlapping with one or more other subbands of the at least one full-duplex symbol, and wherein the one or more resource blocks overlap with the gap period and each subband of the at least one subband.

Aspect 59: The method of any of aspects 32 through 58, further comprising: transmitting, to the UE, a control signal indicating the set of rules, wherein communicating the message is based at least in part on receiving the control signal.

Aspect 60: The method of any of aspects 32 through 59, wherein the message comprises at least one of a physical downlink control channel without repetition, a physical uplink control channel without repetition, a physical uplink shared channel without repetition, physical downlink shared channel without repetition, a physical downlink control channel with repetition, a physical uplink control channel with repetition, a physical uplink shared channel with repetition, physical downlink shared channel with repetition, a sounding reference signal, a channel state information reference signal, a transport block over multiple slots with repetition, a transport block over multiple slots without repetition, multiple physical uplink shared channel scheduled by a single downlink control information, multiple physical downlink shared channel scheduled by a single downlink control information, or a combination thereof.

Aspect 61: The method of any of aspects 32 through 60, wherein the set of full-duplex symbols and the set of non-full-duplex symbols are included in same slot or in different slots.

Aspect 62: The method of any of aspects 32 through 61, wherein the set of full-duplex symbols and the set of non-full-duplex symbols included in different slots comprise physical uplink shared channel repetition type B or supports transport block processing over multiple slots or both.

Aspect 63: An apparatus for wireless communication at a UE, comprising a processor; memory coupled with the processor; and instructions stored in the memory and executable by the processor to cause the apparatus to perform a method of any of aspects 1 through 31.

Aspect 64: An apparatus for wireless communication at a UE, comprising at least one means for performing a method of any of aspects 1 through 31.

Aspect 65: A non-transitory computer-readable medium storing code for wireless communication at a UE, the code comprising instructions executable by a processor to perform a method of any of aspects 1 through 31.

Aspect 66: An apparatus for wireless communication at a network entity, comprising a processor; memory coupled with the processor; and instructions stored in the memory and executable by the processor to cause the apparatus to perform a method of any of aspects 32 through 62.

Aspect 67: An apparatus for wireless communication at a network entity, comprising at least one means for performing a method of any of aspects 32 through 62.

Aspect 68: A non-transitory computer-readable medium storing code for wireless communication at a network entity, the code comprising instructions executable by a processor to perform a method of any of aspects 32 through 62.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., including a list of items prefaced by a phrase such as “at least one of” or “one or more of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
at least one processor; and
memory coupled with the at least one processor, the memory storing instructions executable by the at least one processor to cause the UE to:
receive an indication that an occasion of a set of one or more occasions for a message occurs over a plurality of symbols, wherein the plurality of symbols comprises a set of full-duplex symbols and a set of non-full-duplex symbols; and
communicate the message via the occasion in accordance with a set of rules and based at least in part on the occasion being across at least one full-duplex symbol of the set of full-duplex symbols and at least one non-full-duplex symbol of the set of non-full-duplex symbols.

2. The apparatus of claim 1, wherein the set of rules indicate that communication of the message via the occasion is allowed based at least in part on the message being a first type of message and the occasion comprising a multi-symbol resource having a transmission direction that conflicts with at least one subband of the at least one full-duplex symbol of the set of full-duplex symbols.

3. The apparatus of claim 2, wherein the first type of message comprises a physical uplink shared channel, or a physical downlink shared channel, or one or more reference signals.

4. The apparatus of claim 1, wherein the instructions are further executable by the at least one processor to cause the UE to:
drop the message in accordance with the set of rules and based at least in part on the occasion comprising a multi-symbol resource having a transmission direction that conflicts with at least one subband of the at least one full-duplex symbol of the set of full-duplex symbols.

5. The apparatus of claim 1, wherein the instructions are further executable by the at least one processor to cause the UE to:
perform rate matching around one or more resource blocks of the message in accordance with the set of rules, wherein the rate matching is performed based at least in part on the occasion comprising the one or more resource blocks having a transmission direction that conflicts with at least one subband, or at least one guard band, or both, of the at least one full-duplex symbol of the set of full-duplex symbols, or at least one resource block of the set of non-full-duplex symbols.

6. The apparatus of claim 1, wherein the instructions are further executable by the at least one processor to cause the UE to:
receive, from a network entity, an indication to perform uplink cancellation for one or more resource blocks, or one or more symbols, or both, of the message in accordance with the set of rules, wherein the uplink cancellation is performed based at least in part on the occasion comprising the one or more resource blocks having a transmission direction that conflicts with at least one subband, or at least one guard band, or both, of the at least one full-duplex symbol of the set of full-duplex symbols or at least one resource block of the set of non-full-duplex symbols.

7. The apparatus of claim 1, wherein the instructions are further executable by the at least one processor to cause the UE to:
receive a control message indicating a plurality of frequency domain resource allocations, or a plurality of time domain resource allocations, or both, for one or more resource blocks of one or more occasions of the message;
identify one or more respective occasions of the message associated with a first frequency domain resource allocation of the plurality of frequency domain resource allocations, or a first time domain resource allocation of the plurality of time domain resource allocations, or both, for the set of full-duplex symbols, based at least in part on the set of rules and the set of full-duplex symbols, wherein communicating the message is based at least in part on the first frequency domain resource allocation, or the first time domain resource allocation, or both; and
identify one or more respective occasions of the message associated with a second frequency domain resource allocation of the plurality of frequency domain resource allocations, or a second time domain resource allocation of the plurality of time domain resource allocations, or both, for the set of non-full-duplex symbols, based at least in part on the set of rules and the set of non-full-duplex symbols, wherein communicating the message is based at least in part on the second frequency domain resource allocation, or the second time domain resource allocation, or both.

8. The apparatus of claim 1, wherein the instructions are further executable by the at least one processor to cause the UE to:
perform rate matching around one or more resource blocks of the message in accordance with the set of rules, wherein the rate matching is performed based at least in part on the occasion comprising the one or more resource blocks having a transmission direction that conflicts with at least one subband of the at least one full-duplex symbol of the set of full-duplex symbols, and wherein the one or more resource blocks correspond to the at least one subband or at least one guard band of the at least one full-duplex symbol and at least one subband of the at least one non-full-duplex symbol of the set of non-full-duplex symbols.

9. The apparatus of claim 1, wherein the instructions are further executable by the at least one processor to cause the UE to:
receive a control message indicating that the UE update at least one subband of the at least one full-duplex symbol in accordance with the set of rules, wherein the at least one full-duplex symbol of the set of full-duplex symbols corresponds to a downlink symbol or a flexible symbol; and
determine that the message corresponds to a downlink transmission and the occasion comprises a multi-symbol resource having a transmission direction that conflicts with at least one subband of the at least one full-duplex symbol of the set of full-duplex symbols, wherein communicating the message comprises receiving the downlink transmission via the occasion based at least in part on the control message.

10. The apparatus of claim 1, wherein the instructions are further executable by the at least one processor to cause the UE to:
receive a control message indicating that the UE update at least one subband of the at least one full-duplex symbol in accordance with the set of rules, wherein the at least one full-duplex symbol of the set of full-duplex symbols corresponds to a flexible symbol; and
determine that the message corresponds to an uplink transmission and the occasion comprises a multi-symbol resource having a transmission direction that conflicts with at least one subband of the at least one full-duplex symbol of the set of full-duplex symbols, wherein communicating the message comprises transmitting the uplink transmission via the occasion based at least in part on the control message.

11. The apparatus of claim 1, wherein the instructions are further executable by the at least one processor to cause the UE to:
determine that the message corresponds to a downlink transmission and the occasion comprises a multi-symbol resource having a transmission direction that corresponds to a transmission direction of a first subband of the at least one full-duplex symbol, wherein the message is non-overlapping with one or more other subbands of the at least one full-duplex symbol, and wherein communicating the message comprises receiving the downlink transmission via the first subband.

12. The apparatus of claim 1, wherein the instructions are further executable by the at least one processor to cause the UE to:
determine that the message corresponds to an uplink transmission and the occasion comprises a multi-symbol resource having a transmission direction that corresponds to a transmission direction of a first subband of the at least one full-duplex symbol, wherein the message is non-overlapping with one or more other subbands of the at least one full-duplex symbol, and wherein communicating the message comprises transmitting the uplink transmission via the first subband.

13. The apparatus of claim 1, wherein a second occasion of the set of one or more occasions is across the at least one non-full-duplex symbol of the set of non-full-duplex symbols and a gap period that is between the set of non-full-duplex symbols and the set of full-duplex symbols, and wherein the instructions are further executable by the at least one processor to cause the UE to:
drop a second message of the second occasion in accordance with the set of rules.

14. The apparatus of claim 1, wherein a second occasion of the set of one or more occasions is across the at least one non-full-duplex symbol of the set of non-full-duplex symbols and a gap period that is between the set of non-full-duplex symbols and the set of full-duplex symbols, and wherein the instructions are further executable by the at least one processor to cause the UE to:
perform rate matching around one or more resource blocks of a second message included in the second occasion in accordance with the set of rules, wherein the one or more resource blocks overlap with the gap period; and
receive the second message via the second occasion based at least in part on performing the rate matching around the one or more resource blocks.

15. The apparatus of claim 1, wherein the occasion is across the set of non-full-duplex symbols, the set of full-duplex symbols, and a gap period that is between the set of non-full-duplex symbols and the set of full-duplex symbols, and the instructions are further executable by the at least one processor to cause the UE to:
drop the message in accordance with the set of rules and based at least in part on the occasion comprising a multi-symbol resource having a transmission direction that conflicts with at least one subband, or at least one guard band, or both, of the at least one full-duplex symbol of the set of full-duplex symbols or at least one or more resource blocks of the set of non-full-duplex symbols.

16. The apparatus of claim 1, wherein the occasion is across the set of non-full-duplex symbols, the set of full-duplex symbols, and a gap period that is between the set of non-full-duplex symbols and the set of full-duplex symbols, and the instructions are further executable by the at least one processor to cause the UE to:
perform rate matching around one or more resource blocks of the message in accordance with the set of rules, wherein the rate matching is performed based at least in part on the occasion comprising the one or more resource blocks having a transmission direction that conflicts with at least one subband, or at least one guard band, or both, of the at least one full-duplex symbol of the set of full-duplex symbols or at least one or more resource blocks of the set of non-full-duplex symbols, and wherein the one or more resource blocks overlap with the gap period and the at least one full-duplex symbol or the at least one or more resource blocks of the set of non-full-duplex symbols.

17. The apparatus of claim 1, wherein the occasion is across the set of non-full-duplex symbols, the set of full-duplex symbols, and a gap period that is between the set of non-full-duplex symbols and the set of full-duplex symbols, and the instructions are further executable by the at least one processor to cause the UE to:
perform rate matching around one or more resource blocks of the message in accordance with the set of rules, wherein the rate matching is performed based at least in part on the occasion comprising the one or more resource blocks having a transmission direction that conflicts with at least one subband, or at least one guard band, or both, of the at least one full-duplex symbol of the set of full-duplex symbols or at least one or more resource blocks of the set of non-full-duplex symbols, and wherein the one or more resource blocks overlap with the gap period, each subband of the at least one subband, and at least one subband of the at least one non-full-duplex symbol of the set of non-full-duplex symbols corresponding to the at least one subband of the at least one full-duplex symbol.

18. The apparatus of claim 17, wherein the instructions are further executable by the at least one processor to cause the UE to:
bundle, in accordance with the set of rules, one or more demodulation reference signal symbols included in the occasion prior to the gap period that is between the set of non-full-duplex symbols and the set of full-duplex symbols; and
bundle, in accordance with the set of rules, one or more demodulation reference signal symbols included in the occasion after the gap period that is between the set of non-full-duplex symbols and the set of full-duplex symbols.

19. The apparatus of claim 1, wherein the occasion is across the set of non-full-duplex symbols, the set of full-duplex symbols, and a gap period that is between the set of non-full-duplex symbols and the set of full-duplex symbols, and the instructions are further executable by the at least one processor to cause the UE to:
drop one or more resource blocks of the message in accordance with the set of rules and based at least in part on the one or more resource blocks having a transmission direction that conflicts with at least one subband, or at least one guard band, or both, of the at least one full-duplex symbol of the set of full-duplex symbols or at least one or more resource blocks of the set of non-full-duplex symbols, and wherein the one or more resource blocks overlap with the gap period, each subband of the at least one subband, and at least one subband of the at least one non-full-duplex symbol of the set of non-full-duplex symbols corresponding to the at least one subband of the at least one full-duplex symbol.

20. The apparatus of claim 19, wherein the instructions are further executable by the at least one processor to cause the UE to:
perform rate matching around the one or more resource blocks of the message in accordance with the set of rules, wherein the rate matching is performed based at least in part on one or more demodulation reference signal symbols being included in the occasion prior to the gap period that is between the set of non-full-duplex symbols and the set of full-duplex symbols.

21. The apparatus of claim 1, wherein the occasion is across the set of non-full-duplex symbols, the set of full-duplex symbols, and a gap period that is between the set of non-full-duplex symbols and the set of full-duplex symbols, and the instructions are further executable by the at least one processor to cause the UE to:
perform rate matching around one or more resource blocks of the message in accordance with the set of rules and based at least in part on the occasion comprising the one or more resource blocks having a transmission direction that conflicts with at least one subband, or at least one guard band, or both, of the at least one full-duplex symbol of the set of full-duplex symbols or at least one or more resource blocks of the set of non-full-duplex symbols, wherein the one or more resource blocks overlap with the gap period and each subband of the at least one subband, and wherein the rate matching is performed based at least in part on one or more demodulation reference signal symbols being included in the occasion prior to and after the gap period that is between the set of non-full-duplex symbols and the set of full-duplex symbols.

22. The apparatus of claim 21, wherein:
the one or more resource blocks further overlap with a remaining portion of the message after the occasion prior to the gap period, and
the rate matching is performed based at least in part on the one or more demodulation reference signal symbols being included in the occasion prior to the gap period that is between the set of non-full-duplex symbols and the set of full-duplex symbols.

23. The apparatus of claim 1, wherein the occasion is across the set of non-full-duplex symbols, the set of full-duplex symbols, and a gap period that is between the set of non-full-duplex symbols and the set of full-duplex symbols, and the instructions are further executable by the at least one processor to cause the UE to:
drop one or more resource blocks of the message in accordance with the set of rules and based at least in part on the occasion comprising the one or more resource blocks having a transmission direction that is same as at least one subband, or at least one guard band, or both, of the at least one full-duplex symbol of the set of full-duplex symbols or at least one or more resource blocks of the set of non-full-duplex symbols, wherein the message is non-overlapping with one or more other subbands of the at least one full-duplex symbol.

24. The apparatus of claim 1, wherein the occasion is across the set of non-full-duplex symbols, the set of full-duplex symbols, and a gap period that is between the set of non-full-duplex symbols and the set of full-duplex symbols, and the instructions are further executable by the at least one processor to cause the UE to:
perform rate matching around one or more resource blocks of the message in accordance with the set of rules and based at least in part on the occasion comprising the one or more resource blocks having a transmission direction that is same as at least one subband, or at least one guard band, or both, of the at least one full-duplex symbol of the set of full-duplex symbols or at least one or more resource blocks of the set of non-full-duplex symbols, wherein the message is non-overlapping with one or more other subbands of the at least one full-duplex symbol, and wherein the rate matching is performed based at least in part on one or more demodulation reference signal symbols being included in the occasion prior to the gap period that is between the set of non-full-duplex symbols and the set of full-duplex symbols.

25. The apparatus of claim 1, wherein the occasion is across the set of non-full-duplex symbols, the set of full-duplex symbols, and a gap period that is between the set of non-full-duplex symbols and the set of full-duplex symbols, and the instructions are further executable by the at least one processor to cause the UE to:
perform rate matching around one or more resource blocks of the message in accordance with the set of rules and based at least in part on the occasion comprising the one or more resource blocks having a transmission direction that is same as at least one subband, or at least one guard band, or both, of the at least one full-duplex symbol of the set of full-duplex symbols or at least one or more resource blocks of the set of non-full-duplex symbols, wherein the message is non-overlapping with one or more other subbands of the at least one full-duplex symbol, and wherein the one or more resource blocks overlap with the gap period.

26. The apparatus of claim 25, wherein the instructions are further executable by the at least one processor to cause the UE to:
bundle, in accordance with the set of rules, one or more demodulation reference signal symbols included in the occasion prior to the gap period that is between the set of non-full-duplex symbols and the set of full-duplex symbols; and
bundle, in accordance with the set of rules, one or more demodulation reference signal symbols included in the occasion after the gap period that is between the set of non-full-duplex symbols and the set of full-duplex symbols.

27. The apparatus of claim 1, wherein the occasion is across the set of non-full-duplex symbols, the set of full-duplex symbols, and a gap period that is between the set of non-full-duplex symbols and the set of full-duplex symbols, and the instructions are further executable by the at least one processor to cause the UE to:
perform rate matching around one or more resource blocks of the message in accordance with the set of rules and based at least in part on the occasion comprising the one or more resource blocks having a transmission direction that is configured same as at least one subband, or at least one guard band, or both, of the at least one full-duplex symbol of the set of full-duplex symbols or at least one or more resource blocks of the set of non-full-duplex symbols, wherein the message is non-overlapping with one or more other subbands of the at least one full-duplex symbol, and wherein the one or more resource blocks overlap with the gap period and each subband of the at least one subband.

28. An apparatus for wireless communication at a network entity, comprising:
at least one processor; and
memory coupled with the at least one processor, the memory storing instructions executable by the at least one processor to cause the network entity to:
transmit, to a user equipment (UE), an indication that an occasion of a set of one or more occasions for a message occurs over a plurality of symbols, wherein the plurality of symbols comprises a set of full-duplex symbols and a set of non-full-duplex symbols; and
communicate the message via the occasion in accordance with a set of rules and based at least in part on the occasion being across at least one full-duplex symbol of the set of full-duplex symbols and at least one non-full-duplex symbol of the set of non-full-duplex symbols.

29. A method for wireless communication at a user equipment (UE), comprising:
receiving an indication that an occasion of a set of one or more occasions for a message occurs over a plurality of symbols, wherein the plurality of symbols comprises a set of full-duplex symbols and a set of non-full-duplex symbols; and
communicating the message via the occasion in accordance with a set of rules and based at least in part on the occasion being across at least one full-duplex symbol of the set of full-duplex symbols and at least one non-full-duplex symbol of the set of non-full-duplex symbols.

30. A method for wireless communication at a network entity, comprising:
transmitting, to a user equipment (UE), an indication that an occasion of a set of one or more occasions for a message occurs over a plurality of symbols, wherein the plurality of symbols comprises a set of full-duplex symbols and a set of non-full-duplex symbols; and
communicating the message via the occasion in accordance with a set of rules and based at least in part on the occasion being across at least one full-duplex symbol of the set of full-duplex symbols and at least one non-full-duplex symbol of the set of non-full-duplex symbols.
